(19) United States
(12) Patent Application Publication
(10) Pub. No.: US 2017/0007067 A1
(43) Pub. Date: Jan. 12, 2017

(54) AGITATION UNIT AND BEVERAGE PREPARATION APPARATUS

(71) Applicant: SHARP KABUSHIKI KAISHA, Sakai-shi (JP)

(72) Inventors: Hidekazu SHIMA, Sakai-shi (JP); Masaru MISUMI, Sakai-shi (JP); Kimiko MIEDA, Sakai-shi (JP); Yasuaki SAKANE, Sakai-shi (JP)

(73) Assignee: Sharp Kabushiki Kaisha, Osaka (JP)

(21) Appl. No.: 15/120,567

(22) PCT Filed: Aug. 25, 2015
(86) PCT No.: PCT/JP2015/073806

§ 371 Date: Aug. 22, 2016

(30) Foreign Application Priority Data
Sep. 4, 2014 (JP) 2014-180356
Sep. 4, 2014 (JP) 2014-180358
Sep. 5, 2014 (JP) 2014-181457

(51) Int. Cl. A47J 31/40; A47J 43/046; A47J 43/08; A47J 31/44

(52) U.S. Cl. CPC A47J 31/40; A47J 31/44; A47J 43/046; A47J 43/08

(57) ABSTRACT

An agitation unit includes an agitation tank to which a liquid is supplied and an agitation member which agitates the liquid supplied to the agitation tank. The agitation tank has an area of opening in a horizontal direction decreasing in a downward direction.

### TECHNICAL FIELD

The present invention relates to an agitation unit including an agitation tank and an agitation member, and a beverage preparation apparatus.

### BACKGROUND ART

Various types of agitation units which can produce fine foams in order to make a taste of beverages milder have conventionally been developed. For example, Japanese National Patent Publication No. 2010-535577 (PTD 1) discloses such an agitation unit.

In the agitation unit disclosed in PTD 1, electric power is supplied to a drive portion through a conduction path provided in a container (an agitation tank) by placing the container on a base plate connected to a power supply. Thus, the drive portion causes an agitation member to agitate and froth a liquid (milk) in an agitation tank. A user removes the container from the base plate by holding a handle provided in the container and pours the frothed milk from a lip into a cup.

Various types of beverage preparation apparatuses including agitation means which can produce fine foams in order to make a taste of a beverage milder have conventionally been developed.

For example, PTD 1 and Japanese Patent Laying-Open No. 2009-163622 (PTD 2) each disclose a beverage preparation apparatus including such agitation means.

The beverage preparation apparatus in PTD 1 includes the features the same as described above so that the agitation member agitates and frothes a liquid (milk) in the agitation tank. A user removes the container from the base plate and pours frothed milk from a lip into a cup.

In the beverage preparation apparatus disclosed in PTD 2, initially, cream powders and sugar necessary for one cup are supplied into a cup from a sub ingredient supply portion, and in succession, hot water for preparation of powders is supplied from a hot water supply portion into the cup. An agitation portion provided at a tip end of an agitation shaft is immersed in the hot water for preparation in the cup and the agitation shaft is rotated by an agitation drive portion, so that whipped cream is produced. Then, the agitation shaft and the agitation portion are moved out of the cup and a coffee liquid is supplied from a coffee preparation portion into the cup.

Various agitation units which agitate a liquid in an agitation tank such as a container and beverage preparation apparatuses have recently been developed. For example, Japanese Patent Laying-Open No. 2004-065325 (PTD 3), PTD 1, and PTD 2 each disclose such an agitation unit or a beverage preparation apparatus.

In the beverage preparation apparatus disclosed in PTD 3, juice produced as a result of rotation of a cutter disposed in a mixer container is forcibly transferred to a juice extraction pipe by using a juice extraction pump. By constantly integrally rotating the cutter and the juice extraction pump while a valve for opening and closing the juice extraction pipe is closed, juice can be produced and agitated. By opening the valve in this state, juice uniform in concentration can be discharged to the outside of the container.

The agitation unit disclosed in PTD 1 includes the features the same as described above, so that the agitation member agitates and frothes a liquid (milk) in the agitation tank. A user removes a container from the base plate and pours frothed milk from a lip into a cup.

The beverage preparation apparatus disclosed in PTD 2 includes the features the same as described above, so that the agitation portion provided at the tip end of the agitation shaft is immersed in hot water for preparation in the cup and the agitation shaft is rotated by the agitation drive portion, so that whipped cream is produced. Then, the agitation shaft and the agitation portion are moved out of the cup and a coffee liquid is supplied from the coffee preparation portion into the cup.

### CITATION LIST

### Patent Document

PTD 1: Japanese National Patent Publication No. 2010-535577
PTD 2: Japanese Patent Laying-Open No. 2009-163622
PTD 3: Japanese Patent Laying-Open No. 2004-065325

### SUMMARY OF INVENTION

### Technical Problem

In the agitation unit disclosed in PTD 1, however, the agitation member is coupled to drive means with a coupling shaft being interposed, the coupling shaft extending downward from the drive means arranged above the container. Therefore, agitation means is arranged at a considerable distance from a bottom portion of the container. The container has a cylindrical shape with bottom which has an area of opening substantially constant from an upper portion to the bottom portion or a cylindrical shape with bottom which has an area of opening increasing from the upper portion toward the bottom portion.

Thus, in the agitation unit disclosed in PTD 1, in order to sufficiently agitate a liquid to be frothed, a considerable amount of liquid should be supplied into the container so that a spiral spring (an agitation portion) which contributes to agitation in the agitation member is entirely immersed in the liquid. When an amount of supply of a liquid is small, the agitation member is located above a liquid level and it is difficult to sufficiently agitate the liquid.

Displacement in height of the liquid level which varies depending on an amount of supply of the liquid cannot be suppressed. Therefore, when an amount of supply of the liquid is greater than a prescribed amount of supply, increase in height of a liquid level cannot be suppressed and the liquid level is excessively distant from the agitation member. Then, air cannot sufficiently be taken in during agitation and sufficient frothing is difficult.

In a milk frother disclosed in PTD 1, when pouring of milk containing foams from the lid into a cup is attempted, milk in a state of a liquid greater in specific gravity is poured first and frothed milk lower in specific gravity (foams of milk) remains on an inner wall of the container. Since liquids different in specific gravity are thus poured separately, it has been difficult to discharge a liquid having desired specific gravity into a cup in accordance with preference of a user.

In the beverage preparation apparatus disclosed in PTD 2, coffee is supplied into a cup after cream (foams of cream) previously whipped in the cup is produced. Therefore, though foams of cream are not left unserved in the cup, one serving of a beverage can only be prepared in the cup. Therefore, it is difficult to apply the feature of the beverage preparation apparatus disclosed in PTD 2 to a beverage preparation apparatus which prepares several servings of a beverage in a mass.

In the beverage preparation apparatus disclosed in PTD 3, a juice extraction pump driven by the drive portion should be provided in a portion of connection between the opening portion provided at the bottom portion of the container and the juice extraction pipe and a structure is complicated.

In the milk frother disclosed in PTD 1, when pouring of milk containing foams from the lid into a cup is attempted, milk in a state of a liquid greater in specific gravity is poured first and frothed milk smaller in specific gravity (foams of milk) remains on the inner wall of the container. Therefore, it has been difficult to efficiently discharge a liquid containing a layer small in specific gravity from a liquid separated into different layers owing to a difference in specific gravity.

In the beverage preparation apparatus disclosed in PTD 2, coffee is supplied into a cup after cream (foams of cream) whipped previously in the cup is produced. Therefore, though foams of cream are not left unserved in the cup, one serving of a beverage can only be prepared in the cup. Therefore, it is difficult to apply the agitation mechanism disclosed in PTD 2 to a beverage preparation apparatus which prepares a desired number of servings of a beverage such as several servings in a mass.

The present invention was made in view of the problems as above, and a first object of the present invention is to provide an agitation unit and a beverage preparation apparatus which can sufficiently agitate a liquid even though an amount of a supplied liquid is small.

The present invention was made in view of the problems as above, and a second object of the present invention is to provide a beverage preparation apparatus which can discharge a beverage having desired specific gravity in accordance with preference of a user while a desired amount of a beverage is prepared.

The present invention was made in view of the problems as above, and a third object of the present invention is to provide an agitation unit and a beverage preparation apparatus which have a simplified construction, can agitate a desired amount of a supplied liquid, and can reliably discharge a liquid containing a layer small in specific gravity from an agitated liquid produced by agitation and separated into different layers owing to a difference in specific gravity.

### Solution to Problem

An agitation unit based on a first aspect of the present invention includes an agitation tank to which a liquid is supplied and an agitation member which agitates the liquid supplied to the agitation tank. The agitation tank has an area of opening in a horizontal direction decreasing in a downward direction.

In the agitation unit based on the present invention, preferably, a guideline amount of supply of the liquid is predetermined, and in this case, preferably, a liquid level position when the guideline amount of supply is minimal is located above an upper surface of the agitation member.

In the agitation unit based on the first aspect of the present invention, preferably, the agitation member is provided at a bottom portion of the agitation tank.

In the agitation unit based on the first aspect of the present invention, preferably, the agitation tank has such a curved shape that the area of opening in the horizontal direction decreases in the downward direction.

A beverage preparation apparatus based on the first aspect of the present invention includes a milling unit which obtains powders by grating an object to be grated and an agitation unit to which the powders and a liquid are supplied, and the agitation unit described above is employed as the agitation unit.

A beverage preparation apparatus based on a second aspect of the present invention includes an agitation tank, an agitation member which agitates a liquid supplied to the agitation tank, an agitation member drive portion which rotationally drives the agitation member, a discharge mechanism which is provided in the agitation tank and discharges the liquid from the agitation tank to the outside, and a control unit which controls the agitation member drive portion, and the control unit controls the agitation member drive portion such that the agitation member is rotationally driven when the discharge mechanism discharges the liquid to the outside.

In the beverage preparation apparatus based on the second aspect of the present invention, preferably, the control unit controls the agitation member drive portion such that the agitation member is intermittently rotationally driven.

The beverage preparation apparatus based on the second aspect of the present invention preferably further includes an operation portion for operating the discharge mechanism and a sensing device which senses timing of an operation of the operation portion. In this case, the control unit may receive input of a sensing signal indicative of sensing of the timing from the sensing device and control the agitation member drive portion such that the agitation member is rotationally driven after a prescribed period of time has elapsed since discharging of the liquid from the discharge mechanism to the outside.

The beverage preparation apparatus based on the second aspect of the present invention preferably further includes an operation portion for operating the discharge mechanism and a sensing device which senses timing of an operation of the operation portion. In this case, the control unit may receive input of a sensing signal indicative of sensing of the timing from the sensing device and control the agitation member drive portion such that the agitation member is rotationally driven before the liquid is discharged from the discharge mechanism to the outside.

The beverage preparation apparatus based on the second aspect of the present invention may further include an input portion for indicating a time period for the agitation member to be rotationally driven and/or the number of rotations.

An agitation unit based on a third aspect of the present invention includes an agitation tank to which a liquid is supplied, an agitation member which agitates the liquid supplied to the agitation tank, and a discharge mechanism which discharges an agitated liquid produced as a result of agitation by the agitation member to the outside. The agitated liquid contains a first layer and a second layer which is separated as an upper layer based on a difference in specific gravity from the first layer. The discharge mechanism has a suction port located in the vicinity of a boundary portion between the first layer and the second layer and discharges the agitated liquid suctioned through the suction port.

In the agitation unit based on the third aspect of the present invention, the discharge mechanism may be provided to be able to select between a first discharge path through which the agitated liquid containing the first layer is discharged and a second discharge path through which the agitated liquid containing the second layer is discharged.

The agitation unit based on the third aspect of the present invention preferably further includes a float member which follows displacement of the boundary portion between the first layer and the second layer. In this case, the float member is preferably disposed around the suction port, and the suction port preferably follows displacement of the boundary portion owing to the float member and suctions the agitated liquid containing the second layer.

In the agitation unit based on the third aspect of the present invention, the suction port may be provided in a side surface of the agitation tank so as to be opened and closed, and the agitated liquid containing the first layer and the second layer may be suctioned through the suction port while the suction port is open.

A beverage preparation apparatus based on the third aspect of the present invention includes a milling unit which obtains powders by grating an object to be grated and an agitation unit to which the powders and a liquid are supplied. The agitation unit described in any portion above is employed as the agitation unit.

### Advantageous Effects of Invention

According to the first aspect of the present invention, an agitation unit and a beverage preparation apparatus which can sufficiently agitate a liquid even though an amount of a supplied liquid is small can be provided.

According to the second aspect of the present invention, a beverage preparation apparatus which can discharge a liquid having desired specific gravity in accordance with preference of a user while a desired amount of a beverage is prepared can be provided.

According to the third aspect of the present invention, an agitation unit and a beverage preparation apparatus which have a simplified construction, can agitate a desired amount of a supplied liquid, and can reliably discharge a liquid containing a layer small in specific gravity from an agitated liquid produced by agitation and separated into different layers owing to a difference in specific gravity can be provided.

### BRIEF DESCRIPTION OF DRAWINGS

FIG. 1 is an overall perspective view of a beverage preparation apparatus according to Embodiment 1.

FIG. 2 is a cross-sectional view along the line II-II in FIG. 1.

FIG. 3 is an overall view showing a schematic component of the beverage preparation apparatus according to Embodiment 1.

FIG. 4 shows a first preparation flow showing discharge of tea using the beverage preparation apparatus according to Embodiment 1.

FIG. 5 shows a second preparation flow showing discharge of tea using the beverage preparation apparatus according to Embodiment 1.

FIG. 6 shows a third preparation flow showing discharge of tea using the beverage preparation apparatus according to Embodiment 1.

FIG. 7 is a perspective view showing an internal structure of the beverage preparation apparatus according to Embodiment 1.

FIG. 8 is a perspective view of a milling unit according to Embodiment 1.

FIG. 9 is an exploded perspective view of the milling unit according to Embodiment 1.

FIG. 10 is a vertical cross-sectional view of the milling unit according to Embodiment 1.

FIG. 11 is an exploded perspective view of an agitation unit according to Embodiment 1.

FIG. 12 is a vertical cross-sectional view of the agitation unit according to Embodiment 1.

FIG. 13 is a perspective view of an agitation blade according to Embodiment 1.

FIG. 14 is an exploded perspective view showing a structure of the agitation blade according to Embodiment 1.

FIG. 15 is a cross-sectional view along the line XV-XV shown in FIG. 13.

FIG. 16 is a perspective view showing an agitation tank and the agitation blade according to Embodiment 1.

FIG. 17 is a cross-sectional view along the line XVII-XVII shown in FIG. 16.

FIG. 18 is a perspective view showing an agitation tank and an agitation blade according to Embodiment 2.

FIG. 19 is a cross-sectional view along the line XIX-XIX shown in FIG. 18.

FIG. 20 is a perspective view showing an agitation tank and the agitation blade according to Embodiment 3.

FIG. 21 is a cross-sectional view along the line XXI-XXI shown in FIG. 20.

FIG. 22 is a perspective view showing an agitation tank and an agitation blade according to Embodiment 4.

FIG. 23 is a cross-sectional view along the line XXIII-XXIII shown in FIG. 22.

FIG. 24 is a perspective view showing an agitation tank and the agitation blade according to Embodiment 5.

FIG. 25 is a cross-sectional view along the line XXV-XXV shown in FIG. 24.

FIG. 26 is a perspective view showing an agitation tank and the agitation blade according to Embodiment 6.

FIG. 27 is a cross-sectional view along the line XXVII-XXVII shown in FIG. 26.

FIG. 28 is a perspective view showing an agitation tank and the agitation blade according to Embodiment 7.

FIG. 29 is a cross-sectional view along the line XXIX-XXIX shown in FIG. 28.

FIG. 30 is a perspective view showing an agitation tank and the agitation blade according to Embodiment 8.

FIG. 31 is a cross-sectional view along the line XXXI-XXXI shown in FIG. 30.

FIG. 32 is a perspective view showing an agitation tank and the agitation blade according to Embodiment 9.

FIG. 33 is a cross-sectional view along the line XXXIII-XXXIII shown in FIG. 32.

FIG. 34 is a perspective view showing an agitation tank and the agitation blade in a comparative form.

FIG. 35 is a cross-sectional view along the line XXXV-XXXV shown in FIG. 34.

FIG. 36 is a diagram showing conditions and results of a verification experiment conducted for confirming an effect of the present invention.

FIG. 37 is an overall perspective view of a beverage preparation apparatus according to present Embodiment 10.

FIG. 38 is a cross-sectional view along the line XXXVIII-XXXVIII in FIG. 37.

FIG. 39 is an overall perspective view showing a schematic component of the beverage preparation apparatus according to Embodiment 10.

FIG. 40 is a block diagram showing a construction of the beverage preparation apparatus according to Embodiment 10.

FIG. 41 shows a first preparation flow for preparing tea using the beverage preparation apparatus according to Embodiment 10.

FIG. 42 shows a second preparation flow for preparing tea using the beverage preparation apparatus according to Embodiment 10.

FIG. 43 shows a third preparation flow for preparing tea using the beverage preparation apparatus according to Embodiment 10.

FIG. 44 is a perspective view showing an internal structure of the beverage preparation apparatus according to Embodiment 10.

FIG. 45 is a perspective view of a milling unit according to Embodiment 10.

FIG. 46 is an exploded perspective view of the milling unit according to Embodiment 10.

FIG. 47 is a vertical cross-sectional view of the milling unit according to Embodiment 10.

FIG. 48 is an exploded perspective view of an agitation unit according to Embodiment 10.

FIG. 49 is a vertical cross-sectional view of the agitation unit according to Embodiment 10.

FIG. 50 is a flowchart showing details of a discharging step in a flow for preparation of a beverage using the beverage preparation apparatus according to Embodiment 10.

FIG. 51 is a diagram showing a state in the agitation tank in the step of starting agitation shown in FIG. 41.

FIG. 52 is a diagram showing a state in the agitation tank after a prescribed period of time has elapsed since end of agitation in the step of end of agitation shown in FIG. 41.

FIG. 53 is a diagram showing a state of tea discharged in the discharging step shown in FIG. 41.

FIG. 54 is a flowchart showing details of the discharging step in the flow for preparation of a beverage using the beverage preparation apparatus according to Embodiment 11.

FIG. 55 is a flowchart showing details of the discharging step in the flow for preparation of a beverage using the beverage preparation apparatus according to Embodiment 12.

FIG. 56 is a flowchart showing an operation of the agitation unit between the step of end of agitation preceding the discharging step and the discharging step in the flow for preparation of a beverage using the beverage preparation apparatus according to Embodiment 13.

FIG. 57 is a cross-sectional view of a beverage preparation apparatus according to Embodiment 14.

FIG. 58 is an overall perspective view of a beverage preparation apparatus according to Embodiment 15.

FIG. 59 is a cross-sectional view along the line LIX-LIX in FIG. 58.

FIG. 60 is an overall view showing a schematic component of the beverage preparation apparatus according to Embodiment 15.

FIG. 61 shows a first preparation flow showing discharge of tea using the beverage preparation apparatus according to Embodiment 15.

FIG. 62 shows a second preparation flow showing discharge of tea using the beverage preparation apparatus according to Embodiment 15.

FIG. 63 shows a third preparation flow showing discharge of tea using the beverage preparation apparatus according to Embodiment 15.

FIG. 64 is a perspective view showing an internal structure of the beverage preparation apparatus according to Embodiment 15.

FIG. 65 is a perspective view of a milling unit according to Embodiment 15.

FIG. 66 is an exploded perspective view of the milling unit according to Embodiment 15.

FIG. 67 is a vertical cross-sectional view of the milling unit according to Embodiment 15.

FIG. 68 is an exploded perspective view of an agitation unit according to Embodiment 15.

FIG. 69 is a vertical cross-sectional view of the agitation unit according to Embodiment 15.

FIG. 70 is a schematic cross-sectional view showing an agitated liquid produced in the agitation unit according to Embodiment 15 and a discharge mechanism.

FIG. 71 is a schematic cross-sectional view showing a state that the discharge mechanism shown in FIG. 70 is opened and a first discharge path is defined.

FIG. 72 is a schematic cross-sectional view showing a state that the discharge mechanism shown in FIG. 70 is opened and a second discharge path is defined.

FIG. 73 is a schematic cross-sectional view showing an agitated liquid produced in an agitation unit according to Embodiment 16 and a discharge mechanism.

FIG. 74 is a schematic cross-sectional view showing a state after some of the agitated liquid has been discharged from the state shown in FIG. 73.

FIG. 75 is a schematic cross-sectional view showing an agitated liquid produced in an agitation unit according to Embodiment 17 and a discharge mechanism.

FIG. 76 is a schematic cross-sectional view showing a state that the discharge mechanism of the agitation unit shown in FIG. 75 is opened and a second discharge path is defined.

FIG. 77 is a schematic cross-sectional view showing an agitated liquid produced in an agitation unit according to Embodiment 18 and a discharge mechanism.

FIG. 78 is a front view of the discharge mechanism shown in FIG. 77.

FIG. 79 is a schematic cross-sectional view showing a state that the discharge mechanism shown in FIG. 77 is opened and the agitated liquid is discharged.

FIG. 80 is a schematic cross-sectional view showing an agitated liquid produced in an agitation unit according to Embodiment 19 and a discharge mechanism.

### DESCRIPTION OF EMBODIMENTS

Embodiments of the present invention will be described hereinafter in detail with reference to the drawings. In the embodiments shown below, the same or common elements have the same reference characters allotted in the drawings and description thereof will not be repeated.

In the present embodiment, though a case that tea leaves are used as an object to be grated and tea is prepared as a beverage will be described by way of example, the object to be grated is not limited to tea leaves, but the embodiment can also be applied to preparation of a beverage with cereals, dried goods, and other objects to be grated. Hereinafter, tea leaves mean a solid state before grating, tea leaf powders mean grated tea leaves, and tea means a beverage obtained by agitating (mixing) tea leaf powders and hot water.

### Embodiment 1

### Beverage Preparation Apparatus 1

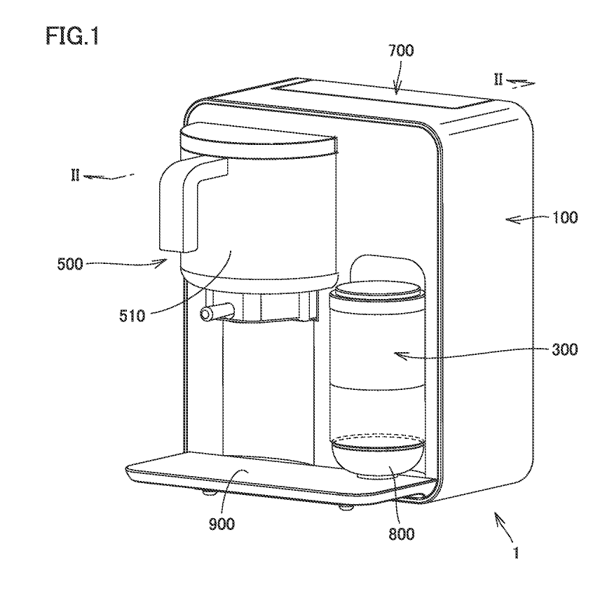

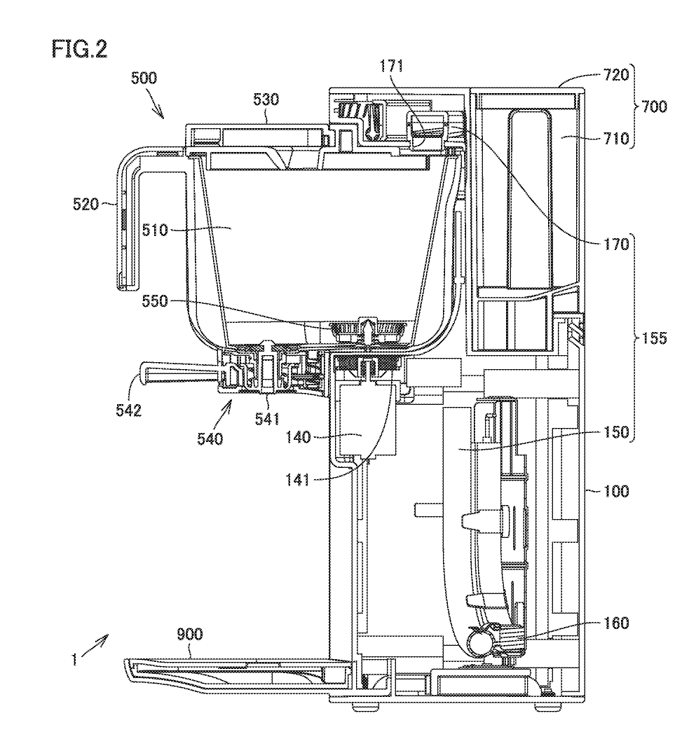

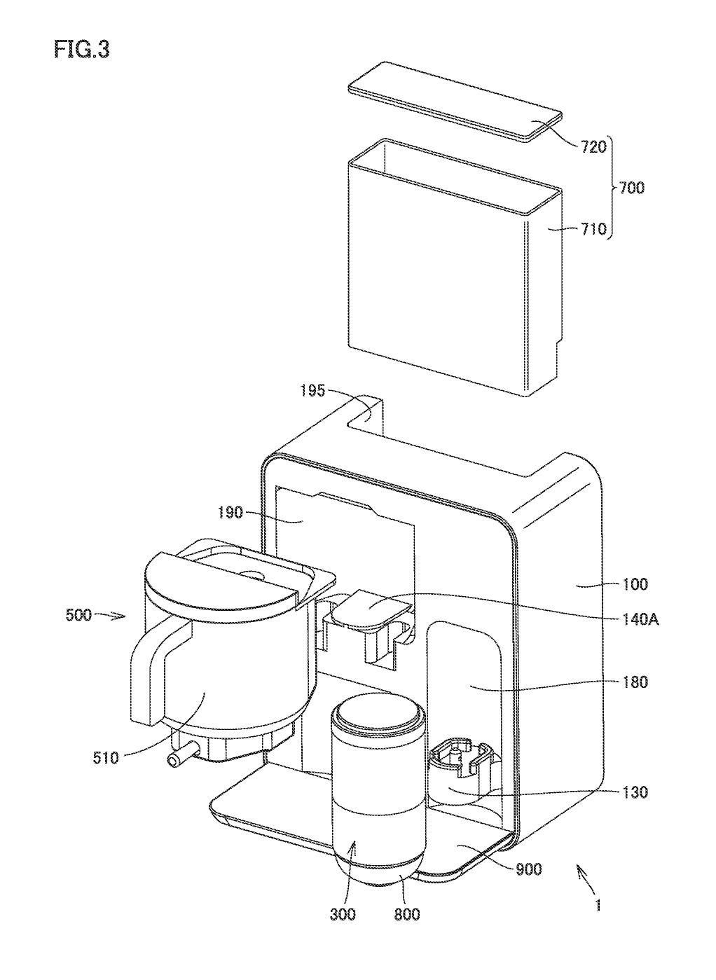

A beverage preparation apparatus 1 in the present embodiment will be described with reference to FIGS. 1 to 3. FIG. 1 is an overall perspective view of beverage preparation apparatus 1, FIG. 2 is a cross-sectional view along the line II-II in FIG. 1, and FIG. 3 is an overall perspective view of a schematic component of beverage preparation apparatus 1.

As shown in FIGS. 1 to 3, beverage preparation apparatus 1 uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100 as a main body portion, a milling unit 300, an agitation unit 500, a liquid storage tank 700, a liquid supply path 155 as a liquid supply portion (see FIG. 2), a tea leaf powder tray 800 as a powder reception portion, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can move the tray by holding the tray.

(Milling Unit 300)

Milling unit 300 is removably attached to a milling unit attachment portion 180 provided on a front surface side of apparatus main body 100. A milling driving force coupling mechanism 130 is provided in milling unit attachment portion 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

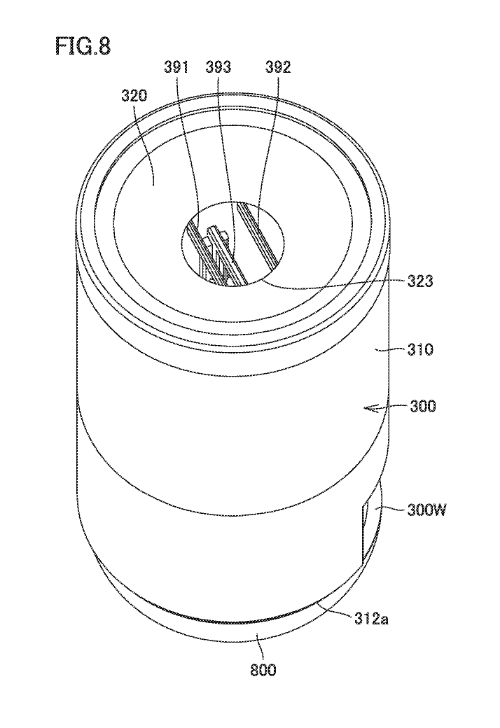

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 8 to 10.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water which is introduced from the outside by removing lid portion 720.

A plurality of guidelines for showing guides for amounts of a liquid to be stored in accordance with an amount of tea to be prepared are provided on an inner circumferential surface of liquid storage tank 700. For example, four guidelines are provided to extend in a circumferential direction of the inner circumferential surface. The four guidelines are provided at a distance from each other in a vertical direction.

A first guideline located at a lowermost position indicates a water level position when an amount of water recommended for preparing half a cup of tea is introduced in liquid storage tank 700. In this case, half a cup is preferably within a range from 70 cc to 80 cc and preferably substantially 75 cc.

A second guideline located at a second position from a bottom side indicates a water level position when an amount of water recommended for preparing one serving of tea (a cup of tea) is introduced in liquid storage tank 700. A third guideline located at a third position from the bottom side indicates a water level position when an amount of water recommended for preparing two servings of tea (two cups of tea) is introduced in liquid storage tank 700. A fourth guideline located at an uppermost position (the fourth from the bottom side) indicates a water level position when an amount of water recommended for preparing three servings of tea (three cups of tea) is introduced in liquid storage tank 700. With such guidelines, a guideline amount of supply of a liquid supplied from liquid storage tank 700 into agitation unit 500 is predetermined

(Liquid Supply Path 155)

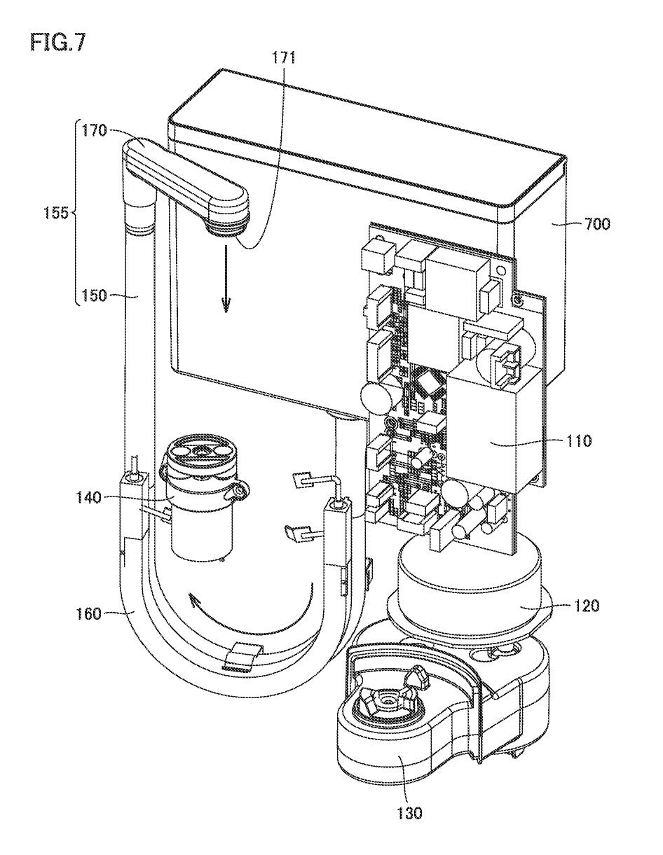

Liquid supply path 155 is accommodated in apparatus main body 100. Liquid supply path 155 is connected to liquid storage tank 700 (see FIG. 7). Liquid supply path 155 is provided with a supply port 171 on a side opposite to a side where liquid storage tank 700 is connected. Liquid supply path 155 includes a hot water supply pipe 150 and a hot water supply nozzle 170. Hot water supply pipe 150 has one end side connected to liquid storage tank 700 and the other end side connected to hot water supply nozzle 170. A liquid introduced from liquid storage tank 700 into liquid supply path 155 is supplied to agitation unit 500 through hot water supply pipe 150 and hot water supply nozzle 170.

(Agitation Unit 500)

Agitation unit 500 includes an agitation blade 550 for agitating a liquid and powders and agitation tank 510 accommodating agitation blade 550. Agitation blade 550 corresponds to an agitation member. Agitation tank 510 is removably attached to an agitation tank attachment portion 190 provided on the front surface side of apparatus main body 100. Agitation tank 510 is attached to agitation tank attachment portion 190 such that a part of agitation tank 510 protrudes from a front surface of apparatus main body 100 along a direction of normal to the front surface.

An agitation motor contactless table 140A is provided in agitation tank attachment portion 190. Agitation unit 500 is placed on agitation motor contactless table 140A. Agitation blade 550 provided in agitation unit 500 is rotated by an agitation motor unit 140 and a permanent magnet 141 coupled thereto. Agitation motor unit 140 and permanent magnet 141 are accommodated in apparatus main body 100 so as to be located below agitation motor contactless table 140A. Agitation motor unit 140 corresponds to an agitation blade drive portion which rotationally drives agitation blade 550.

Hot water supply nozzle 170 is provided above agitation tank attachment portion 190 of apparatus main body 100. In apparatus main body 100, a temperature of water in hot water supply pipe 150 is raised to a prescribed temperature and hot water is supplied from hot water supply nozzle 170 into agitation tank 510. Hot water prepared in apparatus main body 100 and tea leaf powders obtained by milling unit 300 are introduced into agitation tank 510, and hot water and tea leaf powders are agitated by agitation blade 550 in agitation tank 510. Tea is thus prepared in agitation tank 510.

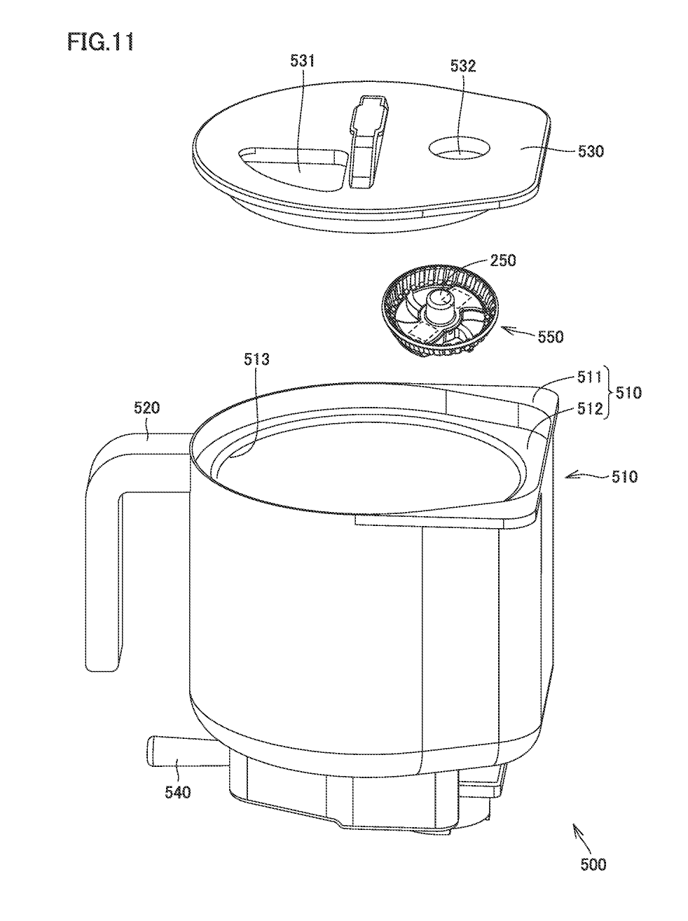

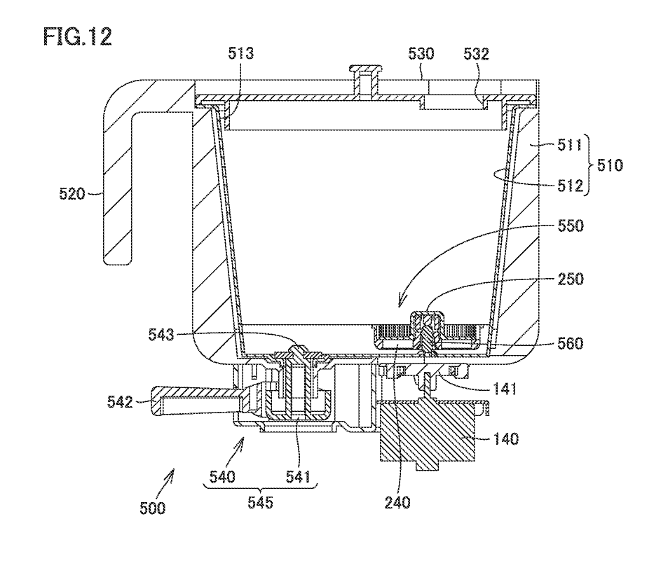

Tea prepared in agitation unit 500 can be poured into a cup (not shown) placed on placement base 900 by operating an operation lever 542 of a discharge port opening and closing mechanism 540 provided below agitation unit 500. A detailed structure of agitation unit 500 will be described later with reference to FIGS. 11 and 12.

(Flow of Preparation of Tea (Beverage))

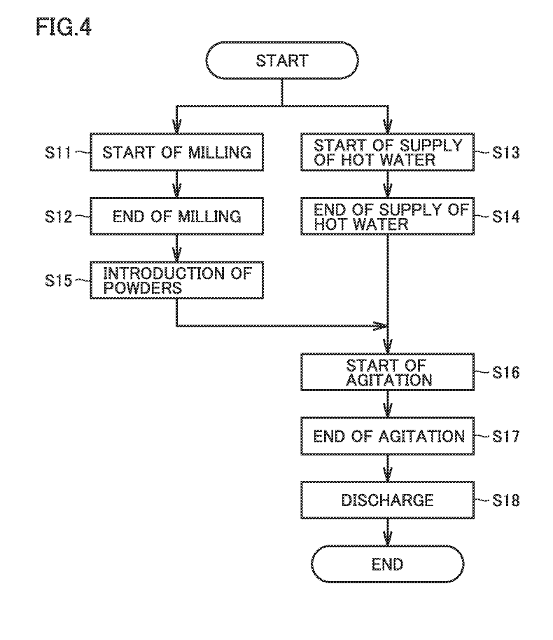

A flow of preparation of tea (beverage) with the use of beverage preparation apparatus 1 will now be described with reference to FIGS. 4 to 6. FIGS. 4 to 6 show first to third preparation flows showing discharge of tea using beverage preparation apparatus 1, respectively. A prescribed amount of tea leaves is introduced into milling unit 300 and a prescribed amount of water is stored in liquid storage tank 700.

(First Preparation Flow)

A first preparation flow will be described with reference to FIG. 4. This first preparation flow is a flow in which grating of tea leaves in milling unit 300 and supply of hot water from apparatus main body 100 to agitation unit 500 are simultaneously carried out.

In beverage preparation apparatus 1, milling of tea leaves by milling unit 300 in a step 11 and supply of hot water from apparatus main body 100 to agitation unit 500 in a step 13 are simultaneously started. Then, milling of tea leaves by milling unit 300 ends in a step 12, and supply of hot water from apparatus main body 100 to agitation unit 500 ends in a step 14.

In a step 15, tea leaf powders obtained in step 12 are introduced into agitation unit 500 by a user.

Then, in a step 16, agitation of the tea leaf powders and hot water in agitation unit 500 is started. In a step 17, agitation of the tea leaf powders and hot water in agitation unit 500 ends. In a step 18, tea is discharged into the cup placed on placement base 900 as the user operates operation lever 542 of discharge port opening and closing mechanism provided below agitation unit 500. According to the present flow, since milling of tea leaves and supply of hot water are simultaneously performed, a tea beverage can efficiently be prepared in a short period of time.

(Second Preparation Flow)

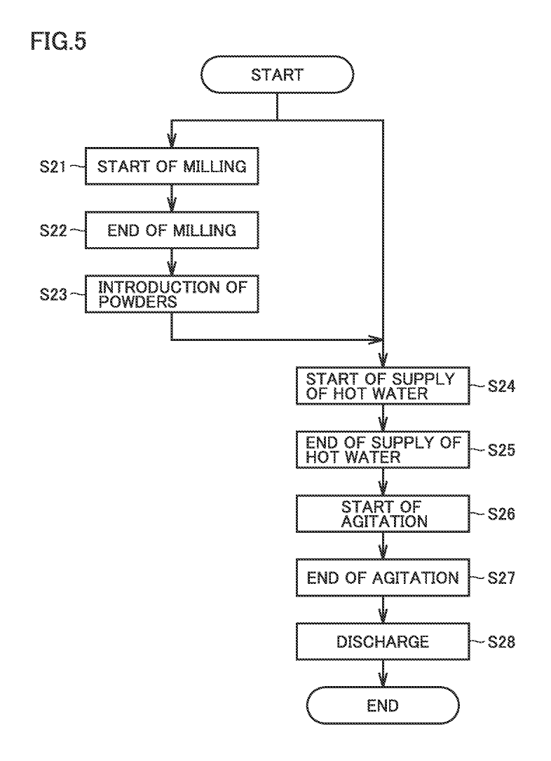

A second preparation flow will be described with reference to FIG. 5. This second preparation flow is a flow in which hot water is supplied from apparatus main body 100 to agitation unit 500 after tea leaves are grated in milling unit 300.

In beverage preparation apparatus 1, in a step 21, milling of tea leaves by milling unit 300 is started. In a step 22, milling of tea leaves by milling unit 300 ends. In a step 23, tea leaf powders obtained in step 22 are introduced into agitation unit 500 by a user.

In a step 24, supply of hot water from apparatus main body 100 to agitation unit 500 is started. In a step 25, supply of hot water from apparatus main body 100 to agitation unit 500 ends.

Then, in a step 26, agitation of the tea leaf powders and hot water in agitation unit 500 is started. In a step 27, agitation of the tea leaf powders and hot water in agitation unit 500 ends. In a step 28, tea is discharged into the cup placed on placement base 900 as the user operates operation lever 542 of discharge port opening and closing mechanism 540 provided below agitation unit 500. According to the present flow, since hot water is supplied after tea leaves are milled, lowering in temperature of hot water can be suppressed.

(Third Preparation Flow)

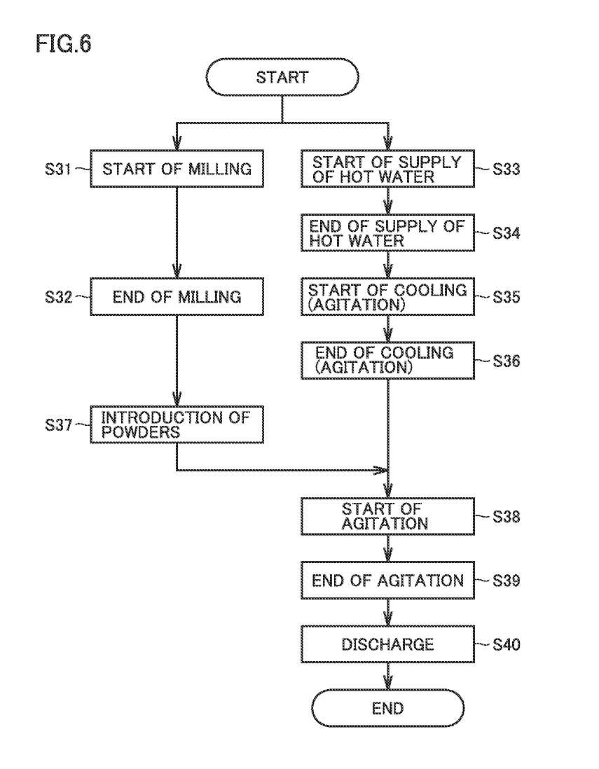

A third preparation flow will be described with reference to FIG. 6. This third preparation flow includes a step of cooling hot water by agitation in agitation unit 500.

In beverage preparation apparatus 1, milling of tea leaves by milling unit 300 in a step 31 and supply of hot water from apparatus main body 100 to agitation unit 500 in a step 33 are simultaneously started. In a step 34, supply of hot water from apparatus main body 100 to agitation unit 500 ends.

Then, in a step 32, milling of tea leaves by milling unit 300 ends, and in a step 35, cooling by agitation of hot water supply is started in agitation unit 500. In a step 36, cooling by agitation of hot water supply in agitation unit 500 ends.

In a step 37, the tea leaf powders obtained in step 32 are introduced into agitation unit 500 by a user.

Then, in a step 38, agitation of the tea leaf powders and hot water in agitation unit 500 is started. In a step 39, agitation of the tea leaf powders and hot water in agitation unit 500 ends. In a step 40, tea is discharged into the cup placed on placement base 900 as the user operates operation lever 542 of discharge port opening and closing mechanism 540 provided below agitation unit 500. According to the present flow, a tea beverage can be prepared at an appropriate temperature from tea leaves suitable for hot water at a relatively low temperature, such as gyokuro.

(Internal Structure of Apparatus Main Body 100)

An internal structure of apparatus main body 100 will now be described with reference to FIG. 7. FIG. 7 is a perspective view showing the internal structure of beverage preparation apparatus 1. In apparatus main body 100 of beverage preparation apparatus 1, a control unit 110 including a printed circuit board on which electronic components are mounted is arranged on a front surface side of liquid storage tank 700. Based on input of a start signal by a user, the flow for preparation of tea is executed by control unit 110.

A milling motor unit 120 for providing driving force to milling unit 300 is arranged at a position below control unit 110. Milling driving force coupling mechanism 130 provided to protrude forward for transmitting driving force of milling motor unit 120 to milling unit 300 is provided at a position below milling motor unit 120.

To a bottom surface of liquid storage tank 700, one end of hot water supply pipe 150 extending once downward from the bottom surface and then extending upward in a U shape is coupled. Hot water supply nozzle 170 for pouring hot water into agitation tank 510 of agitation unit 500 is coupled to an upper end portion of hot water supply pipe 150. A U-shaped heater 160 for heating water which passes through hot water supply pipe 150 is attached to an intermediate region of hot water supply pipe 150.

(Structure of Milling Unit 300)

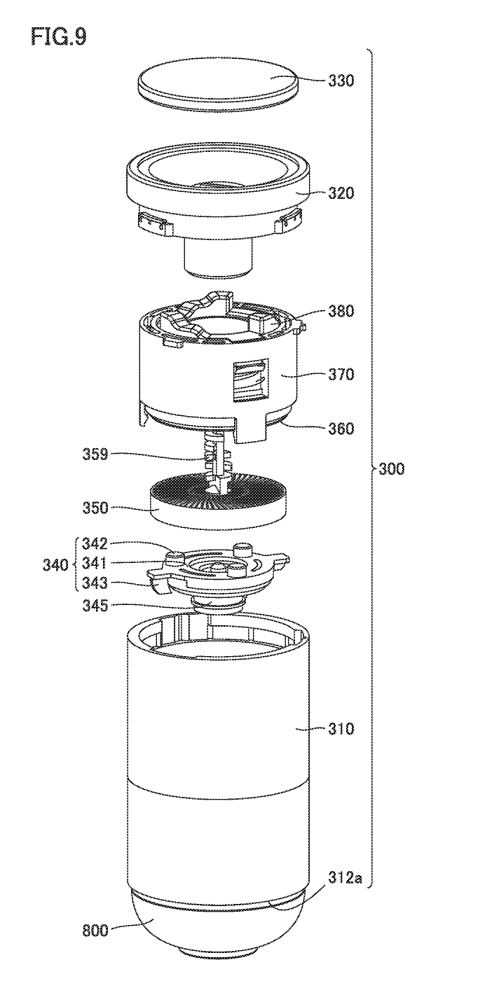

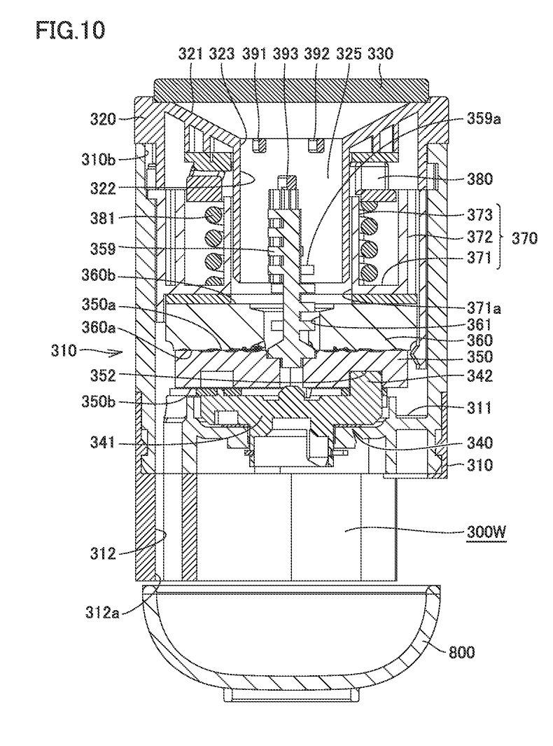

A structure of milling unit 300 will now be described with reference to FIGS. 8 to 10. FIG. 8 is a perspective view of milling unit 300, FIG. 9 is an exploded perspective view of milling unit 300, and FIG. 10 is a vertical cross-sectional view of milling unit 300.

Milling unit 300 has a milling case 310 having a cylindrical shape as a whole, and a window for coupling 300W in which milling driving force coupling mechanism 130 is inserted is provided in a side surface below. A storage portion 311 (see FIG. 10) for storing tea leaf powders produced by an upper mill 360 and a lower mill 350 and a discharge path 312 communicating with storage portion 311 are provided in milling case 310. An outlet port 312a for discharging tea leaf powders into tea leaf powder tray 800 is provided at a lower end portion of discharge path 312 which is a lowermost end portion of milling case 310. Outlet port 312a is provided below an opening portion 513 of a thermally insulated tank 512 (see FIG. 12) which will be described later. Entry through outlet port 312a, of steam resulting from hot water supplied into thermally insulated tank 512 can thus be prevented.

Milling unit 300 includes upper mill 360 and lower mill 350 which grate an object to be grated and a lower mill support portion 340 to which lower mill 350 is attached. In milling case 310, lower mill support portion 340, lower mill 350, and upper mill 360 are successively provided from below.

Lower mill support portion 340 supports lower mill 350 from a side opposite to a side where upper mill 360 is located (a side below lower mill 350). Lower mill support portion 340 has a substantially columnar main body portion 341, an engagement protrusion portion 342, and a powder scraping portion 343. A milling shaft 345 is provided on a lower surface of main body portion 341 and extends downward. Milling shaft 345 is coupled to milling driving force coupling mechanism 130. Lower mill support portion 340 is thus rotatable while it supports lower mill 350.

Engagement protrusion portion 342 is provided on an upper surface of main body portion 341 and protrudes upward. Engagement protrusion portion 342 is a site for locking lower mill 350. Powder scraping portion 343 is provided around a circumferential portion of main body portion 341. Powder scraping portion 343 scrapes off tea leaf powders stored in storage portion 311 and transports the tea leaf powders to discharge path 312 as lower mill support portion 340 rotates.

Lower mill 350 includes a main surface 350a arranged to be opposed to a main surface 360a of upper mill 360, a main surface 350b located opposite to main surface 350a, and a circumferential surface connecting main surface 350a and main surface 350b to each other. A plurality of shear grooves are formed in main surface 350a of lower mill 350. The plurality of shear grooves are provided, for example, to extend along an equiangular spiral. The plurality of shear grooves may be such that linear grooves extending from an inner circumferential side toward an outer circumference are radially provided.

An engagement recess portion 352 is provided in main surface 350b of lower mill 350. Engagement recess portion 352 is provided at a position corresponding to engagement protrusion portion 342 of lower mill support portion 340 and locked by engagement protrusion portion 342. Lower mill 350 thus rotates in coordination with lower mill support portion 340. A core 359 extending upward along a core of a rotation shaft is provided in a central portion of lower mill 350.

Core 359 is provided to pass through a through hole 361 provided in a central portion of upper mill 360. Core 359 has a helically provided helical blade 359a.

Upper mill 360 includes main surface 360a arranged to be opposed to main surface 350a of lower mill 350, a main surface 360b located opposite to main surface 360a, and a circumferential surface connecting main surface 360a and main surface 360b to each other. A shear groove is formed in main surface 360a of upper mill 360, as in main surface 350a of the lower mill.

Upper mill 360 is held by an upper mill holding member 370 arranged above the upper mill. A not-shown hole portion is provided in an upper surface of upper mill 360. As a not-shown pin portion provided in upper mill holding member 370 enters the hole portion, rotation of upper mill 360 is prevented.

Upper mill holding member 370 includes a bottom surface portion 371 provided with a hole portion 371a, an outer cylindrical portion 372 erected upward from a circumference of bottom surface portion 371, and an inner cylindrical portion 373 erected upward from a circumference of hole portion 371a. Hole portion 371a is provided to communicate with through hole 361 in upper mill 360. A spring 381 pressing upper mill 360 downward and a spring holding member 380 are accommodated in between outer cylindrical portion 372 and inner cylindrical portion 373. Spring 381 adjusts a grating pressure applied between upper mill 360 and lower mill 350.

A hopper portion 320 for supplying an object to be grated in between upper mill 360 and lower mill 350 is attached to a side of an upper end opening portion 310b of milling case 310. Hopper portion 320 has a top plate portion 321, a cylindrical portion 322, and an object-to-be-grated inlet 325. Top plate portion 321 has such a bowl shape that an opening portion 323 is provided substantially in a central portion. Cylindrical portion 322 is provided to extend downward from a circumference of opening portion 323. Cylindrical portion 322 is inserted in inner cylindrical portion 373.

Object-to-be-grated inlet 325 is defined by opening portion 323 and cylindrical portion 322. A tip end side of core 359 is accommodated in object-to-be-grated inlet 325. In cylindrical portion 322, a plurality of linear ribs 391, 392, and 393 are provided across object-to-be-grated inlet 325.

In grating tea leaves, hopper portion 320 is preferably covered with a cover portion 330. Thus, after tea leaves are introduced into object-to-be-grated inlet 325, entry of a foreign matter into milling unit 300 and scattering of grated tea leaves can be prevented. When tea leaves are to be introduced, cover portion 330 is removed from hopper portion 320.

Tea leaves introduced into object-to-be-grated inlet 325 are accommodated in a space defined by the upper surface of upper mill 360 exposed through upper mill holding member 370 and an inner circumferential surface of cylindrical portion 322. Tea leaves accommodated in the space are guided in between upper mill 360 and lower mill 350 as helical blade 359a rotates with rotation of lower mill 350.

Tea leaves guided in between upper mill 360 and lower mill 350 are grated and fall downward in a form of tea leaf powders from a circumference of upper mill 360 and lower mill 350. Some of fallen tea leaf powders is discharged through discharge path 312 into tea leaf powder tray 800 from outlet port 312a. Other fallen tea leaf powders are stored in storage portion 311. Tea leaf powders in storage portion 311 are transported to discharge path 312 and discharged from outlet port 312a into tea leaf powder tray 800 as powder scraping portion 343 rotates with rotation of lower mill support portion 340.

(Structure of Agitation Unit 500)

A structure of agitation unit 500 will now be described with reference to FIGS. 11 and 12. FIG. 11 is a perspective view of agitation unit 500 and FIG. 12 is a vertical cross-sectional view of agitation unit 500.

Agitation unit 500 is in a shape of a container having an opening upper surface and includes agitation tank 510, agitation blade 550, an agitation cover 530, and discharge port opening and closing mechanism 540. Agitation tank 510 includes an exterior holder 511 made of a resin and thermally insulated tank 512 held by exterior holder 511. An integrally resin molded grip 520 is provided in exterior holder 511. Thermally insulated tank 512 has opening portion 513 which has a cylindrical shape with bottom and opens upward.

Agitation cover 530 is attached to opening portion 513 so as to be able to open and close opening portion 513. Agitation cover 530 is provided with a powder inlet 531 for introducing tea leaf powders grated by milling unit 300 and a hot water supply inlet 532 through which hot water formed in apparatus main body 100 is poured from hot water supply nozzle 170. Hot water supply inlet 532 is provided at a position corresponding to supply port 171 of hot water supply nozzle 170.

Powder inlet 531 and hot water supply inlet 532 communicate with opening portion 513. Tea leaf powders introduced from moved tea leaf powder tray 800 to powder inlet 531 are introduced into thermally insulated tank 512 through opening portion 513. Hot water poured through hot water supply inlet 532 from hot water supply nozzle 170 is supplied into thermally insulated tank 512 through opening portion 513.

Agitation blade 550 is placed on a bottom portion of agitation tank 510. A rotation shaft 560 extending upward is provided on the bottom portion of agitation tank 510, and a cylindrical core 250 of agitation blade 550 is inserted in this rotation shaft 560.

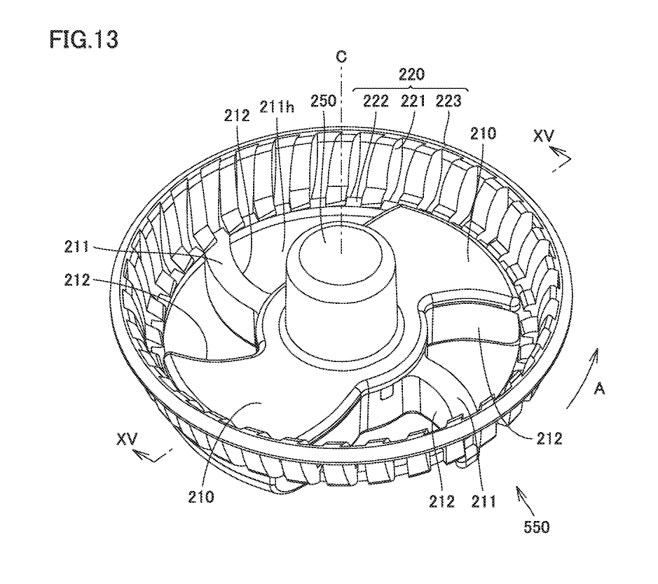

A permanent magnet 240 is embedded in agitation blade 550. In agitation motor contactless table 140A, permanent magnet 240 embedded in agitation blade 550 and permanent magnet 141 provided on a side of agitation motor unit 140 are magnetically coupled in a contactless state, so that rotational driving force of agitation motor unit 140 is transmitted to agitation blade 550. Details of agitation blade 550 will be described later with reference to FIGS. 13 to 15.

Agitation tank 510 further includes a discharge portion 545 for discharging a prepared beverage. Discharge portion 545 is provided in agitation tank 510 in a portion protruding from apparatus main body 100. Discharge portion 545 includes a discharge port 541 provided in the bottom portion of agitation tank 510 and discharge port opening and closing mechanism 540 opening and closing discharge port 541. Discharge port 541 is a portion for discharging tea prepared by agitation of tea leaf powders and hot water by agitation blade 550.

Discharge port opening and closing mechanism 540 includes an opening and closing nozzle 543 inserted into discharge port 541 so as to be able to open and close discharge port 541 and operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541 and thus tea in agitation tank 510 is poured into a cup (not shown) placed on placement base 900.

(Structure of Agitation Blade 550)

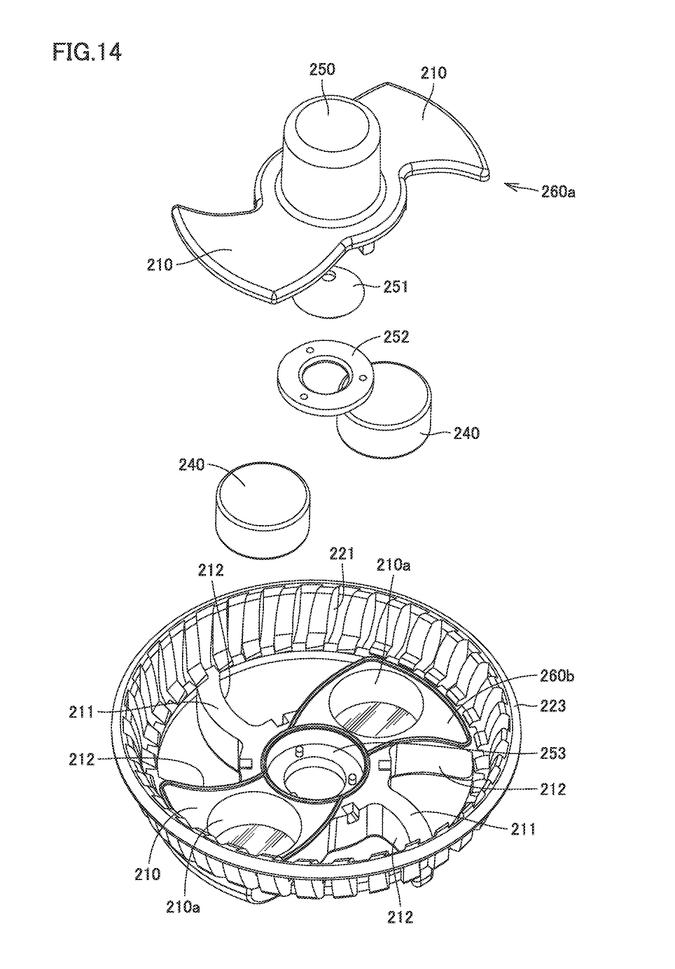

A structure of agitation blade 550 in the present embodiment will now be described with reference to FIGS. 13 to 15. FIG. 13 is a perspective view showing a shape of agitation blade 550, FIG. 14 is an exploded perspective view showing a structure of agitation blade 550, and FIG. 15 is a cross-sectional view along the line XV-XV in FIG. 13.

Referring to FIGS. 13 and 14, agitation blade 550 includes in the center, cylindrical core 250 in which a rotation shaft is inserted. Cylindrical core 250 implements a rotation portion having a central axis of rotation (C). Agitation blade 550 includes a first paddle 210, a second paddle 211, and a blade portion 220. A pair of first paddles 210 extends radially from an outer circumferential surface of cylindrical core 250, the paddles being provided at positions opposed to each other at an angle of 180 degrees. A pair of second paddles 211 is provided with the paddles being provided at positions opposed to each other at an angle of 180 degrees, each at a position rotated by 90 degrees from first paddle 210.

Blade portion 220 includes a plurality of blade pieces 221, a lower auxiliary ring 222, and an upper auxiliary ring 223. Lower auxiliary ring 222 is provided on an outer circumferential surface of the pair of first paddles 210 and an outer circumferential surface of the pair of second paddles 211. Lower auxiliary ring 222 has such a shape as not producing a resistance in a direction of rotation (a direction shown with an arrow A in the figures).

A plurality of blade pieces 221 extending toward an upper surface (a first surface) of first paddle 210 and second paddle 211 are provided on lower auxiliary ring 222 so as to surround central axis of rotation C and to be in rotation symmetry with respect to central axis of rotation C. An upper end portion of blade piece 221 is coupled to upper auxiliary ring 223. Upper auxiliary ring 223 also has a shape not producing a resistance in the direction of rotation, similarly to lower auxiliary ring 222. A detailed shape of blade piece 221 will be described later.

The pair of first paddles 210 has a curved paddle surface 212 formed, which has a prescribed thickness downward (toward a second surface), has a curved shape recessed on a downstream side when viewed in the direction of rotation, and contributes to agitation in the direction of rotation (the direction shown with arrow A in the figures). Similarly, second paddle 211 has curved paddle surface 212 formed, which has a prescribed thickness downward (toward the second surface), has a curved shape recessed on the downstream side when viewed in the direction of rotation, and contributes to agitation in the direction of rotation (the direction shown with arrow A in the figures). Paddle surfaces 212 are provided at four locations, and four spaces 210h in total are formed between first paddles 210 and second paddles 211. Permanent magnet 240 is embedded in the pair of first paddles 210.

Cylindrical core 250 and the pair of first paddles 210 include an integrally formed cover 260a. A cylindrical accommodation portion 210a for accommodating permanent magnet 240 is provided in a paddle main body 260b of first paddle 210. Rotation is transmitted to permanent magnet 240 embedded in the pair of first paddles 210, by a contactless rotational drive mechanism (agitation motor unit 140 and permanent magnet 141) by means of magnetic force. In order to enhance holding capability owing to magnetic force during rotational drive, the permanent magnet is desirably provided at two locations.

A through hole 253 in which the rotation shaft is inserted is provided between the pair of first paddles 210. A conical cap 251 is accommodated in cylindrical core 250 for smooth rotation of agitation blade 550 with a tip end of the rotation shaft being in point contact. A ring seal 252 for ensuring water tightness is fitted in between cover 260a and paddle main body 260b.

A shape of blade piece 221 will now be described with reference to FIG. 15. An angle of inclination θ spreading outward in an upward direction is provided in blade piece 221. Angle of inclination θ is set, for example, to approximately 75 degrees. Depending on angle of inclination θ, agitation blade 550 can obtain high agitation force with an outer shape being the same, or load imposed on the rotational drive portion can be lowered with agitation force being the same.

Depending on angle of inclination θ, ease in cleaning of agitation blade 550 improves. An area where height ha of first paddle 210 and second paddle 211 produces a resistance (contributes to agitation force) in the direction of rotation as shown in FIG. 15 with respect to a total height h of agitation blade 550 is defined. In the present embodiment, desirably, h=9.5 mm and ha=5.5 mm Blade piece 221 desirably has an inner diameter d1=φ30 mm and an outer diameter d=φ32 mm. When agitation blade 550 having such a dimension is employed, fine foams can be produced when a depth of water is not smaller than 19 mm and not greater than 38 mm from the bottom portion. When the depth of water is too small, a swirl is not formed and it becomes difficult to take in air from the liquid level through the swirl. When the depth of water is too large, the swirl does not reach blade portion 220 and hence it becomes difficult to produce fine foams.

As agitation blade 550 is rotated, as a result of an agitation function of agitation blade 550, force in a direction substantially orthogonal to central axis of rotation C is applied to hot water. Consequently, a swirl is formed to reach agitation blade 550. By sending air taken into hot water through the swirl together with hot water from the central portion to the outer circumferential portion of agitation blade 550, tea leaf powders and hot water are agitated while foams are formed. The formed foams are crushed as a result of collision with blade piece 221 and fine foams are obtained.

Though an example in which agitation blade 550 constructed as above is employed as the agitation member is described, limitation thereto is not intended and an agitation member provided with an agitation element in an outer circumferential portion can be adopted as the agitation member as appropriate. A wound portion formed from a wire in a toroidal shape or an impeller can be adopted as the agitation element.

(Shape of Agitation Tank 510)

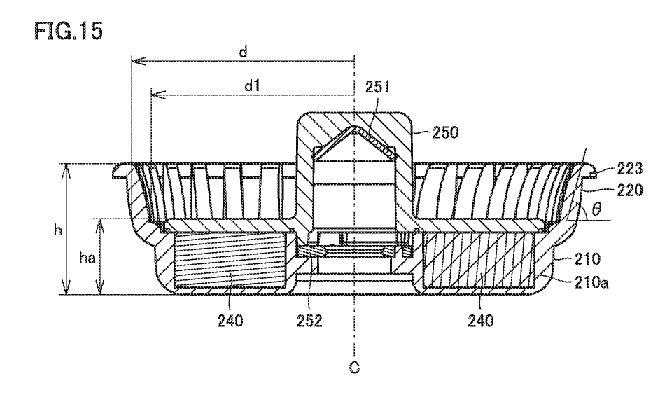

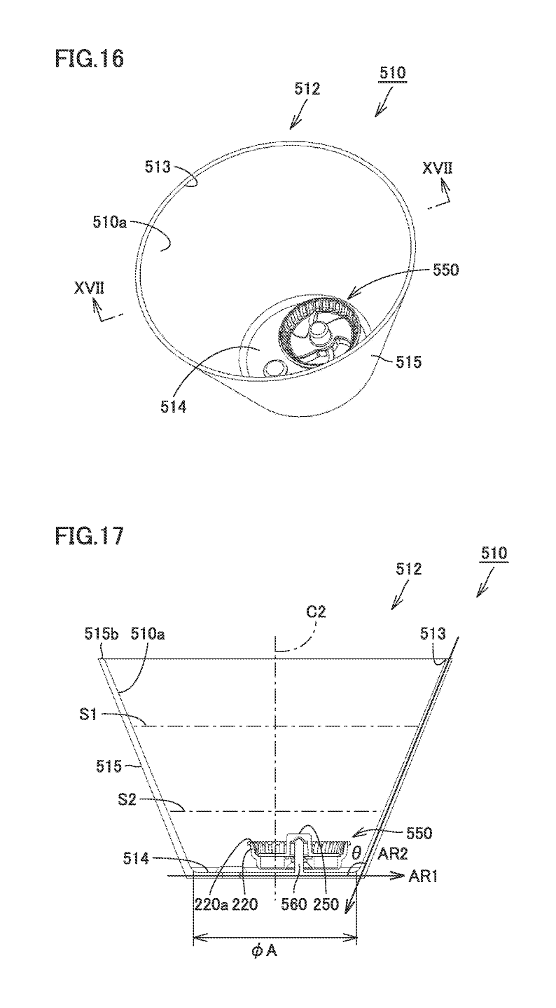

FIG. 16 is a perspective view showing the agitation tank and the agitation blade according to the present embodiment. FIG. 17 is a cross-sectional view along the line XVII-XVII shown in FIG. 16. FIGS. 16 and 17 do not show exterior holder 511 for the sake of convenience in showing agitation tank 510 and shows thermally insulated tank 512 defining an inner circumferential surface 510a of agitation tank 510. A shape of inner circumferential surface 510a of agitation tank 510 according to the present embodiment will be described with reference to FIGS. 16 and 17.

As shown in FIGS. 16 and 17, inner circumferential surface 510a of agitation tank 510 according to the present embodiment is defined by an inner surface of a side wall portion 515 of thermally insulated tank 512. A bottom portion 514 of thermally insulated tank 512 corresponds to the bottom portion of agitation tank 510. Side wall portion 515 of thermally insulated tank 512 is provided to connect to a circumference of bottom portion 514 of thermally insulated tank 512.

Inner circumferential surface 510a of agitation tank 510 is provided such that an area of opening continuously decreases from a side of an upper end 515b of side wall portion 515 toward bottom portion 514. Specifically, inner circumferential surface 510a of agitation tank 510 is in a shape of a frustum.

As shown in FIG. 17, in a cross-section in the central portion of agitation tank 510, an angle θ formed between side wall portion 515 and bottom portion 514 (an angle formed between AR2 and AR1 in the figure) is preferably greater than 90° and not greater than 119°. An inner diameter φ A of bottom portion 514 is preferably not smaller than 60 mm.

A virtual line S1 represents a water level position (a first liquid level position) when hot water is supplied to agitation tank 510 based on a first guideline amount of supply at which the guideline amount of supply described above is maximal and a virtual line S2 represents a water level position (a second liquid level position) when hot water is introduced into agitation tank 510 based on a second guideline amount of supply at which the guideline amount of supply described above is minimal. An area of opening at the first liquid level position is greater than an area of opening at the second liquid level position.

Inner circumferential surface 510a of agitation tank 510 is provided to be inclined as above, so that even when a small amount of hot water is supplied, the liquid level position can be higher than in a container with an area of opening of an opening surface of the agitation tank substantially constant to the bottom portion.

Thus, even when hot water is supplied based on the second guideline amount of supply in order to prepare approximately half a cup of tea less than a cup, the second liquid level position formed thereby is located above upper surface 220a of blade portion 220 of agitation blade 550. Consequently, since the entire blade portion 220 of agitation blade 550 contributing to agitation can be immersed in hot water, hot water and powders can sufficiently be agitated.

Since inner circumferential surface 510a of agitation tank 510 is inclined to radially spread toward an upward direction as described above, displacement in height of a liquid level which varies in accordance with an amount of supplied hot water can be suppressed. Therefore, even when an amount of supply is greater than a prescribed guideline amount of supply, displacement in distance from a liquid level to agitation blade 550 can be suppressed. A state of formed foams is affected by a distance from the liquid level to agitation blade 550. By thus adjusting displacement of the liquid level based on an amount of a liquid, agitation force can sufficiently be ensured and air can sufficiently be taken into hot water. Consequently, satisfactorily fine foams can also be formed.

As set forth above, when agitation unit 500 and beverage preparation apparatus 1 including the same according to the present embodiment are made use of, a liquid can sufficiently be agitated even though an amount of a supplied liquid is small. Agitation unit 500 and beverage preparation apparatus 1 including the same according to the present embodiment can suppress displacement in height of a liquid level which varies with increase in amount of a supplied liquid. Namely, displacement of a liquid level can be adjusted based on an amount of a liquid.

### Embodiment 2

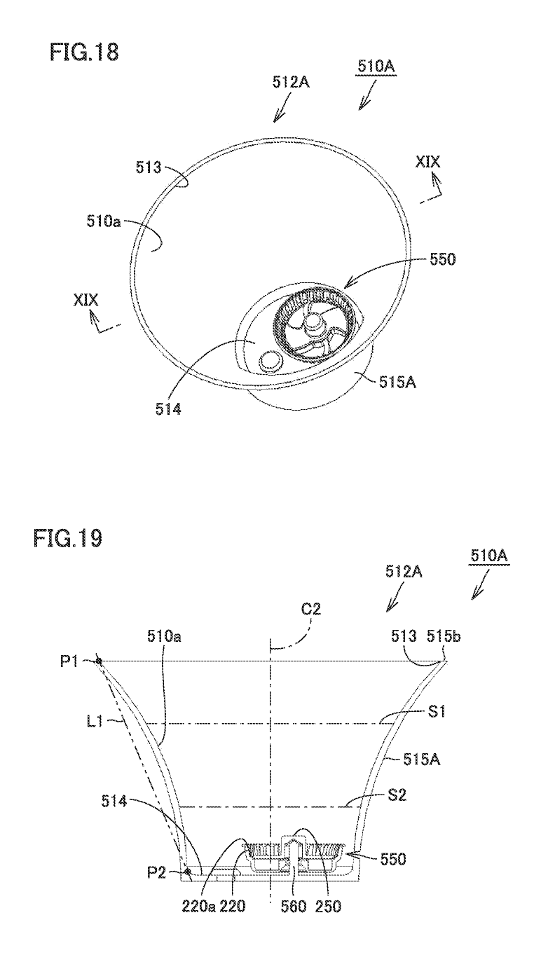

FIG. 18 is a perspective view showing an agitation tank and the agitation blade according to the present embodiment. FIG. 19 is a cross-sectional view along the line XIX-XIX shown in FIG. 18. FIGS. 18 and 19 do not show exterior holder 511 either for the sake of convenience in showing an agitation tank 510A and shows a thermally insulated tank 512A defining inner circumferential surface 510a of agitation tank 510A. A shape of inner circumferential surface 510a of agitation tank 510A according to the present embodiment will be described with reference to FIGS. 18 and 19.

Inner circumferential surface 510a of agitation tank 510A according to the present embodiment has such a curved shape that an area of opening decreases toward bottom portion 514. Specifically, as shown in FIG. 19, in a vertical cross-sectional view with a central axis C2 of agitation tank 510A being defined as the vertical axis, inner circumferential surface 510a of agitation tank 510A has such a curved shape as curving to be recessed inward relatively to a virtual line L1 connecting an upper end P1 and an lower end P2 to each other. Since an angle formed between a lower end portion of a side wall portion 515A and bottom portion 514 is close to 90°, inner diameter φ A of bottom portion 514 can be made larger than in Embodiment 1.

In such a case as well, an area of opening at the first liquid level position when hot water is supplied into agitation tank 510A based on the first guideline amount of supply at which the guideline amount of supply is maximal as shown with virtual line S1 is greater than an area of opening at the second liquid level position when hot water is introduced into agitation tank 510A based on the second guideline amount of supply at which the guideline amount of supply is minimal as shown with virtual line S2.

The second liquid level position is located above upper surface 220a of blade portion 220 of agitation blade 550. Therefore, the entire blade portion 220 can be immersed in a minimal guideline amount of supplied hot water and hot water and the tea leaf powders can sufficiently be agitated.

As set forth above, in the present embodiment as well, inner circumferential surface 510a has such a curved shape that the area of opening decreases toward bottom portion 514, so that a liquid can sufficiently be agitated even when an amount of a supplied liquid is small. Displacement in height of a liquid level which varies with increase in amount of a supplied liquid can be suppressed. Namely, displacement of a liquid level can be adjusted based on an amount of a liquid.

Though an example in which inner circumferential surface 510a of agitation tank 510A has such a curved shape as curving to be recessed inward relatively to virtual line L1 connecting upper end P1 and lower end P2 to each other in the vertical cross-sectional view with central axis C2 of agitation tank 510A being defined as the vertical axis is described in the present embodiment, limitation thereto is not intended and inner circumferential surface 510a may have such a curved shape as curving to project outward relatively to virtual line L1. In this case, a beverage is less likely to spill when agitation ends and the agitation unit containing a prepared beverage is carried, and thus handleability is improved.

### Embodiment 3

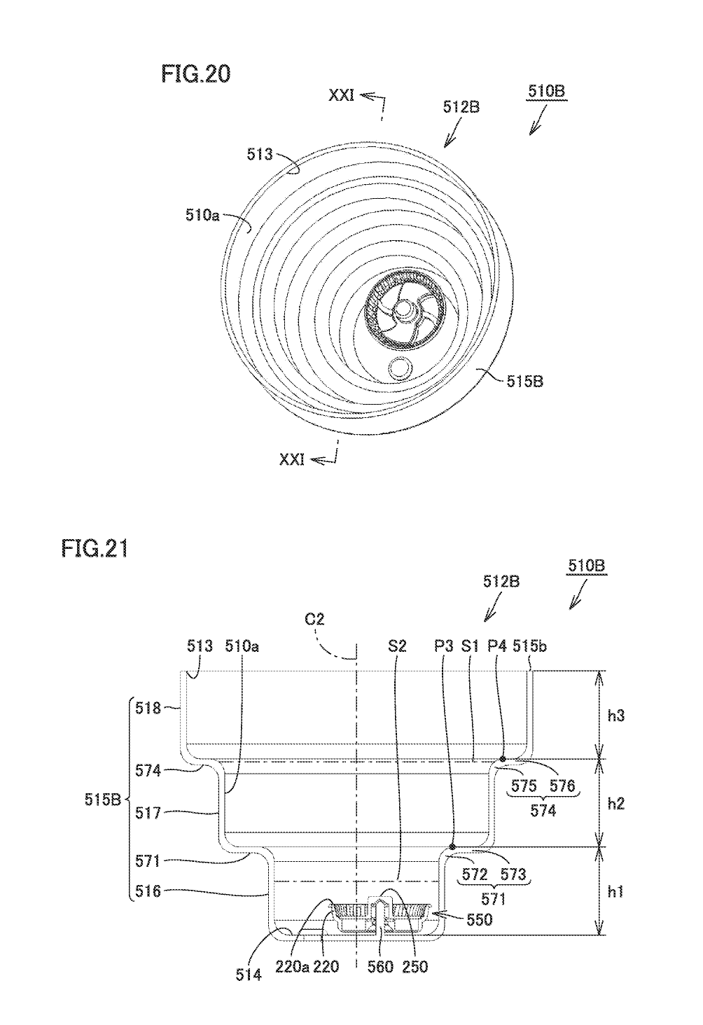

FIG. 20 is a perspective view showing an agitation tank and the agitation blade according to the present embodiment. FIG. 21 is a cross-sectional view along the line XXI-XXI shown in FIG. 20. FIGS. 20 and 21 do not show exterior holder 511 either for the sake of convenience in showing an agitation tank 510B and shows a thermally insulated tank 512B defining inner circumferential surface 510a of agitation tank 510B. Agitation tank 510B according to the present embodiment will be described with reference to FIGS. 20 and 21.

Inner circumferential surface 510a of agitation tank 510B according to the present embodiment is in a form of a staircase. Thus, an area of opening of agitation tank 510B decreases stepwise toward bottom portion 514. Specifically, an area of opening of agitation tank 510B at a central position in a direction of height (a direction of an axial line of central axis C2 of agitation tank 510B) of a third cylindrical portion 518 which will be described later, an area of opening of agitation tank 510B at a central position in the direction of height of a second cylindrical portion 517 which will be described later, and an area of opening of agitation tank 510B at a central position in the direction of height of a first cylindrical portion 516 which will be described later become smaller stepwise in this order.

A side wall portion 515B of thermally insulated tank 512B includes first cylindrical portion 516, second cylindrical portion 517, third cylindrical portion 518, a connection portion 571, and a connection portion 574. First cylindrical portion 516 is in a cylindrical shape and provided to connect to bottom portion 514. Second cylindrical portion 517 is in a cylindrical shape and connected to first cylindrical portion 516 with connection portion 571 being interposed. Second cylindrical portion 517 is greater in inner diameter than first cylindrical portion 516. Third cylindrical portion 518 is in a cylindrical shape and connected to second cylindrical portion 517 with connection portion 574 being interposed. Third cylindrical portion 518 is greater in inner diameter than second cylindrical portion 517.

Connection portion 571 includes a curved portion 572 and a flat portion 573. Curved portion 572 is connected to an upper end of first cylindrical portion 516 and curved to be away from central axis C2 in the upward direction. Flat portion 573 is in a shape of an annular flat plate in parallel to the horizontal direction. Second cylindrical portion 517 is provided to connect to an outer circumference of flat portion 573.

Connection portion 574 includes a curved portion 575 and a flat portion 576. Curved portion 575 is connected to an upper end of second cylindrical portion 517 and curved to be away from central axis C2 in the upward direction. Flat portion 576 is in a shape of an annular flat plate in parallel to the horizontal direction. Third cylindrical portion 518 is provided to connect to an outer circumference of flat portion 576.

A length h1 from an inner surface of bottom portion 514 to an inner surface of flat portion 573 along the direction of central axis C2, a length h2 from the inner surface of flat portion 573 to an inner surface of flat portion 576 along the direction of central axis C2, and a length h3 from the inner surface of flat portion 576 to upper end 515b of third cylindrical portion 518 along the direction of central axis C2 are substantially the same.

In such a case as well, the first liquid level position when hot water is supplied into agitation tank 510B based on the first guideline amount of supply at which the guideline amount of supply is maximal is located above the second liquid level position when hot water is introduced into agitation tank 510B based on the second guideline amount of supply at which the guideline amount of supply is minimal, and hence an area of opening at the first liquid level position is greater than an area of opening at the second liquid level position.

Specifically, as shown with virtual line S1, the first liquid level position is located in the vicinity of a boundary portion between second cylindrical portion 517 and third cylindrical portion 518. The first liquid level position being located in the vicinity of the boundary portion between second cylindrical portion 517 and third cylindrical portion 518 refers to the fact that the liquid level is located as high as a plane which passes through the inner surface of flat portion 576 in the horizontal direction or located at a position slightly lower than the plane.

As shown with virtual line S2, the second liquid level position is located at a prescribed position in first cylindrical portion 516 above upper surface 220a of blade portion 220 of agitation blade 550. Thus, the entire blade portion 220 can be immersed in the minimum guideline amount of supplied hot water and hot water and tea leaf powders can sufficiently be agitated.

The first liquid level position is located in the vicinity of the boundary between second cylindrical portion 517 and third cylindrical portion 518. Therefore, when water is introduced over the guideline located at the highest position in introduction of water into liquid storage tank 700 and hot water exceeding the maximum guideline amount of supply is supplied into agitation tank 510B, hot water is supplied into third cylindrical portion 518 over the upper end of second cylindrical portion 517. Since the area of opening of third cylindrical portion 518 is larger than the area of opening of second cylindrical portion 517, displacement in height of the liquid level can be suppressed as compared with supply of hot water only into second cylindrical portion 517.

As set forth above, in the present embodiment as well, inner circumferential surface 510a of agitation tank 510B is in such a form of a staircase that an area of opening decreases stepwise toward bottom portion 514. Therefore, a liquid can sufficiently be agitated even though an amount of a supplied liquid is small. Displacement in height of a liquid level which varies with increase in amount of a supplied liquid can be suppressed.

### Embodiment 4

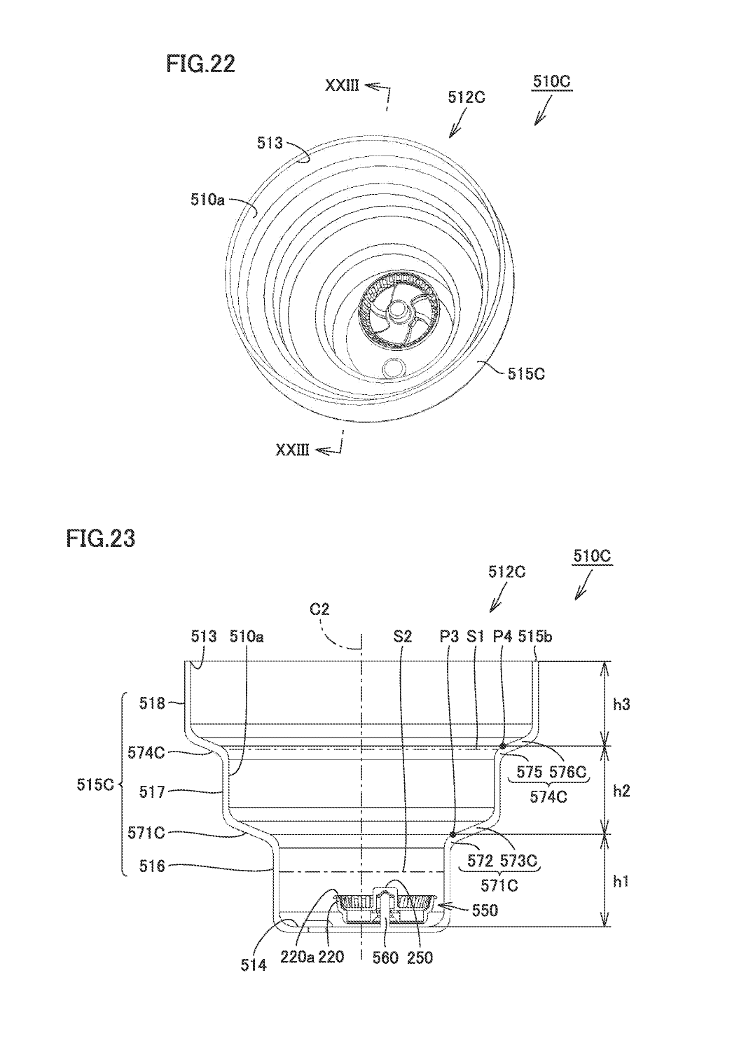

FIG. 22 is a perspective view showing an agitation tank and the agitation blade according to the present embodiment. FIG. 23 is a cross-sectional view along the line XXIII-XXIII shown in FIG. 22. FIGS. 22 and 23 do not show exterior holder 511 either for the sake of convenience in showing an agitation tank 510C and shows a thermally insulated tank 512C defining the inner circumferential surface of agitation tank 510C. Agitation tank 510C according to the present embodiment will be described with reference to FIGS. 22 and 23.

Agitation tank 510C according to the present embodiment is different from agitation tank 510B according to Embodiment 3 in a shape of inner circumferential surface 510a of agitation tank 510C originating from a difference in shape of a side wall portion 515C of thermally insulated tank 512C.

Specifically, a connection portion 571C connecting first cylindrical portion 516 and second cylindrical portion 517 to each other and a connection portion 574C connecting second cylindrical portion 517 and third cylindrical portion 518 to each other have inclined portions 573C and 576C inclined to radially spread toward the upward direction, instead of flat portions 573 and 576 according to Embodiment 3, respectively. Inclined portions 573C and 576C have inclination start points P3 and P4 at the boundary with curved portions 572 and 575, respectively.

Length h1 from the inner surface of bottom portion 514 to inclination start point P3 along the direction of central axis C2, length h2 from inclination start point P3 to inclination start point P4 along the direction of central axis C2, and length h3 from inclination start point P3 to upper end 515b of third cylindrical portion 518 along the direction of central axis C2 are substantially the same.

With such a construction as well, an area of opening of agitation tank 510C decreases stepwise toward bottom portion 514. Specifically, an area of opening of agitation tank 510C at a central position in the direction of height (the direction of the axial line of central axis C2 of agitation tank 510C) of third cylindrical portion 518, an area of opening of agitation tank 510C at a central position in the direction of height of second cylindrical portion 517, and an area of opening of agitation tank 510C at a central position in the direction of height of first cylindrical portion 516 become smaller stepwise in this order.

In this case, preferably, the first liquid level position is located in the vicinity of inclination start point P4 as shown with virtual line S1 and the second liquid level position is located at a prescribed position in first cylindrical portion 516 as shown with virtual line S2. With such a construction, agitation tank 510C according to the present embodiment obtains an effect substantially the same as the effect of agitation tank 510B according to Embodiment 3. In addition, by providing inclined portions 573C and 576C, an effect of a smoother flow of a liquid in discharging of a beverage than in the construction according to Embodiment 3 is obtained.

### Embodiment 5

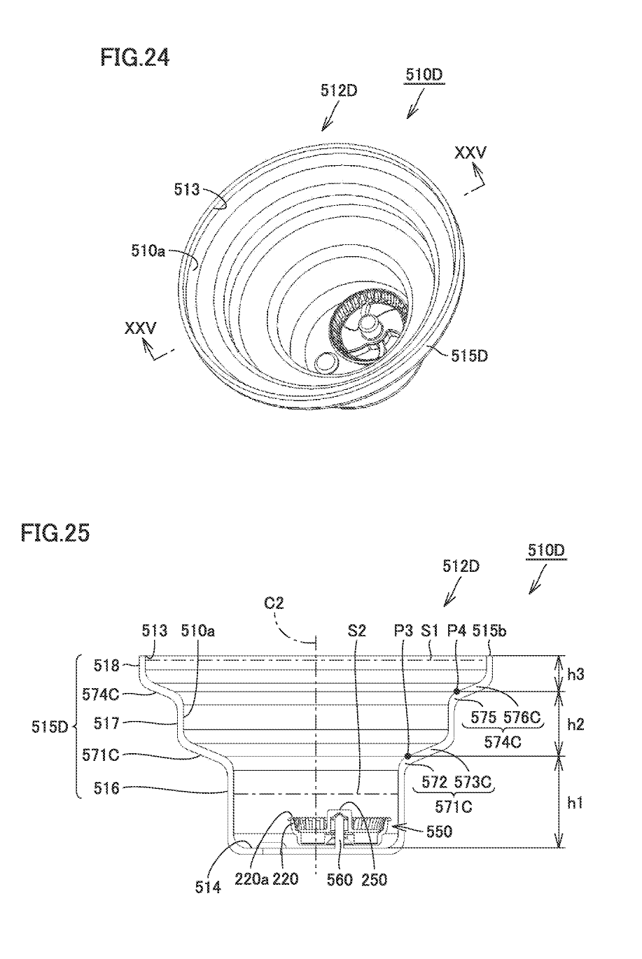

FIG. 24 is a perspective view showing an agitation tank and the agitation blade according to the present embodiment. FIG. 25 is a cross-sectional view along the line XXV-XXV shown in FIG. 24. FIGS. 24 and 25 do not show exterior holder 511 either for the sake of convenience in showing an agitation tank 510D. Agitation tank 510D according to the present embodiment will be described with reference to FIGS. 24 and 25.

Agitation tank 510D according to the present embodiment is different from agitation tank 510C according to Embodiment 4 in a shape of inner circumferential surface 510a of agitation tank 510D originating from a difference in shape of a side wall portion 515D of a thermally insulated tank 512D.

Specifically, first cylindrical portion 516, second cylindrical portion 517, and third cylindrical portion 518 are different in height from one another depending on an amount of a supplied hot water (an amount for one serving, an amount for two servings, and an amount for three servings).

Specifically, length h1 from the inner surface of bottom portion 514 to inclination start point P3 along the direction of central axis C2 is longer than length h2 from inclination start point P3 to inclination start point P4 along the direction of central axis C2 and length h3 from inclination start point P3 to upper end 515b of third cylindrical portion 518 along the direction of central axis C2. Length h2 from inclination start point P3 to inclination start point P4 along the direction of central axis C2 is longer than length h3 from inclination start point P3 to upper end 515b of third cylindrical portion 518 along the direction of central axis C2.

As shown with virtual line S2, the liquid level position (the second liquid level position) when hot water in an amount of approximately half a cup which is the minimum guideline amount of supply is supplied is located at a height position substantially half the height of first cylindrical portion 516. The liquid level position when hot water for one serving is supplied is located in the vicinity of inclination start point P3. The liquid level position when hot water for two servings is supplied is located in the vicinity of inclination start point P4. As shown with virtual line S1, the liquid level position (the first liquid level position) when hot water for three servings which is the maximum guideline amount of supply is supplied is located in the vicinity of the upper end of third cylindrical portion 518.

With such a construction, agitation tank 510D according to the present embodiment obtains an effect substantially the same as the effect of agitation tank 510C according to Embodiment 4. Since a step portion (connection portions 571C and 574C) of inner circumferential surface 510a functions as a scale in agitation tank 510D according to the present embodiment, a user can readily check an amount of supply of hot water and convenience is improved.

### Embodiment 6

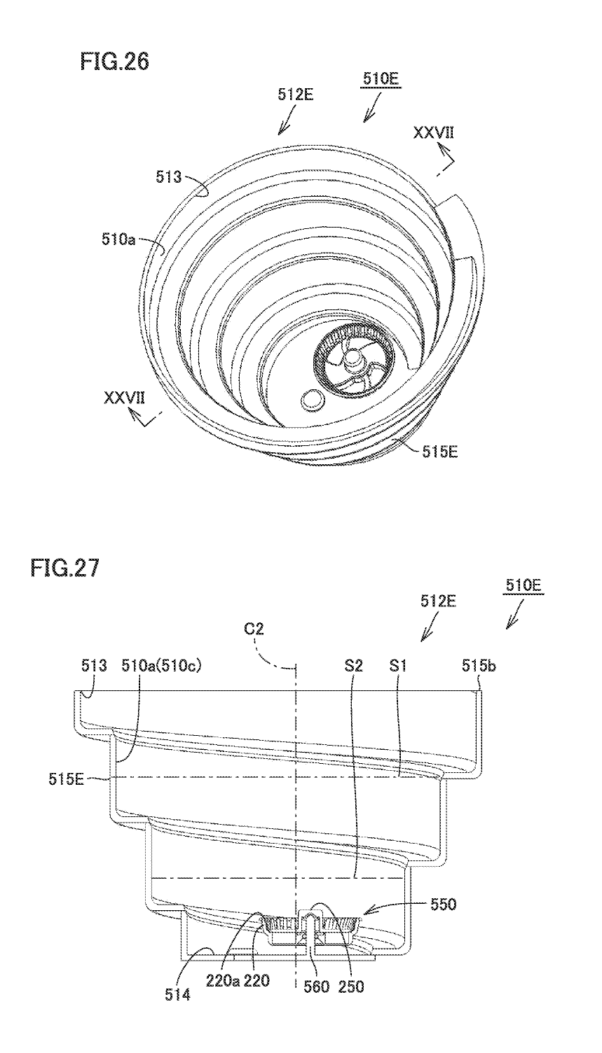

FIG. 26 is a perspective view showing an agitation tank and the agitation blade according to the present embodiment. FIG. 27 is a cross-sectional view along the line XXVII-XXVII shown in FIG. 26. FIGS. 26 and 27 do not show exterior holder 511 either for the sake of convenience in showing an agitation tank 510E but shows a thermally insulated tank 512E defining inner circumferential surface 510a of agitation tank 510E. Agitation tank 510E according to the present embodiment will be described with reference to FIGS. 26 and 27.

Agitation tank 510E according to the present embodiment is different from agitation tank 510B according to Embodiment 3 in a shape of inner circumferential surface 510a of agitation tank 510E originating from a difference in shape of a side wall portion 515E of thermally insulated tank 512E.

Specifically, inner circumferential surface 510a of agitation tank 510 has a helically extending surface 510c. Helically extending surface 510c is provided to turnaround central axis C2 while it has a constant width along the direction of central axis C2 of agitation tank 510. Helically extending surface 510c is provided such that a distance in a radial direction from central axis C2 of agitation tank 510E increases in the upward direction. The direction of turning of helically extending surface 510c is preferably the same as the direction of rotation of agitation blade 550 so that a flow of a liquid during agitation can be stronger.

With such a construction as well, an area of opening of agitation tank 510E can decrease toward bottom portion 514. Thus, an area of opening at the first liquid level position when hot water is supplied into agitation tank 510E based on the first guideline amount of supply at which the guideline amount of supply is maximal as shown with virtual line S1 is greater than an area of opening at the second liquid level position when hot water is introduced in agitation tank 510E based on the second guideline amount of supply at which the guideline amount of supply is minimal as shown with virtual line S2.

The second liquid level position is located above upper surface 220a of blade portion 220 of agitation blade 550. Thus, the entire blade portion 220 can be immersed in the minimum guideline amount of a supplied liquid and the liquid and powders can sufficiently be agitated.

As set forth above, in agitation tank 510E according to the present embodiment as well, with inner circumferential surface 510a in a form of a helically extending surface, a liquid can sufficiently be agitated even though an amount of a supplied liquid is small. Displacement in height of a liquid level which varies with increase in amount of a supplied liquid can be suppressed. With inner circumferential surface 510a in a form of the helically extending surface, an effect of a smoother flow of a liquid in discharging of a beverage than in agitation tank 510B according to Embodiment 3 is obtained.

### Embodiment 7

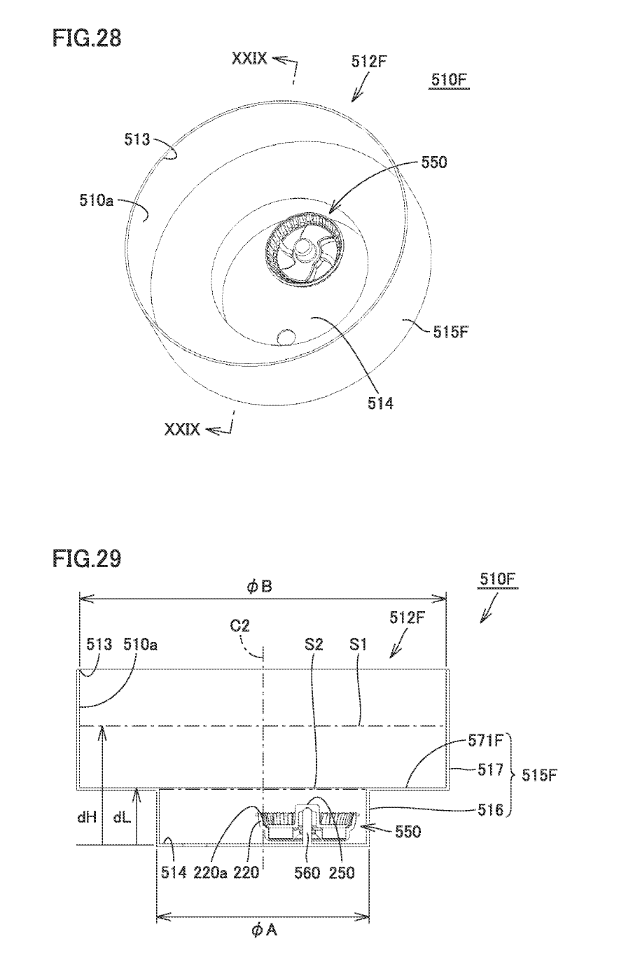

FIG. 28 is a perspective view showing an agitation tank and the agitation blade according to the present embodiment. FIG. 29 is a cross-sectional view along the line XXIX-XXIX shown in FIG. 28. FIGS. 28 and 29 do not show exterior holder 511 either for the sake of convenience in showing an agitation tank 510F. Agitation tank 510F according to the present embodiment will be described with reference to FIGS. 28 and 29.

Agitation tank 510F according to the present embodiment is different from agitation tank 510B according to Embodiment 3 in a shape of inner circumferential surface 510a of agitation tank 510F originating from a difference in shape of a side wall portion 515F of a thermally insulated tank 512F. More specifically, the number of steps provided in inner circumferential surface 510a is different.

Side wall portion 515F of thermally insulated tank 512F includes first cylindrical portion 516, second cylindrical portion 517, and a connection portion 571F. First cylindrical portion 516 is in a cylindrical shape and provided to connect to bottom portion 514. Second cylindrical portion 517 is in a cylindrical shape and connected to first cylindrical portion 516 with connection portion 571F being interposed. An inner diameter φ B of second cylindrical portion 517 is greater than inner diameter (inner diameter of bottom portion 514) φ A of first cylindrical portion 516. For example, inner diameter A of first cylindrical portion 516 is preferably approximately 70 mm and in this case, inner diameter φ B of the second cylindrical portion is preferably not smaller than 124 mm.

Connection portion 571F is in a shape of an annular flat plate in parallel to the horizontal direction. Connection portion 571F connects the upper end of first cylindrical portion 516 and a lower end of second cylindrical portion 517 to each other.

With such a construction as well, an area of opening of agitation tank 510F decreases stepwise toward bottom portion 514. Specifically, an area of opening of agitation tank 510F at a central position in the direction of height of second cylindrical portion 517 and an area of opening of agitation tank 510F at a central position in the direction of height of first cylindrical portion 516 become smaller stepwise in this order.

In this case, the first liquid level position is located in the center in the direction of height of second cylindrical portion 517 as shown with virtual line S1 and the second liquid level position is located in the vicinity of the boundary portion between first cylindrical portion 516 and second cylindrical portion 517 as shown with virtual line S2.

The second liquid level position is located above upper surface 220a of blade portion 220 of agitation blade 550. Thus, blade portion 220 can entirely be immersed in the minimum guideline amount of supplied hot water and hot water and tea leaf powders can sufficiently be agitated.

With a construction as above, agitation tank 510F according to the present embodiment obtains an effect substantially the same as the effect of agitation tank 510B according to Embodiment 3.

In the present embodiment, with decrease in inner diameter of bottom portion 514, even when an amount of a liquid supplied to agitation tank 510F is small, a distance from agitation blade 550 to the second liquid level position can be made larger. Furthermore, by setting an inner diameter of second cylindrical portion 517 to be greater than an inner diameter of first cylindrical portion 516, a distance from agitation blade 550 to the first liquid level position can be made smaller when an amount of a supplied liquid is large.

Thus, fine foams can be produced in each case by forming a swirl of air by taking air from the liquid level with rotation of agitation blade 550 and cutting the air with blade portion 220 of agitation blade 550. Therefore, in the present embodiment, a range of amounts of a liquid which can be agitated and frothed can also be widened.

### Embodiment 8

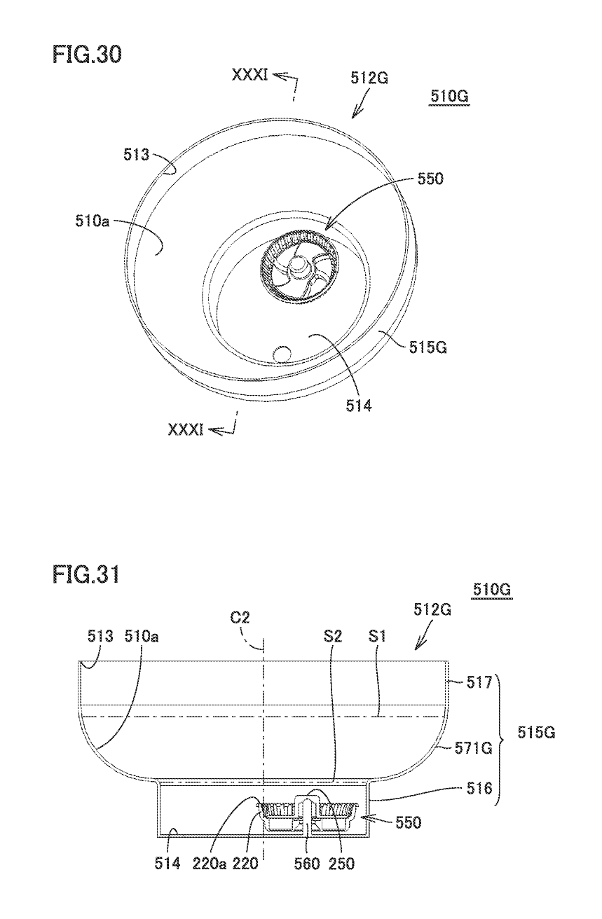

FIG. 30 is a perspective view showing an agitation tank and the agitation blade according to the present embodiment. FIG. 31 is a cross-sectional view along the line XXXI-XXXI shown in FIG. 30. FIGS. 30 and 31 do not show exterior holder 511 either for the sake of convenience in showing an agitation tank 510G. Agitation tank 510G according to the present embodiment will be described with reference to FIGS. 30 and 31.

Agitation tank 510G according to the present embodiment is different from agitation tank 510F according to Embodiment 7 in a shape of inner circumferential surface 510a of agitation tank 510G originating from a difference in shape of a side wall portion 515G of a thermally insulated tank 512G. Specifically, a shape of a connection portion 571G is different.

Connection portion 571G is in such a bowl shape as having open opposing ends in a vertical direction. Connection portion 571G is provided to have an area of opening gradually decreasing downward. A lower end side of connection portion 571G is connected to the upper end of first cylindrical portion 516. An upper end side of connection portion 571G is connected to a lower end side of second cylindrical portion 517.

In such a case as well, an area of opening at the first liquid level position when hot water is supplied into agitation tank 510G based on the first guideline amount of supply at which the guideline amount of supply is maximal as shown with virtual line S1 is greater than an area of opening at the second liquid level position when hot water is introduced into agitation tank 510G based on the second guideline amount of supply at which the guideline amount of supply is minimal as shown with virtual line S2.

The second liquid level position is located above upper surface 220a of blade portion 220 of agitation blade 550. Thus, blade portion 220 can entirely be immersed in the minimum guideline amount of supplied hot water and hot water and tea leaf powders can sufficiently be agitated.

Furthermore, with decrease in inner diameter of bottom portion 514, even when an amount of a liquid supplied to agitation tank 510G is small, a distance from agitation blade 550 to the second liquid level position can be large. With a most part of connection portion 571G being greater than the inner diameter of first cylindrical portion 516, a distance from agitation blade 550 to the first liquid level position can be made smaller when an amount of a supplied liquid is large. Thus, a range of amounts of a liquid which can be agitated and frothed can also be widened.

As set forth above, agitation tank 510G according to the present embodiment obtains an effect substantially the same as the effect of agitation tank 510F according to Embodiment 7. In addition, with connection portion 571G in a bowl shape, agitation tank 510G according to the present embodiment can suppress resistance of water produced by a step portion and obtains an effect of a smooth flow of a liquid in discharging of a beverage.

### Embodiment 9

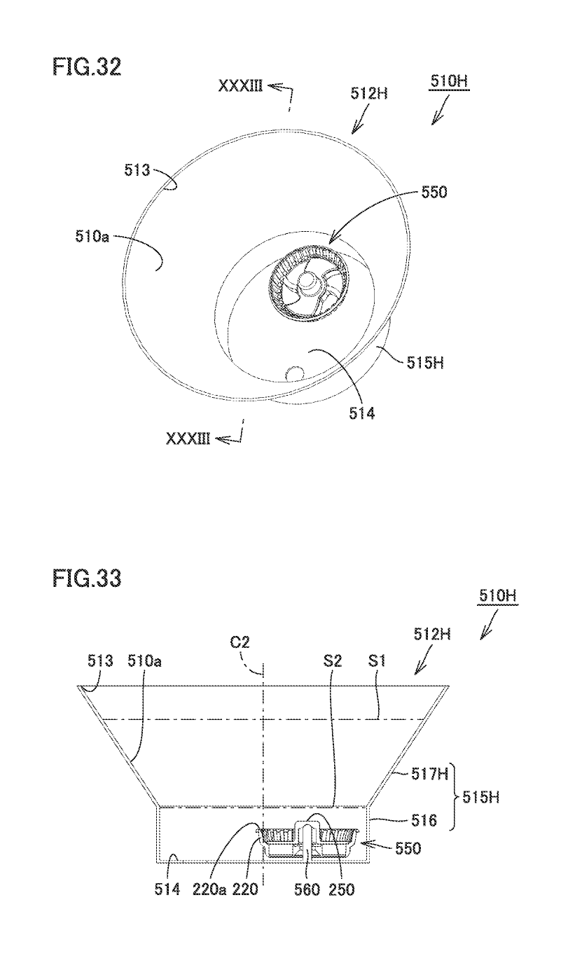

FIG. 32 is a perspective view showing an agitation tank and the agitation blade according to the present embodiment. FIG. 33 is a cross-sectional view along the line XXXIII-XXXIII shown in FIG. 32. FIGS. 32 and 33 do not show exterior holder 511 either for the sake of convenience in showing an agitation tank 510H. Agitation tank 510H according to the present embodiment will be described with reference to FIGS. 32 and 33.

Agitation tank 510H according to the present embodiment is different from agitation tank 510G according to Embodiment 8 in a shape of inner circumferential surface 510a of agitation tank 510H originating from a difference in a shape of a side wall portion 515H of a thermally insulated tank 512H.

Side wall portion 515H of thermally insulated tank 512H includes first cylindrical portion 516 and a second cylindrical portion 517H. First cylindrical portion 516 is in a cylindrical shape of which length around the circumference is constant along the vertical direction. Second cylindrical portion 517H is in a cylindrical shape of which length around the circumference gradually decreases downward. Thus, second cylindrical portion 517H has an area of opening gradually decreasing downward. A lower end of second cylindrical portion 517H is connected to the upper end of first cylindrical portion 516.

In such a case as well, an area of opening at the first liquid level position when hot water is supplied into agitation tank 510H based on the first guideline amount of supply at which the guideline amount of supply is maximal as shown with virtual line S1 is greater than an area of opening at the second liquid level position when hot water is introduced into agitation tank 510H based on the second guideline amount of supply at which the guideline amount of supply is minimal as shown with virtual line S2.

The second liquid level position is located above upper surface 220a of blade portion 220 of agitation blade 550. Thus, blade portion 220 can entirely be immersed in the minimum guideline amount of supplied hot water and hot water and tea leaf powders can sufficiently be agitated.

With a most part of second cylindrical portion 517H being greater than the inner diameter of first cylindrical portion 516, a range of amounts of a liquid which can be agitated and frothed can also be widened as described above.

In addition, with second cylindrical portion 517H in a shape as above, resistance of water produced by a step portion can be suppressed and an effect of a smooth flow of a liquid in discharging of a beverage is also obtained.

As set forth above, agitation tank 510H according to the present embodiment obtains an effect substantially the same as the effect of agitation tank 510G according to Embodiment 8.

(Comparative Form)

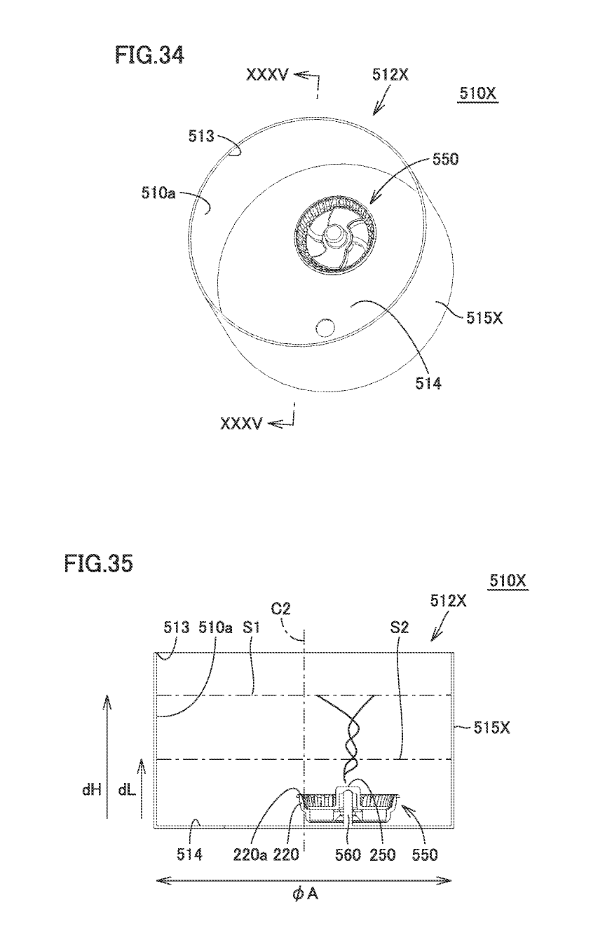

FIG. 34 is a perspective view showing an agitation tank and the agitation blade in a comparative form. FIG. 35 is a cross-sectional view along the line XXXV-XXXV shown in FIG. 34. FIGS. 34 and 35 do not show exterior holder 511 either for the sake of convenience in showing an agitation tank 510X. Agitation tank 510X according to the comparative form will be described with reference to FIGS. 34 and 35.

Agitation tank 510X according to the comparative form is different from agitation tank 510F according to Embodiment 7 in a shape of inner circumferential surface 510a of agitation tank 510X originating from a difference in shape of a side wall portion 515X of a thermally insulated tank 512X.

Side wall portion 515X of thermally insulated tank 512X is in a cylindrical shape of which length around the circumference is constant along the vertical direction. Therefore, side wall portion 515X has an area of opening constant along the vertical direction. An inner diameter (an inner diameter of bottom portion 514) φ A of side wall portion 515X is greater than an inner diameter of bottom portion 514 of each of agitation tanks 510 to 510H according to Embodiments 1 to 9.

Agitation blade 550 produces fine foams by forming a swirl by rotation and cutting air taken from the swirl with blade portion 220. When hot water is supplied into agitation tank 510X and when a depth of water (a depth of a liquid) is too small, a swirl cannot be formed and air cannot be taken into hot water during agitation. Therefore, in order to produce fine foams, the liquid level should be located moderately above agitation blade 550.

As described above, in agitation tank 510X according to the comparative form, an inner diameter of bottom portion 514 is greater than in Embodiments 1 to 9. Therefore, the minimum guideline amount of supply necessary for the liquid level to be located above the agitation blade is greater than the minimum guideline amount of supply according to Embodiments 1 to 9. Therefore, in agitation tank 510X according to the comparative form, when an amount of a supplied liquid is small, the liquid cannot sufficiently be agitated.

### Examples

### Verification Experiment

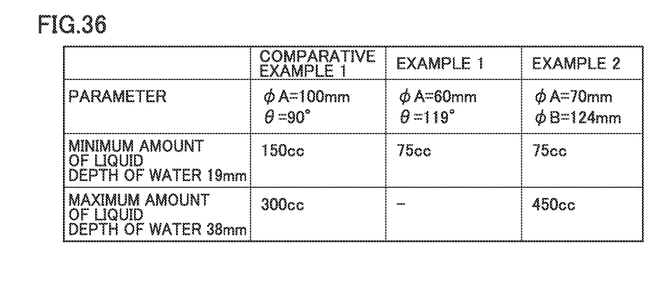

FIG. 36 is a diagram showing conditions and results of a verification experiment conducted for confirming an effect of the present invention. A verification experiment conducted for confirming the effect of the present invention will be described with reference to FIG. 36.

In the verification experiment, an agitation unit including agitation tank 510X according to the comparative form was employed as Comparative Example 1, agitation unit 500 including agitation tank 510 according to Embodiment 1 was employed as Example 1, and agitation tank 510F according to Embodiment 7 was employed as Example 2. In Comparative Example 1, an inner diameter (an inner diameter of the bottom portion) φ A of side wall portion 515X was set to 100 mm and side wall portion 515X was erected at angle of 90° with respect to the bottom portion. In Example 1, an inner diameter φ A of the bottom portion was set to 60 mm and an angle formed between side wall portion 515 and bottom portion 514 was set to 119°. In Example 2, an inner diameter (an inner diameter of the bottom portion) φ A of first cylindrical portion 516 was set to 70 mm and an inner diameter φ B of second cylindrical portion 517 was set to 124 mm.

An agitation blade which can produce fine foams when a depth of water was not smaller than 19 mm and not greater than 38 mm was employed as agitation blade 550.

In Examples 1 and 2 and Comparative Example 1, an amount of water supplied to each agitation tank when the depth of water was set to 19 mm and 38 mm was measured. An amount of supply necessary at the time when the depth of water was set to 19 mm was defined as the minimum guideline amount of supply. An amount of supply necessary at the time when the depth of water was set to 38 mm was defined as the maximum guideline amount of supply.

In Comparative Example 1, the minimum guideline amount of supply was 150 cc and the maximum guideline amount of supply was 300 cc. In Examples 1 and 2, the minimum guideline amount of supply was 75 cc, which was approximately half that in Comparative Example 1. In Example 2, the maximum guideline amount was 450 cc. With the shape in Example 2, the maximum supply amount could be increased by setting the inner diameter of second cylindrical portion 517 to be greater than in Comparative Example 1.

It was also experimentally proven that a liquid could sufficiently be agitated even when an amount of a supplied liquid was small, by employing the agitation unit including the agitation tank in a shape as in Examples 1 and 2.

Though an example in which beverage preparation apparatus 1 includes agitation unit 500 including agitation tank 510 according to Embodiment 1 is illustrated and described in Embodiment 1 above, limitation thereto is not intended and the beverage preparation apparatus may include an agitation unit including any of agitation tanks 510A to 510H according to Embodiments 2 to 9.

Though an example in which an agitation tank is constituted of an exterior holder and a thermally insulated tank is illustrated and described in Embodiments 1 to 9 above, limitation thereto is not intended and the agitation tank may consist of a thermally insulated tank. A container not having thermal insulation but having heat resistance may be employed instead of the thermally insulated tank.

Though an example in which tea as a beverage is prepared by agitating hot water as a liquid and tea leaf powders as powders in the agitation unit according to each of Embodiments 1 to 9 above is illustrated and described, limitation thereto is not intended. A foamed beverage such as milk foam may be prepared by agitating a liquid for a beverage such as milk alone, or a mixed beverage obtained by agitating a plurality of liquids for a beverage different in specific gravity may be prepared.

### Embodiment 10

### Beverage Preparation Apparatus 1001

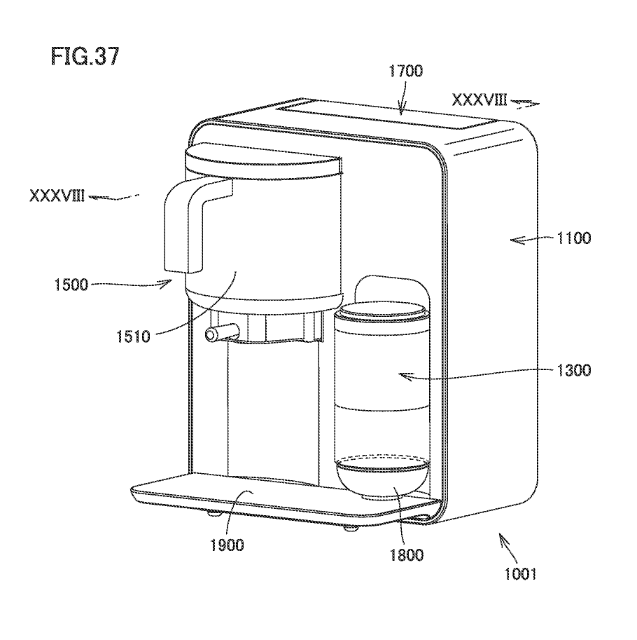

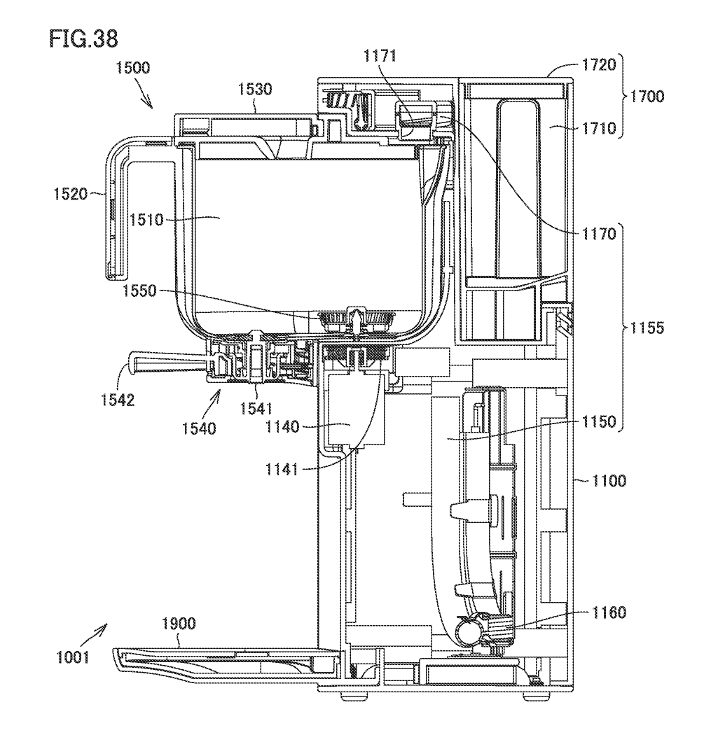

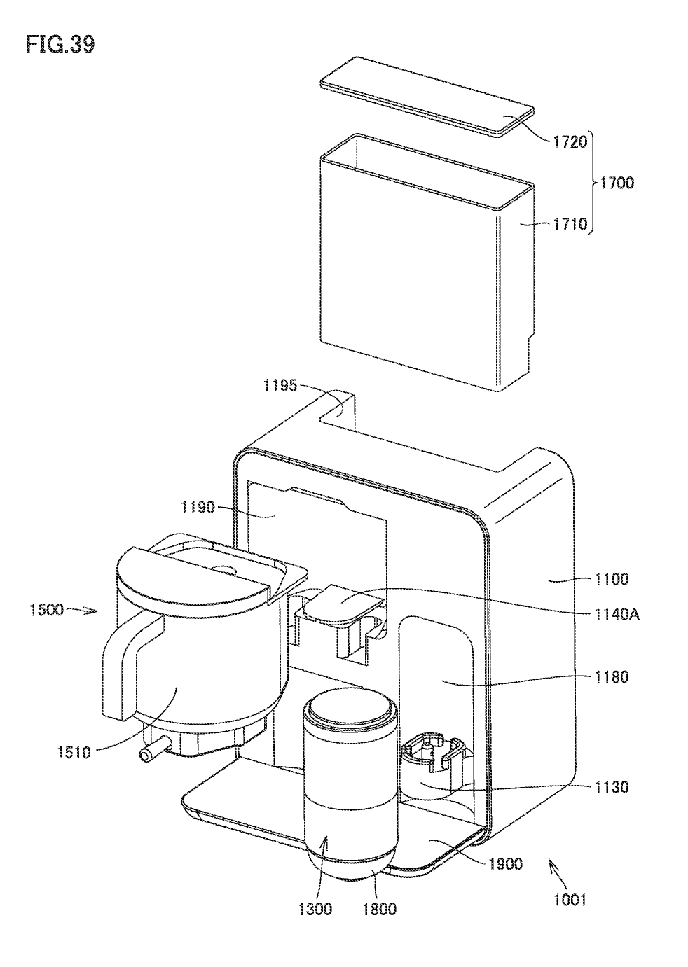

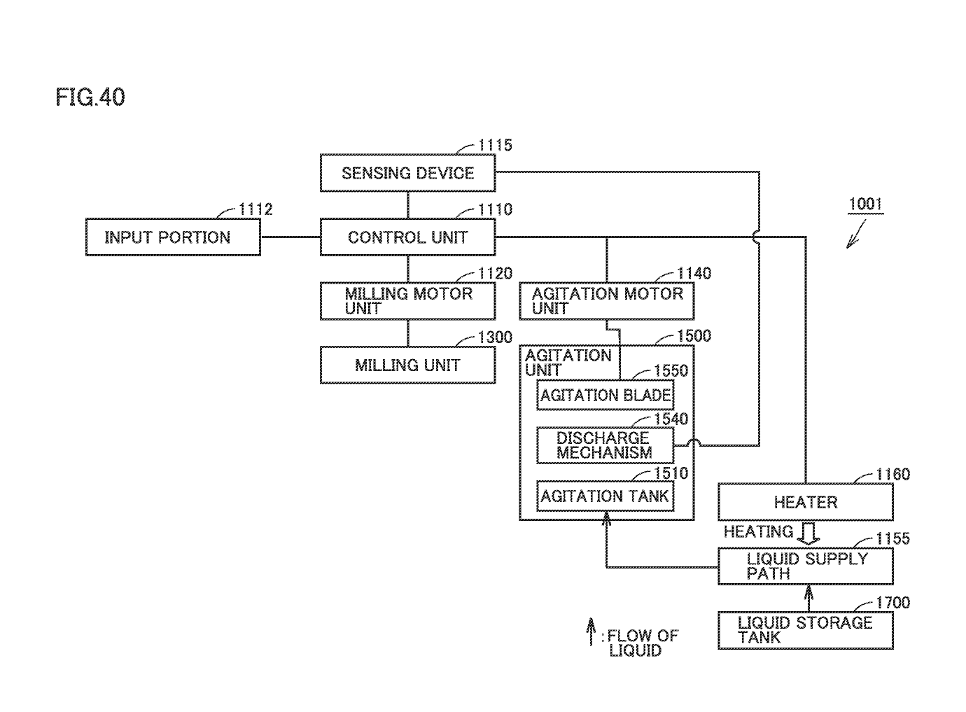

A beverage preparation apparatus 1001 in the present embodiment will be described with reference to FIGS. 37 to 40. FIG. 37 is an overall perspective view of beverage preparation apparatus 1001, FIG. 38 is a cross-sectional view along the line II-II in FIG. 37, and FIG. 39 is an overall perspective view of a schematic component of beverage preparation apparatus 1001. FIG. 40 is a block diagram showing a construction of the beverage preparation apparatus.

As shown in FIGS. 37 to 39, beverage preparation apparatus 1001 uses tea leaves as an object to be grated and obtains tea leaf powders by grating the tea leaves. The beverage preparation apparatus uses the obtained tea leaf powders for preparing tea as a beverage. Beverage preparation apparatus 1001 includes an apparatus main body 1100 as a main body portion, a milling unit 1300, an agitation unit 1500, a liquid storage tank 1700, a liquid supply path 1155 (see FIG. 38), a tea leaf powder tray 1800 as a powder reception portion, and a placement base 1900. Placement base 1900 is provided to protrude forward on a front side in a lower portion of apparatus main body 1100 and a cup (not shown) and tea leaf powder tray 1800 can be placed thereon. Tea leaf powder tray 1800 is provided such that a user can move the tray by holding the tray.

(Milling Unit 1300)

Milling unit 1300 is removably attached to a milling unit attachment portion 1180 provided on a front surface side of apparatus main body 1100. Milling unit 1300 is arranged at a distance from an agitation tank 1510 so as to be displaced from agitation tank 1510 below agitation tank 1510 included in agitation unit 1500 when viewed from the front.

Milling driving force coupling mechanism 1130 is provided in milling unit attachment portion 1180 so as to protrude forward and milling unit 1300 is removably attached to milling driving force coupling mechanism 1130. Milling unit 1300 obtains driving force for milling tea leaves representing an object to be grated by being coupled to milling driving force coupling mechanism 1130.

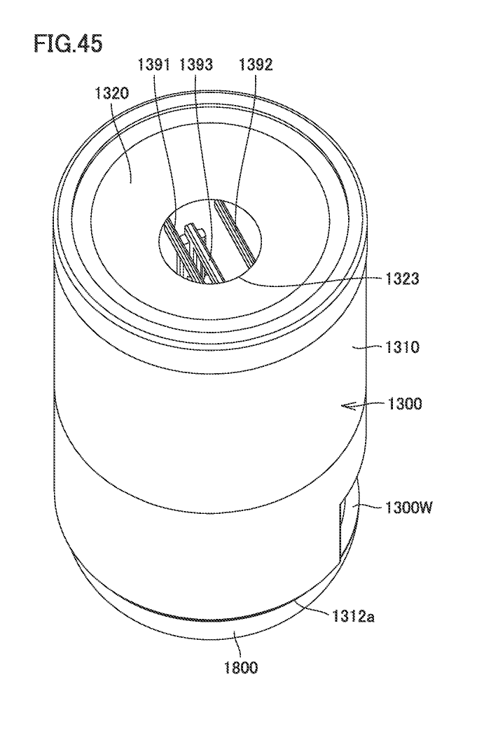

Tea leaves introduced from an upper portion of milling unit 1300 into milling unit 1300 are finely grated in milling unit 1300. The grated tea leaves are dropped and collected as tea leaf powders on tea leaf powder tray 1800 placed below milling unit 1300. A detailed structure of milling unit 1300 will be described later with reference to FIGS. 45 to 47.

(Liquid Storage Tank 1700)

Liquid storage tank 1700 is removably attached to a liquid storage tank attachment portion 1195 provided on an upper surface side of apparatus main body 1100. Liquid storage tank 1700 includes a tank main body 1710 having an opening in an upper surface and a lid portion 1720 closing the opening in the upper surface of tank main body 1710. Liquid storage tank 1700 stores such a liquid as water which is introduced from the outside by removing lid portion 1720.

(Liquid Supply Path 1155)

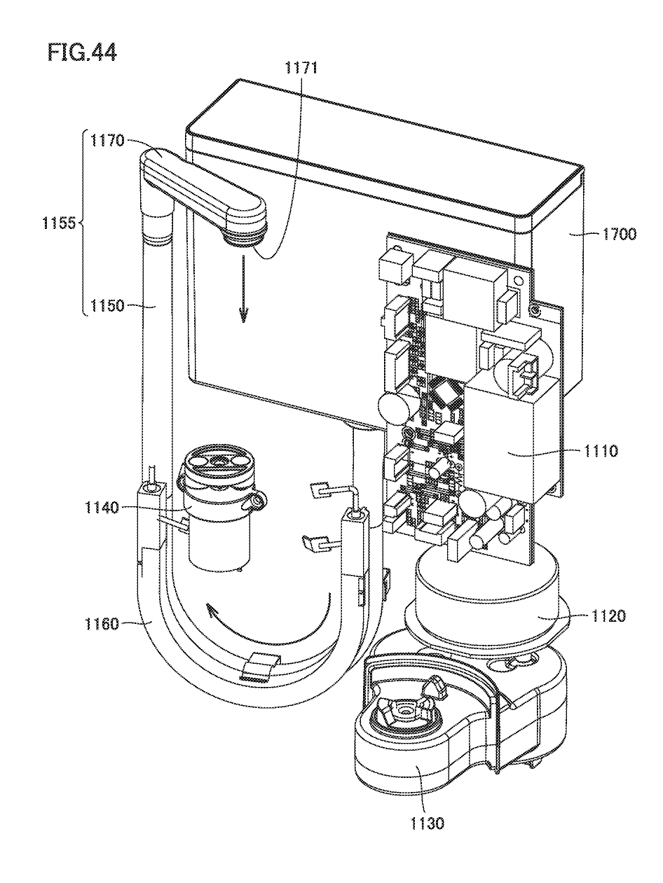

Liquid supply path 1155 is accommodated in apparatus main body 1100. Liquid supply path 1155 is connected to liquid storage tank 1700 (see FIG. 44). Liquid supply path 1155 is provided with a supply port 1171 on a side opposite to a side where liquid storage tank 1700 is connected. Liquid supply path 1155 includes a hot water supply pipe 1150 and a hot water supply nozzle 1170. Hot water supply pipe 1150 has one end side connected to liquid storage tank 1700 and the other end side connected to hot water supply nozzle 1170. A liquid introduced from liquid storage tank 1700 into liquid supply path 1155 is supplied to agitation unit 1500 through hot water supply pipe 1150 and hot water supply nozzle 1170.

(Agitation Unit 1500)

Agitation unit 1500 includes an agitation blade 1550 for agitating a liquid (including a liquid mixture in which a liquid and powders have been mixed) and agitation tank 1510 accommodating agitation blade 1550. Agitation blade 1550 corresponds to an agitation member. Agitation tank 1510 is removably attached to an agitation tank attachment portion 1190 provided on the front surface side of apparatus main body 1100. Agitation tank 1510 is attached to agitation tank attachment portion 1190 so as to protrude from apparatus main body 1100 in a direction intersecting with a vertical direction. Specifically, agitation tank 1510 is attached such that a part of agitation tank 1510 protrudes from a front surface of apparatus main body 1100 along a direction of normal to the front surface.

An agitation motor contactless table 1140A is provided in agitation tank attachment portion 1190. Agitation unit 1500 is placed on agitation motor contactless table 1140A. Agitation blade 1550 provided in agitation unit 1500 is rotated by an agitation motor unit 1140 and a permanent magnet 1141 coupled thereto. Agitation motor unit 1140 and permanent magnet 1141 are accommodated in apparatus main body 1100 so as to be located below agitation motor contactless table 1140A. Agitation motor unit 1140 corresponds to an agitation member drive portion which rotationally drives agitation blade 1550.

Hot water supply nozzle 1170 is provided above agitation tank attachment portion 1190 of apparatus main body 1100. In apparatus main body 1100, a temperature of water in hot water supply pipe 1150 is raised to a prescribed temperature and hot water is supplied from hot water supply nozzle 1170 into agitation tank 1510. Hot water prepared in apparatus main body 1100 and tea leaf powders obtained by milling unit 1300 are introduced into agitation tank 1510, and hot water and tea leaf powders are agitated by agitation blade 1550 in agitation tank 1510. Tea as a liquid mixture is thus prepared in agitation tank 1510.

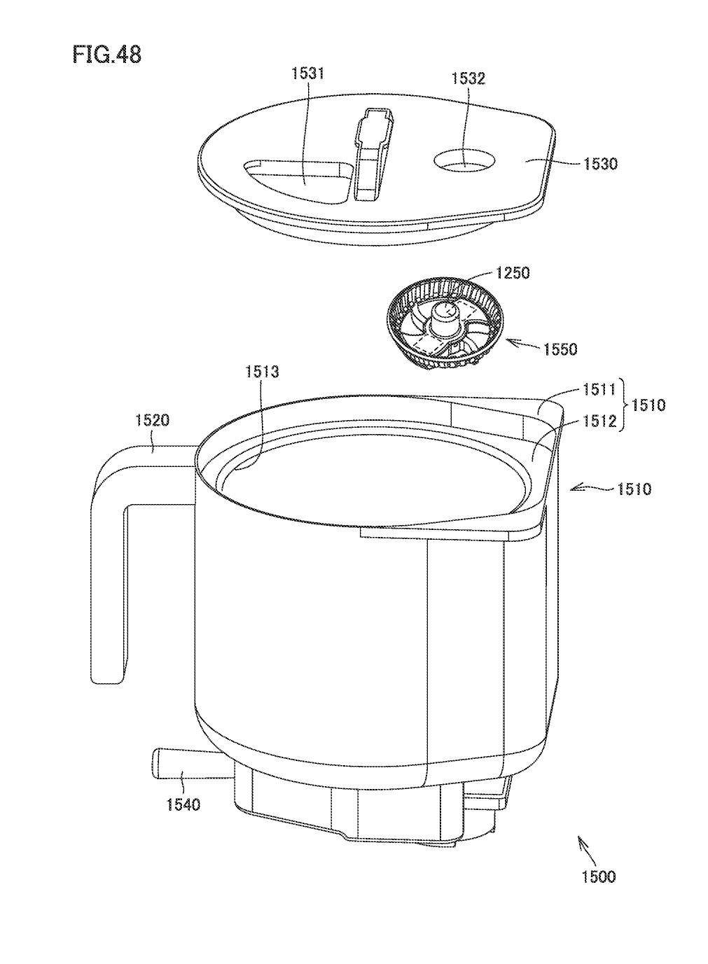

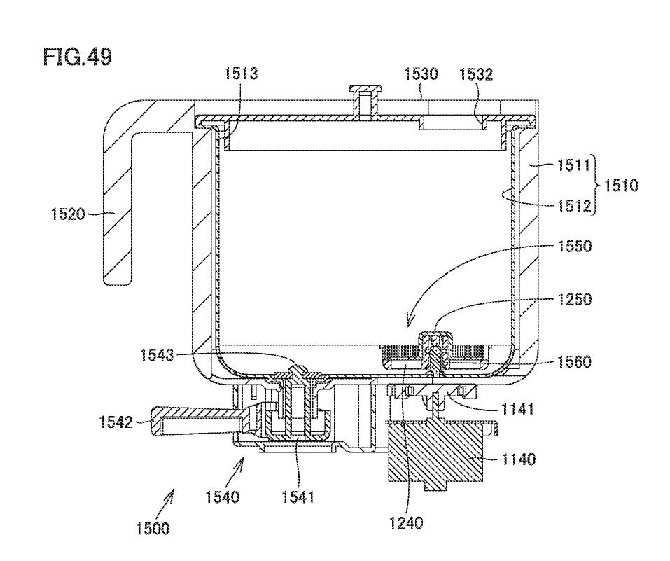

Tea prepared in agitation unit 1500 can be poured into a cup (not shown) placed on placement base 1900 by operating an operation lever 1542 of a discharge mechanism 1540 provided below agitation tank 1510. A detailed structure of agitation unit 1500 will be described later with reference to FIGS. 48 and 49.

As shown in FIG. 40, beverage preparation apparatus 1001 further includes a control unit 1110, a milling motor unit 1120, an agitation motor unit 1140, a heater 1160, an input portion 1112, and a sensing device 1115. Control unit 1110 controls an operation of milling motor unit 1120, agitation motor unit 1140, and heater 1160. Milling motor unit 1120 drives milling unit 1300 and agitation motor unit 1140 drives agitation unit 1500.

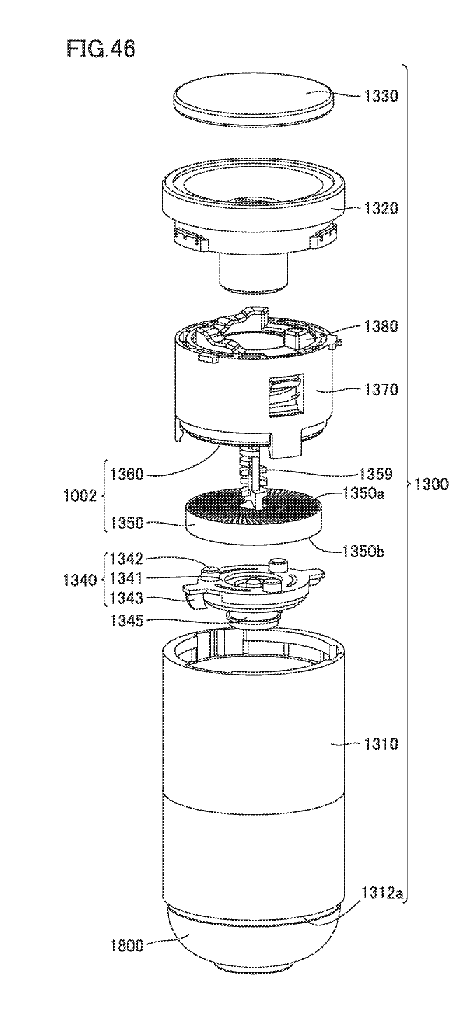

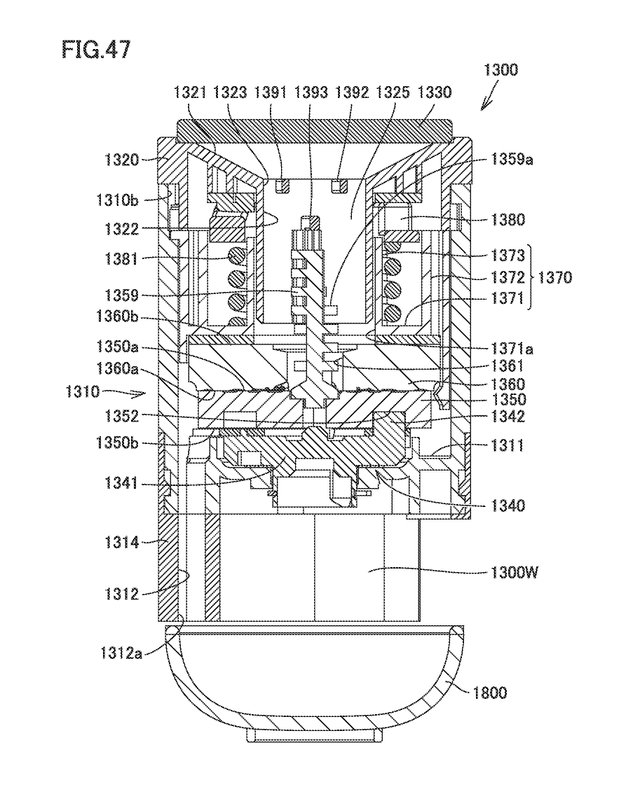

Specifically, milling motor unit 1120 rotationally drives a lower mill 1350 (see FIG. 46) of milling unit 1300 to thereby grate tea leaves between an upper mill 1360 (see FIG. 46) and lower mill 1350. Agitation motor unit 1140 rotationally drives agitation blade 1550 of agitation unit 1500 to thereby agitate hot water and tea leaf powders supplied to agitation tank 1510.

Input portion 1112 serves to instruct control unit 1110 to set a rotation mode of agitation blade 1550 and a time period for agitation and/or the number of agitations of agitation blade 1550 in a discharging step which will be described later. A push button or a liquid crystal display integrated with a touch sensor can be adopted as input portion 1112. When the push button implements input portion 1112, such conditions as a rotation mode, a time period for agitation, and/or the number of agitations can be determined by making selection as appropriate from among a plurality of buttons such as a first button and a second button for which predetermined different conditions have been set. When a liquid crystal display integrated with a touch sensor implements input portion 1112, a user may directly input such a condition.

The sensing device 1115 senses timing of an operation of operation lever 1542 provided in discharge mechanism 1540 which will be described later. The sensing device 1115 inputs a sensing signal indicative of sensing of the timing to control unit 1110. Control unit 1110 controls agitation motor unit 1140 in advance such that agitation blade 1550 is rotationally driven before the sensing device 1115 senses the timing and controls agitation motor unit 1140 such that agitation blade 1550 is rotationally driven in a signal input state that the sensing signal has been input.

A liquid such as water stored in liquid storage tank 1700 is introduced into liquid supply path 1155. Water introduced into liquid supply path 1155 is heated by heater 1160 and resultant hot water is supplied to agitation unit 1500.

(Flow of Preparation of Tea (Beverage))

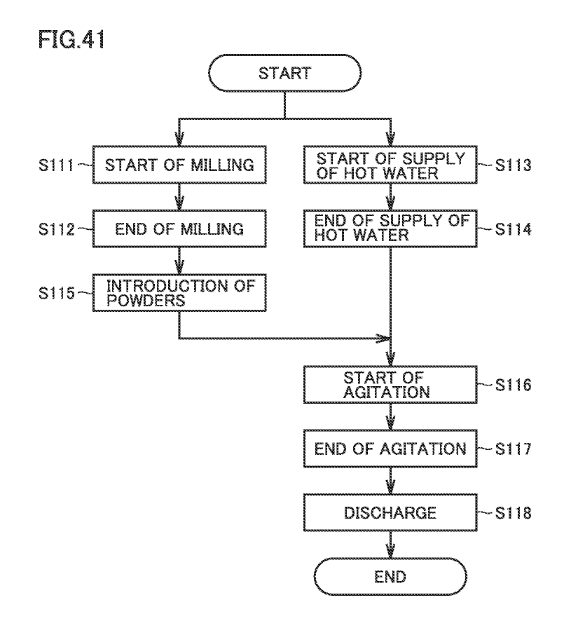

A flow of preparation of tea (beverage) with the use of beverage preparation apparatus 1001 will now be described with reference to FIGS. 41 to 43. FIGS. 41 to 43 show first to third preparation flows for preparing tea using beverage preparation apparatus 1001, respectively. A prescribed amount of tea leaves is introduced into milling unit 1300 and a prescribed amount of water is stored in liquid storage tank 1700.

(First Preparation Flow)

A first preparation flow will be described with reference to FIG. 41. This first preparation flow is a flow in which grating of tea leaves in milling unit 1300 and supply of hot water from apparatus main body 1100 to agitation unit 1500 are simultaneously carried out.

In beverage preparation apparatus 1001, milling of tea leaves by milling unit 1300 in a step 111 and supply of hot water from apparatus main body 1100 to agitation unit 1500 in a step 113 are simultaneously started. Then, milling of tea leaves by milling unit 1300 ends in a step 112, and supply of hot water from apparatus main body 1100 to agitation unit 1500 ends in a step 114.

In a step 115, tea leaf powders obtained in step 112 are introduced into agitation unit 1500 by a user.

Then, in a step 116, agitation of the tea leaf powders and hot water in agitation unit 1500 is started. In a step 117, agitation of the tea leaf powders and hot water in agitation unit 1500 ends. In a step 118, tea is discharged into the cup placed on placement base 1900 as the user operates operation lever 1542 of discharge mechanism 1540 provided below agitation unit 1500.

(Second Preparation Flow)

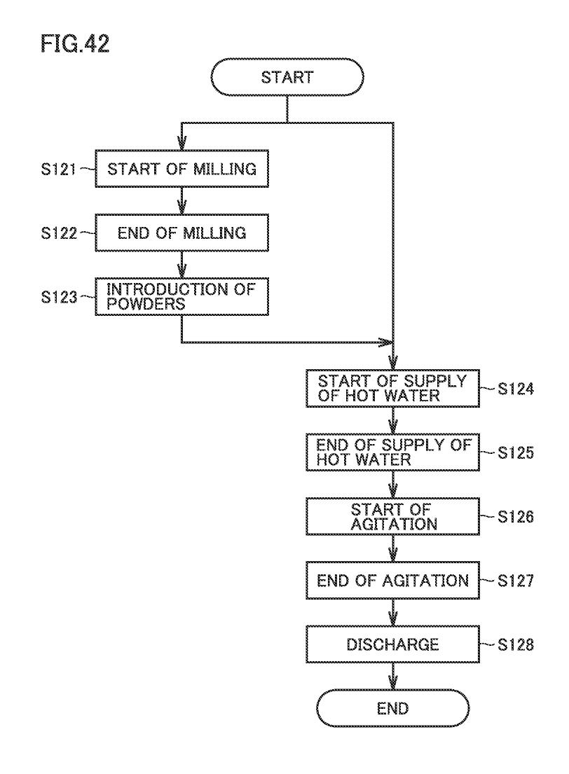

A second preparation flow will be described with reference to FIG. 42. This second preparation flow is a flow in which hot water is supplied from apparatus main body 1100 to agitation unit 1500 after tea leaves are grated in milling unit 1300.

In beverage preparation apparatus 1001, in a step 121, milling of tea leaves by milling unit 1300 is started. In a step 122, milling of tea leaves by milling unit 1300 ends. In a step 123, tea leaf powders obtained in step 122 are introduced into agitation unit 1500 by a user.

In a step 124, supply of hot water from apparatus main body 1100 to agitation unit 1500 is started. In a step 125, supply of hot water from apparatus main body 1100 to agitation unit 1500 ends.

Then, in a step 126, agitation of the tea leaf powders and hot water in agitation unit 1500 is started. In a step 127, agitation of the tea leaf powders and hot water in agitation unit 1500 ends. In a step 128, tea is discharged into the cup placed on placement base 1900 as the user operates operation lever 1542 of discharge mechanism 1540 provided below agitation unit 1500.

(Third Preparation Flow)

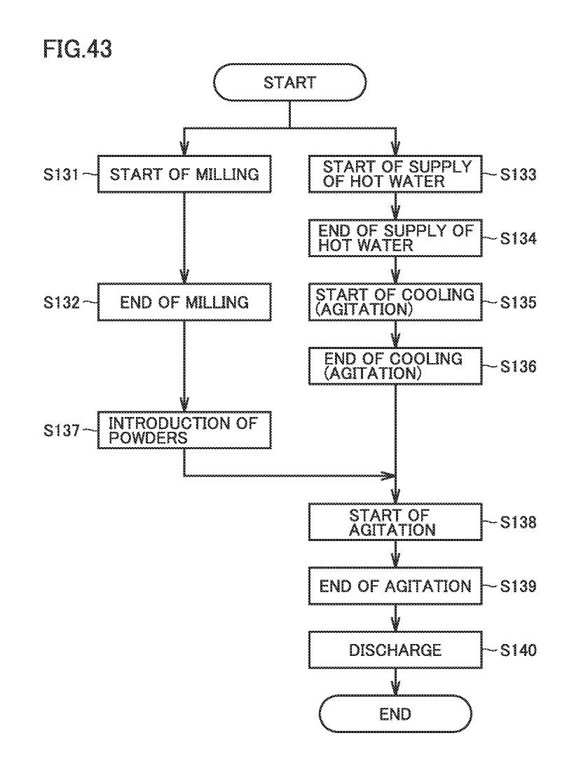

A third preparation flow will be described with reference to FIG. 43. This third preparation flow includes a step of cooling hot water by agitation in agitation unit 1500.

In beverage preparation apparatus 1001, milling of tea leaves by milling unit 1300 in a step 131 and supply of hot water from apparatus main body 1100 to agitation unit 1500 in a step 133 are simultaneously started. In a step 134, supply of hot water from apparatus main body 1100 to agitation unit 1500 ends.

Then, in a step 132, milling of tea leaves by milling unit 1300 ends, and in a step 135, cooling by agitation of hot water supply is started in agitation unit 1500. In a step 136, cooling by agitation of hot water supply in agitation unit 1500 ends.

In a step 137, the tea leaf powders obtained in step 132 are introduced into agitation unit 1500 by a user.

Then, in a step 138, agitation of the tea leaf powders and hot water in agitation unit 1500 is started. In a step 139, agitation of the tea leaf powders and hot water in agitation unit 1500 ends. In a step 140, tea is discharged into the cup placed on placement base 1900 as the user operates operation lever 1542 of discharge mechanism 1540 provided below agitation unit 1500.

(Internal Structure of Apparatus Main Body 1100)

An internal structure of apparatus main body 1100 will now be described with reference to FIG. 44. FIG. 44 is a perspective view showing the internal structure of beverage preparation apparatus 1001. In apparatus main body 1100 of beverage preparation apparatus 1001, control unit 1110 including a printed circuit board on which electronic components are mounted is arranged on a front surface side of liquid storage tank 1700. Based on input of a start signal by a user, the flow for preparation of tea is executed by control unit 1110.

A milling motor unit 1120 for providing driving force to milling unit 1300 is arranged at a position below control unit 1110. Milling driving force coupling mechanism 1130 provided to protrude forward for transmitting driving force of milling motor unit 1120 to milling unit 1300 is provided at a position below milling motor unit 1120.

To a bottom surface of liquid storage tank 1700, one end of hot water supply pipe 1150 extending once downward from the bottom surface and then extending upward in a U shape is coupled. Hot water supply nozzle 1170 for pouring hot water into agitation tank 1510 of agitation unit 1500 is coupled to an upper end portion of hot water supply pipe 1150. A U-shaped heater 1160 for heating water which passes through hot water supply pipe 1150 is attached to an intermediate region of hot water supply pipe 1150.

(Structure of Milling Unit 1300)

A structure of milling unit 1300 will now be described with reference to FIGS. 45 to 47. FIG. 45 is a perspective view of milling unit 1300, FIG. 46 is an exploded perspective view of milling unit 1300, and FIG. 47 is a vertical cross-sectional view of milling unit 1300.

Milling unit 1300 has a milling case 1310 having a cylindrical shape as a whole, and a window for coupling 1300W in which milling driving force coupling mechanism 1130 is inserted is provided in a side surface below. A storage portion 1311 (see FIG. 47) for storing tea leaf powders produced by upper mill 1360 and lower mill 1350 and a discharge path 1312 communicating with storage portion 1311 are provided. An outlet port 1312a for discharging tea leaf powders into tea leaf powder tray 1800 is provided at a lower end portion of discharge path 1312 which is a lowermost end portion of milling case 1310. Outlet port 1312a is provided below an opening portion 1513 of a thermally insulated tank 1512 (see FIG. 48) which will be described later. Entry through outlet port 1312a, of steam resulting from hot water supplied into thermally insulated tank 1512 can thus be prevented.

Milling unit 1300 includes upper mill 1360 and lower mill 1350 which grate an object to be grated and a lower mill support portion 1340 to which lower mill 1350 is attached. In milling case 1310, lower mill support portion 1340, lower mill 1350, and upper mill 1360 are successively provided from below.

Lower mill support portion 1340 supports lower mill 1350 from a side opposite to a side where upper mill 1360 is located (a side below lower mill 1350). Lower mill support portion 1340 has a substantially columnar main body portion 1341, an engagement protrusion portion 1342, and a powder scraping portion 1343. A milling shaft 1345 is provided on a lower surface of main body portion 1341 and extends downward. Milling shaft 1345 is coupled to milling driving force coupling mechanism 2130. Lower mill support portion 1340 is thus rotatable while it supports lower mill 1350.

Engagement protrusion portion 1342 is provided on an upper surface of main body portion 1341 and protrudes upward. Engagement protrusion portion 1342 is a site for locking lower mill 1350. Powder scraping portion 1343 is provided around a circumferential portion of main body portion 1341. Powder scraping portion 1343 scrapes off tea leaf powders stored in storage portion 1311 and transports the tea leaf powders to discharge path 1312 as lower mill support portion 1340 rotates.

Lower mill 1350 includes a main surface 1350a arranged to be opposed to a main surface 1360a of upper mill 1360, a main surface 1350b located opposite to main surface 1350a, and a circumferential surface connecting main surface 1350a and main surface 1350b to each other. Main surface 1350a of lower mill 1350 has a plurality of shear grooves formed. The plurality of shear grooves are provided, for example, to extend along an equiangular spiral. The plurality of shear grooves may be constructed such that linear grooves formed from the inner circumferential side toward the outer circumference are radially provided.

An engagement recess portion 1352 is provided in main surface 1350b of lower mill 1350. Engagement recess portion 1352 is provided at a position corresponding to engagement protrusion portion 1342 of lower mill support portion 1340 and locked by engagement protrusion portion 1342. Lower mill 1350 rotates together with lower mill support portion 1340. A core 1359 extending upward along a core of a rotation shaft is provided in a central portion of lower mill 1350.

Core 1359 is provided to pass through a through hole 1361 provided in a central portion of upper mill 1360. Core 1359 has a helically provided blade portion 1359a.

Upper mill 1360 includes main surface 1360a arranged to be opposed to main surface 1350a of lower mill 1350, a main surface 1360b located opposite to main surface 1360a, and a circumferential surface connecting main surface 1360a and main surface 1360b to each other. A shear groove is formed in main surface 1360a of upper mill 1360 as in main surface 1350a of the lower mill.

Upper mill 1360 is held by an upper mill holding member 1370 arranged above the upper mill. A not-shown hole portion is provided in an upper surface of upper mill 1360. As a not-shown pin portion provided in upper mill holding member 1370 enters the hole portion, rotation of upper mill 1360 is prevented.

Upper mill holding member 1370 includes a bottom surface portion 1371 provided with a hole portion 1371a, an outer cylindrical portion 1372 erected upward from a circumference of bottom surface portion 1371, and an inner cylindrical portion 1373 erected upward from a circumference of hole portion 1371a. Hole portion 1371a is provided to communicate with through hole 1361 in upper mill 1360. A spring 1381 pressing upper mill 1360 downward and a spring holding member 1380 are accommodated in between outer cylindrical portion 1372 and inner cylindrical portion 1373. Spring 1381 adjusts a grating pressure applied between upper mill 1360 and lower mill 1350.

A hopper portion 1320 for supplying an object to be grated in between upper mill 1360 and lower mill 1350 is attached to a side of an upper end opening portion 1310b of milling case 1310. Hopper portion 1320 has a top plate portion 1321, a cylindrical portion 1322, and an object-to-be-grated inlet 1325. Top plate portion 1321 has such a bowl shape that an opening portion 1323 is provided substantially in a central portion. Cylindrical portion 1322 is provided to extend downward from a circumference of opening portion 1323. Cylindrical portion 1322 is inserted in inner cylindrical portion 1373.

Object-to-be-grated inlet 1325 is defined by opening portion 1323 and cylindrical portion 1322. A tip end side of core 1359 is accommodated in object-to-be-grated inlet 1325. In cylindrical portion 322, a plurality of linear ribs 1391, 1392, and 1393 are provided across object-to-be-grated inlet 1325.

In grating tea leaves, hopper portion 1320 is preferably covered with a cover portion 1330. Thus, after tea leaves are introduced into object-to-be-grated inlet 1325, entry of a foreign matter into milling unit 1300 and scattering of grated tea leaves can be prevented. When tea leaves are to be introduced, cover portion 1330 is removed from hopper portion 1320.

Tea leaves introduced into object-to-be-grated inlet 1325 are accommodated in a space defined by the upper surface of upper mill 1360 exposed through upper mill holding member 1370 and an inner circumferential surface of cylindrical portion 1322. Tea leaves accommodated in the space are guided in between upper mill 1360 and lower mill 1350 as helical blade portion 1359a rotates with rotation of lower mill 350.

Tea leaves guided in between upper mill 1360 and lower mill 1350 are grated and fall downward in a form of tea leaf powders from a circumference of upper mill 1360 and lower mill 1350. Some of fallen tea leaf powders is discharged through discharge path 1312 into tea leaf powder tray 1800 from outlet port 1312a. Other fallen tea leaf powders are stored in storage portion 1311. Tea leaf powders in storage portion 1311 are transported to discharge path 1312 and discharged from outlet port 1312a into tea leaf powder tray 1800 as powder scraping portion 1343 rotates with rotation of lower mill support portion 1340.

(Structure of Agitation Unit 1500)

A structure of agitation unit 1500 will now be described with reference to FIGS. 48 and 49. FIG. 48 is a perspective view of agitation unit 1500 and FIG. 49 is a vertical cross-sectional view of agitation unit 1500.

Agitation unit 1500 includes agitation tank 1510, agitation blade 1550, and an agitation cover 1530. Agitation tank 1510 includes an exterior holder 1511 made of a resin and thermally insulated tank 1512 held by exterior holder 1511. Thermally insulated tank 1512 corresponds to a container main body of agitation tank 1510. An integrally resin molded grip 1520 is provided in exterior holder 1511. Thermally insulated tank 1512 has an opening portion 1513 which has a cylindrical shape with bottom and opens upward.

Agitation cover 1530 is attached to opening portion 1513 so as to be able to open and close opening portion 1513. Agitation cover 1530 is provided with a powder inlet 1531 for introducing tea leaf powders grated by milling unit 1300 and a hot water supply inlet 1532 through which hot water formed in apparatus main body 1100 is poured from hot water supply nozzle 1170. Hot water supply inlet 1532 is provided at a position corresponding to supply port 1171 of hot water supply nozzle 1170.

Powder inlet 1531 and hot water supply inlet 1532 communicate with opening portion 1513. Tea leaf powders introduced from moved tea leaf powder tray 1800 to powder inlet 1531 are introduced into thermally insulated tank 1512 through opening portion 1513. Hot water poured through hot water supply inlet 1532 from hot water supply nozzle 1170 is supplied into thermally insulated tank 1512 through opening portion 1513.

Agitation blade 1550 is placed on a bottom portion of agitation tank 1510. A rotation shaft 1560 extending upward is provided on the bottom portion of agitation tank 1510, and a cylindrical core 1250 for agitation blade 1550 is inserted in this rotation shaft 1560.

A permanent magnet 1240 is embedded in agitation blade 1550. In agitation motor contactless table 1140A, permanent magnet 1240 embedded in agitation blade 1550 and permanent magnet 1141 provided on a side of agitation motor unit 1140 are magnetically coupled in a contactless state, so that rotational driving force of agitation motor unit 1140 is transmitted to agitation blade 1550.

Though an example in which agitation blade 1550 constructed as above is employed as the agitation member is illustrated and described, limitation thereto is not intended and an agitation member having an agitation element in the outer circumferential portion can be adopted as the agitation member as appropriate. A wound portion formed from a wire in a toroidal shape or an impeller can be adopted as the agitation element.

Agitation tank 1510 is provided with discharge mechanism 1540. Discharge mechanism 1540 is a mechanism for discharging tea (a liquid mixture) prepared by agitation of hot water (a liquid) and tea leaf powders (powders) by agitation blade 1550 from agitation tank 1510 to the outside.

Discharge mechanism 1540 includes a discharge port 1541 communicating with a container of agitation tank 1510, an opening and closing nozzle 1543 inserted into discharge port 1541 so as to be able to open and close discharge port 1541, and operation lever 1542 controlling a position of opening and closing nozzle 1543. Operation lever 1542 corresponds to an operation portion for operating discharge mechanism 1540.

Opening and closing nozzle 1543 is biased to close discharge port 1541 by a biasing member (not shown) such as a spring in a normal state. When a user moves operation lever 1542 against biasing force, opening and closing nozzle 1543 moves to open discharge port 1541 and thus tea in agitation tank 1510 is discharged into a cup (not shown) placed on placement base 1900.

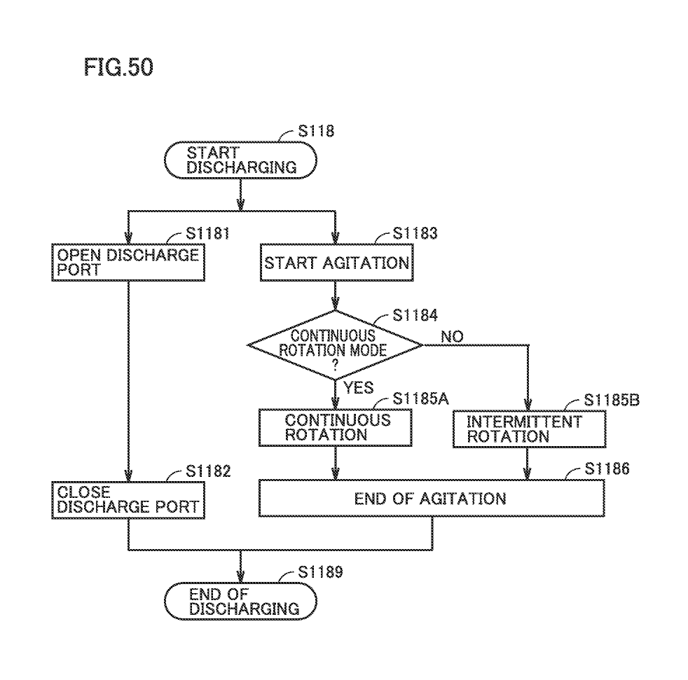

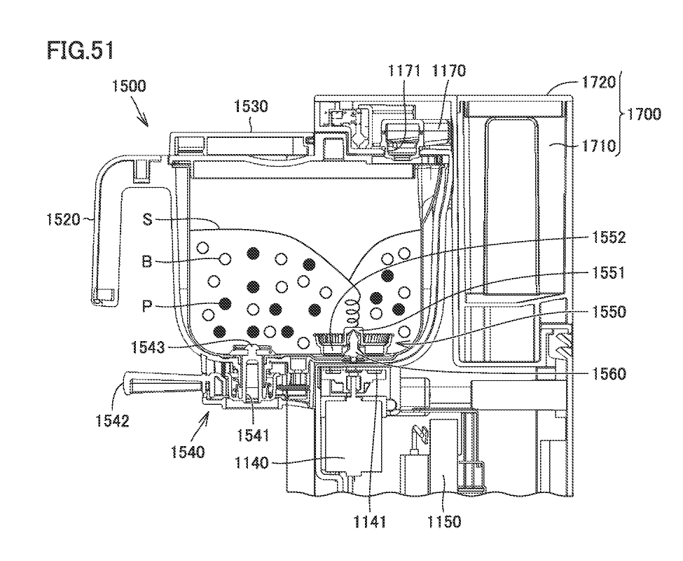

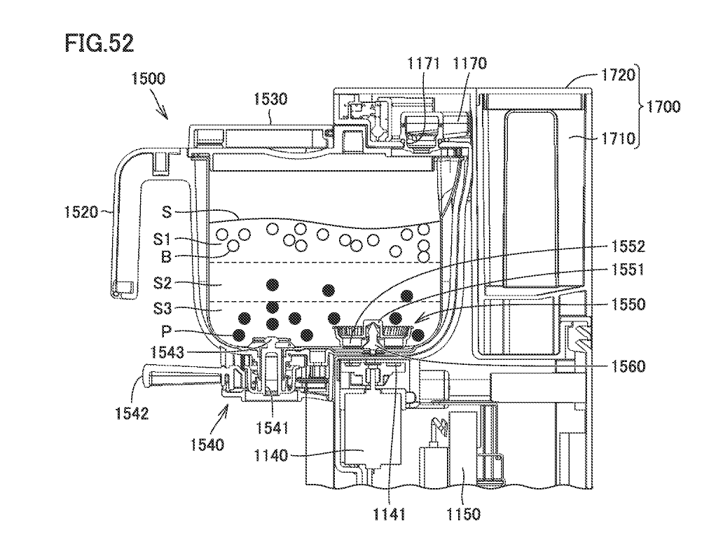

An operation of agitation blade 1550 in discharging of tea in agitation tank 1510 will be described. FIG. 50 is a flowchart showing details of a discharging step in a flow for preparation of a beverage using the beverage preparation apparatus according to the present embodiment. Details of the discharging step will be described with reference to FIG. 50.

In the discharging step, initially, when the discharging step is started as shown in a step 118, an operation for opening discharge port 1541 in a step 1181 and start of an agitation operation in a step 1183 are simultaneously performed. Specifically, as the user moves operation lever 1542 against biasing force, opening and closing nozzle 1543 moves up to open discharge port 1541. Simultaneously, in coordination of the operation of operation lever 1542, a switch (not shown) provided in apparatus main body 1100 is pressed. The switch is thus turned on. The switch corresponds to the sensing device 1115.

When the switch is pressed to be turned on, the switch senses timing of an operation of operation lever 1542, that is, timing of discharge of tea from discharge mechanism 1540 to the outside, and inputs a sensing signal indicative of sensing of the timing to control unit 1110. Control unit 1110 controls agitation motor unit 1140 such that agitation blade 1550 rotates based on the input sensing signal. Thus, agitation blade 1550 rotates simultaneously with opening of discharge port 1541.

After a prescribed period of time has elapsed since opening of discharge port 1541 such that a desired amount of tea is discharged into a cup, discharge port 1541 is closed in a step 1182. Specifically, as the user returns operation lever 1542 from a moved state to the original state against biasing force, opening and closing nozzle 1543 moves down to close discharge port 1541. Simultaneously, the switch is turned off from the on state.

During a period from step 1181 to step 1182, control unit 1110 controls agitation motor unit 1140 such that agitation blade 1550 is continuously or intermittently rotationally driven. Specifically, in a step 1184, control unit 1110 determines whether a mode is set to a continuous rotation mode or an intermittent rotation mode. Whether the mode is set to the continuous rotation mode or the intermittent rotation mode is determined, for example, by selection made by a user in advance through an operation panel. When any one of the continuous rotation mode and the intermittent rotation mode is set in advance, step 1184 is not performed but any one of a step 1185A and a step 1185B is performed.

When control unit 1110 determines in step 1184 that the mode is set to the continuous rotation mode (step 1184: YES), step 1185A is performed. In step 1185A, control unit 1110 controls agitation motor unit 1140 such that agitation blade 1550 is continuously rotationally driven during a period from opening of discharge port 1541 until closing of discharge port 1542. Thus, when a liquid (a liquid mixture composed of powders and a liquid) is discharged from discharge mechanism 1540 to the outside, agitation blade 1550 continuously rotates. A time period for agitation may be set to a time period from opening of discharge port 1541 until lapse of a prescribed period of time. Such a time period for agitation can be indicated through input portion 1112 described above.

When control unit 1110 determines in step 1184 that the mode is set to the intermittent rotation mode (step 1184: NO), step 1185B is performed. In step 1185B, control unit 1110 controls agitation motor unit 1140 such that agitation blade 1550 is intermittently rotationally driven during a period from opening of discharge port 1541 until closing of discharge port 1542. Thus, when a liquid is discharged from discharge mechanism 1540 to the outside, agitation blade 1550 intermittently rotates. Being intermittently rotationally driven means repeated rotation for a prescribed period of time at a prescribed interval based on a prescribed cycle of ON and OFF. Timing of rotation of agitation blade 1550 can be set as appropriate, and agitation may be carried out only immediately after opening of discharge port 1541 and immediately before closing of the discharge port. The number of rotations of the agitation blade may be set to one only within a prescribed period of time during a period from opening of discharge port 1541 until closing of discharge port 1542. A time period during which agitation blade 1550 is rotationally driven and/or the number of rotations can be indicated through input portion 1112 described above.

Then, in a step 1186, control unit 1110 controls agitation motor unit 1140 such that a rotation operation of agitation blade 1550 is stopped. Agitation thus ends. The discharging step ends as shown in a step 1189 with closing of discharge port 1541 in step 1182 and end of agitation in step 1186.

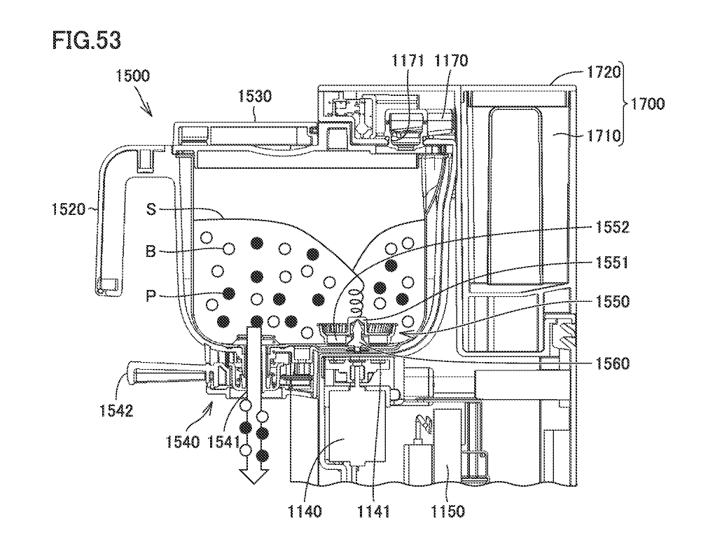

Change in state of tea in agitation tank 1510 as a result of such discharging will be described. FIG. 51 is a diagram showing a state in the agitation tank in the step of starting agitation shown in FIG. 41. FIG. 52 is a diagram showing a state in the agitation tank after a prescribed period of time has elapsed since end of agitation in the step of end of agitation shown in FIG. 41. FIG. 53 is a diagram showing a state of tea discharged in the discharging step shown in FIG. 41.

As shown in FIG. 51, during a period in which step 116 to step 117 in FIG. 41 are performed, control unit 1110 controls agitation motor unit 1140 such that agitation blade 1550 is rotationally driven for agitating hot water and tea leaf powders supplied into agitation tank 1510. In this state, agitation blade 1550 is rotationally driven so that centrifugal force is applied to hot water in agitation tank 1510. Thus, a liquid level S is formed to swirl so that air can be taken into hot water. Air which has been taken in is finely crushed by the blade portion of agitation blade 1550 to become air bubbles B and the air bubbles are uniformly dispersed in hot water together with tea leaf powders P. Thus, fine foams and tea substantially constant in concentration are produced.

As shown in FIG. 52, when agitation in step 117 in FIG. 41 ends and a prescribed period of time has elapsed before start of discharging in step S118, produced tea is separated into a layer containing a large amount of air bubbles B (foams) (a layer S1), a layer containing a small amount of tea leaf powders (a layer S2), and a layer containing a large amount of tea leaf powders (a layer S3).

Layer S1 is small in specific gravity because it contains a large amount of foams. Therefore, after agitation in step 117 ends, layer S1 is substantially immediately separated. Layer 2 and layer 3 are separated as tea leaf powders settle down toward the bottom portion of agitation tank 1510. Therefore, time necessary for layer 2 and layer 3 to be separated is longer to some extent than time for layer S1 to be separated.

In this case, since an amount of tea leaf powders contained in layer S2 is smaller than an amount of tea leaf powders contained in layer S3, specific gravity (concentration) of layer S2 is smaller than specific gravity (concentration) of layer S3.

When tea in which portions different from each other in specific gravity are thus separated is discharged, the tea is discharged successively from layer S3. Therefore, when several servings of tea are prepared, only tea high in concentration may be discharged and foams may not be discharged. It is thus concerned that tea different from preference of a user may be discharged.

In the present embodiment, as described in connection with the discharging step above, control unit 1110 controls agitation motor unit 1140 such that agitation blade 1550 is rotationally driven simultaneously with start of discharging of tea by discharge mechanism 1540 based on a sensing signal input as a result of sensing by the sensing device 1115 of timing of discharge from discharge mechanism 1540.

Thus, agitation blade 1550 rotates during discharging of tea, so that tea can be discharged into a cup while air bubbles B and tea leaf powders P are uniformly dispersed as shown in FIG. 53.

Thus, control unit 1110 controls agitation motor unit 1140 such that agitation blade 1550 is rotationally driven simultaneously with start of discharging of tea by discharge mechanism 1540 in a signal input state that the sensing signal has been input. Accordingly, beverage preparation apparatus 1001 according to the present embodiment can discharge a beverage having desired specific gravity in accordance with preference of a user while the beverage preparation apparatus prepares a desired amount of beverage.

When agitation blade 1550 is intermittently rotated while tea is discharged from discharge port 1541, no negative pressure originating from rotation of agitation blade 1550 is generated during a period in which agitation blade 1550 is not operating. Therefore, a speed of discharging of tea from discharge port 1541 can be higher. Thus, a time period for discharging a necessary amount of tea can be decreased. When agitation blade 1550 is continuously rotated as well, a time period during which no negative pressure is generated can be provided by restricting a time period for agitation. Therefore, a time period for discharging tea can be decreased. An amount of foams can also be adjusted by adjusting a time period for agitation.

Though an example in which a prescribed period of time has elapsed by the time of start of discharging in step 118 since end of agitation in step 117 and tea is separated into layer S1, layer S2, and layer S3 is illustrated and described in the present embodiment, separation of tea is not limited to such an example.

For example, tea may be separated into two layers of a layer containing a large amount of foams and a liquid layer substantially uniform in concentration. In this case, the layer containing a large amount of foams is separated immediately after end of agitation in step 117. Therefore, a prescribed period of time after end of step 117 until start of discharging in step 118 includes also a very short time period in which foams are separated from a liquid.

Though an example in which the sensing device 1115 is implemented by a switch provided to be in coordination with an operation of operation lever 1542 is illustrated and described in the present embodiment, limitation thereto is not intended and it may be implemented by a switch provided not to be in coordination with an operation of operation lever 1542. In this case, timing to press the switch may be before an operation of operation lever 1542 in the discharging step. In this case, an agitation operation is started first in step 1183, and discharge port 1541 may be opened and closed by an operation of operation lever 1542 by a user by the time of end of the agitation operation in step 1186. Furthermore, in this case, beverage preparation apparatus 1001 desirably has means for notifying a user of a discharging stand-by state during a period from step 1183 until step 1186. The switch may be pressed after the operation of operation lever 1542.

### Embodiment 11

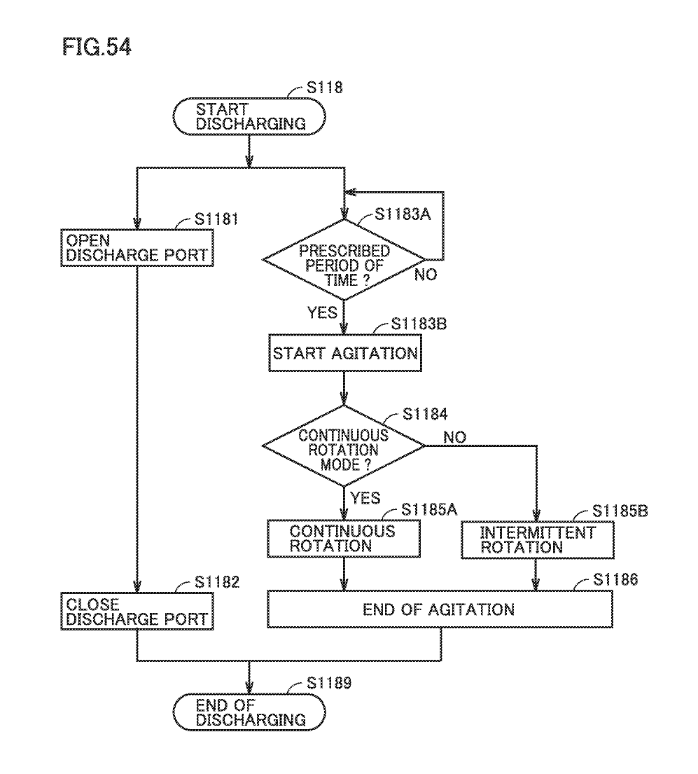

FIG. 54 is a flowchart showing details of the discharging step in the flow for preparation of a beverage using the beverage preparation apparatus according to the present embodiment. The discharging step according to the present embodiment will be described with reference to FIG. 54.

As shown in FIG. 54, the step of discharging from the agitation unit according to the present embodiment is different from the step of discharging from agitation unit 1500 according to Embodiment 10 in timing of rotation of agitation blade 1550. Specifically, in the discharging step in the beverage preparation flow in the beverage preparation apparatus according to the present embodiment, agitation blade 1550 rotates after lapse of a prescribed period of time since opening of discharge port 1541.

More specifically, initially, when the discharging step is started as shown in step 118, discharge port 1541 is opened in step 1181. Specifically, as a user moves operation lever 1542 against biasing force, opening and closing nozzle 1543 moves up to thereby open discharge port 1541. In succession, after a prescribed period of time (a first time period) has elapsed since opening of discharge port 1541 for discharging of a desired amount of tea into a cup, discharge port 1541 is closed in step 1182.

During a period in which step 1181 and step 1182 are performed, operations from a step 1183A to step 1186 are performed in parallel. When the user moves operation lever 1542 in step 1181, a switch (not shown) provided in apparatus main body 1100 is pressed in coordination with an operation of operation lever 1542. The switch is thus turned on.

As the switch is turned on, the switch senses timing of discharging of tea from discharge mechanism 1540 to the outside and inputs a sensing signal indicative of sensing of the timing to control unit 1110.

In a signal input state that the sensing signal has been input to control unit 1110, initially, in step 1183A, control unit 1110 checks whether or not a prescribed period of time (a second time period shorter than a first time period) has elapsed since opening of discharge port 1541. When the prescribed period of time has elapsed (step 1183A: YES), a step 1183B is performed. When the prescribed period of time has not elapsed (step 1183A: NO), the control unit stands by until the prescribed period of time elapses.

Then, in step 1183B, control unit 1110 controls agitation motor unit 1140 such that agitation blade 1550 rotates. In succession, during a period from step 1184 to step 1186, control unit 1110 performs operations similar to those in step 1184 to step 1186 according to Embodiment 10 and controls agitation motor unit 1140 such that agitation blade 1550 continuously or intermittently rotates. A time period of rotation of agitation blade 1550 is shorter than the first time period described above.

In step 1186, control unit 1110 controls agitation motor unit 1140 such that a rotation operation of agitation blade 1550 is stopped. Agitation thus ends. Thus, the discharging step ends as shown in step 1189 with closing of discharge port 1541 in step 1182 and end of agitation in step 1186.

As the operations as above are performed, in the discharging step in the present embodiment, tea great in specific gravity is mainly discharged during a period from opening of discharge port 1541 until start of agitation. Therefore, the discharging step is preferably started as immediately as possible after end of agitation in step 117 shown in FIG. 41. In this case, settling of tea leaf powders can be suppressed and tea relatively uniform in concentration can be discharged into a cup.

Then, during a period from start of agitation until closing of discharge port 1541, tea in agitation tank 1510 is agitated as a result of rotation of agitation blade 1550, so that tea in which air bubbles and tea leaf powders are uniformly dispersed is discharged into a cup. In this case, since some of tea is discharged before agitation, an amount of tea in agitation tank 1510 has been decreased by the time of agitation. Therefore, tea containing a large amount of foams as a result of agitation is prepared.

Therefore, topped-up tea mainly contains a large amount of foams. Tea can be supplied into a cup in such a manner that fine foams are carried over tea substantially constant in concentration which has previously been poured into the cup. When a user desires to taste tea with good texture and good gulp feeling, such a discharging step is preferably employed.

Thus, control unit 1110 controls agitation motor unit 1140 such that agitation blade 1550 is rotationally driven after lapse of a prescribed period of time since input of a sensing signal from the sensing device 1115 and discharging of a liquid from discharge mechanism 1540 to the outside. Thus, the beverage preparation apparatus according to the present embodiment can also discharge a beverage having desired specific gravity in accordance with preference of a user while the beverage preparation apparatus prepares a desired amount of beverage.

### Embodiment 12

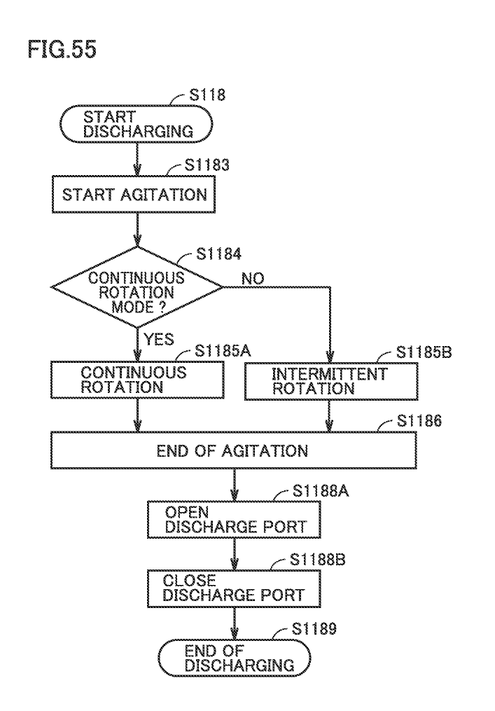

FIG. 55 is a flowchart showing details of the discharging step in the flow for preparation of a beverage using the beverage preparation apparatus according to the present embodiment. The discharging step according to the present embodiment will be described with reference to FIG. 55.

As shown in FIG. 55, the discharging step in the beverage preparation flow according to the present embodiment is different from the discharging step in the first preparation flow according to Embodiment 10 in timing of rotation of agitation blade 1550. Specifically, in the step of discharging from the agitation unit according to the present embodiment, agitation is started by the time of opening of discharge port 1541. The agitation unit according to the present embodiment is different from agitation unit 1500 according to Embodiment 10 in construction of the discharge mechanism. Specifically, the discharge mechanism in agitation unit 1500 includes opening and closing means for automatically opening and closing discharge port 1541 such as an electromagnetic valve (not shown) instead of operation lever 1542 and opening and closing nozzle 1543. Operation means for operating the opening and closing means is provided.

In the discharging step according to the present embodiment, initially, a user operates operation means provided in apparatus main body 1100 at the timing when the user desires discharging. For operation means, a push button for starting a control operation or a liquid crystal display integrated with a touch sensor can be adopted. The operation means functions as an operation portion for operating discharge mechanism 1540 as above and also functions as the sensing device 1115. The operation means inputs the timing of operation to control unit 1110.

As shown in step 118, the discharging step is started as the operation portion is operated. As the operation portion is operated, the operation portion senses the timing of discharging of tea from the discharge mechanism to the outside and inputs a sensing signal indicative of sensing of timing to control unit 1110. Control unit 1110 controls agitation motor unit 1140 such that agitation blade 1550 rotates in step S183 based on the input sensing signal.

In succession, during a period from step 1184 to step 1186, control unit 1110 performs operations similar to those in step 1184 to step 1186 according to Embodiment 10, and controls agitation motor unit 1140 such that agitation blade 1550 continuously or intermittently rotates. In step 1186, control unit 1110 controls agitation motor unit 1140 such that the rotation operation of agitation blade 1550 is stopped. Agitation thus ends.

In succession, in a step 1188A, control unit 1110 sets an electromagnetic valve of discharge mechanism 1540 to open to thereby open discharge port 1541. After a prescribed period of time has elapsed since opening of discharge port 1541 such that a desired amount of tea is discharged into a cup, discharge port 1541 is closed in a step 1188B. Thus, the discharging step ends as shown in step 1189.

As the operations as above are performed, in the discharging step in the present embodiment, tea great in specific gravity is mainly discharged during a period from opening of discharge port 1541 until closing of discharge port 1541.

Therefore, preferably, discharge port 1541 is opened as immediately as possible after end of agitation in step 1186 so that tea in agitation tank 1510 is discharged into the cup. In this case, settling of tea leaf powders can be suppressed and tea relatively uniform in concentration can be discharged into the cup. When a user prefers tea containing less foam, such a discharging step is preferably employed.

Thus, control unit 1110 controls agitation motor unit 1140 such that agitation blade 1550 is rotationally driven before a sensing signal is input from the sensing device 1115 and a liquid (tea) is discharged from discharge mechanism 1540 to the outside. Thus, the beverage preparation apparatus according to the present embodiment can also discharge a beverage having desired specific gravity in accordance with preference of a user while the beverage preparation apparatus prepares a desired amount of beverage.

Though an example in which agitation by agitation blade 1550 ends before discharge port 1541 is opened is illustrated and described in the present embodiment, limitation thereto is not intended and agitation by agitation blade 1550 may end after opening of discharge port 1541. Namely, step 1186 may be performed after step 1188A.

### Embodiment 13

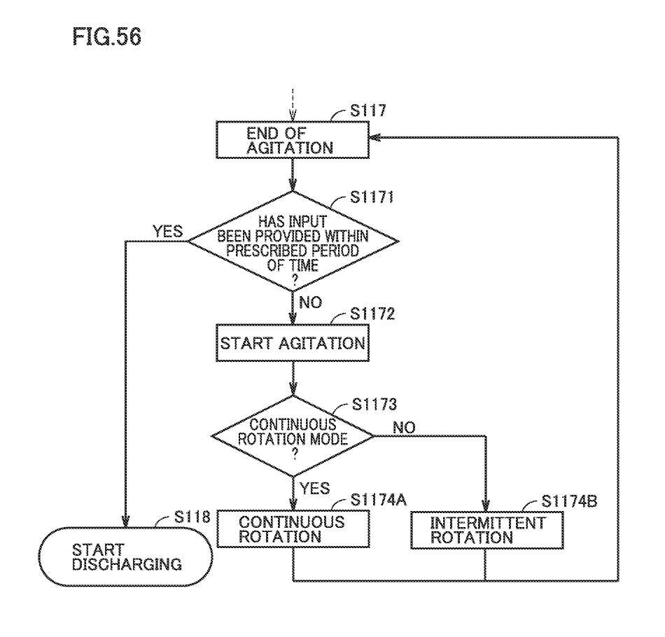

FIG. 56 is a flowchart showing an operation of the agitation unit between the step of end of agitation preceding the discharging step and the discharging step in the flow for preparation of a beverage using the beverage preparation apparatus according to the present embodiment. A preparation flow in the beverage preparation apparatus according to the present embodiment will be described with reference to FIG. 56.

As shown in FIG. 56, in the preparation flow for preparing tea with the use of the beverage preparation apparatus according to the present embodiment, steps (operations) from a step 11171 to a step 1173 are introduced between step S17 and step 118 in the first preparation flow for preparing tea with the use of the beverage preparation apparatus according to Embodiment 10.

Specifically, after agitation ends in step 117, control unit 110 checks in step 11171 whether or not a sensing signal has been input from the sensing device 1115 within a prescribed period of time. When the sensing signal has been input within a prescribed period of time (step 11171: YES), step 118 is started.

When the sensing signal has not been input within the prescribed period of time (step 11171: NO), a step 1172 is performed. In step 1172, control unit 1110 controls agitation motor unit 1140 such that agitation blade 1550 is rotationally driven.

Then, in a step 1173, control unit 1110 performs operations the same as in step 1184 according to Embodiment 10 and determines whether to continuously or intermittently rotate agitation blade 1550. When control unit 1110 determines in step 1173 that the mode is set to the continuous rotation mode (step 1173: YES), a step 1174A is performed. In step 1174A, control unit 1110 controls agitation motor unit 1140 such that agitation blade 1550 is continuously rotationally driven.

When control unit 1110 determines in step 1173 that the mode has been set to the intermittent rotation mode (step 1173: NO), a step 1174B is performed. In step 1174B, control unit 1110 controls agitation motor unit 1140 such that agitation blade 1550 is intermittently rotationally driven.

After agitation blade 1550 continuously or intermittently rotates for a prescribed period of time, control unit 1110 controls agitation motor unit 1140 such that rotation of agitation blade 1550 is stopped. Then, an operation from step 11171 is repeated.

Thus, control unit 1110 controls agitation motor unit 1140 such that agitation blade 1550 periodically rotates after agitation blade 1550 rotated for a prescribed period of time in a normal preparation flow before the sensing device 1115 senses the timing of discharging of tea. Thus, tea leaf powders can be prevented from settling down to the bottom portion of agitation tank 1510 by the time of start of the discharging step.

Though an operation between the step of end of agitation and the discharging step according to Embodiment 13 is illustrated and described as being applied to the first preparation flow in the beverage preparation apparatus according to Embodiment 10, limitation thereto is not intended. The operation may be applied to the second preparation flow and the third preparation flow in the beverage preparation apparatus according to Embodiment 10 or to the beverage preparation flow according to Embodiment 11 or 3.

### Embodiment 14

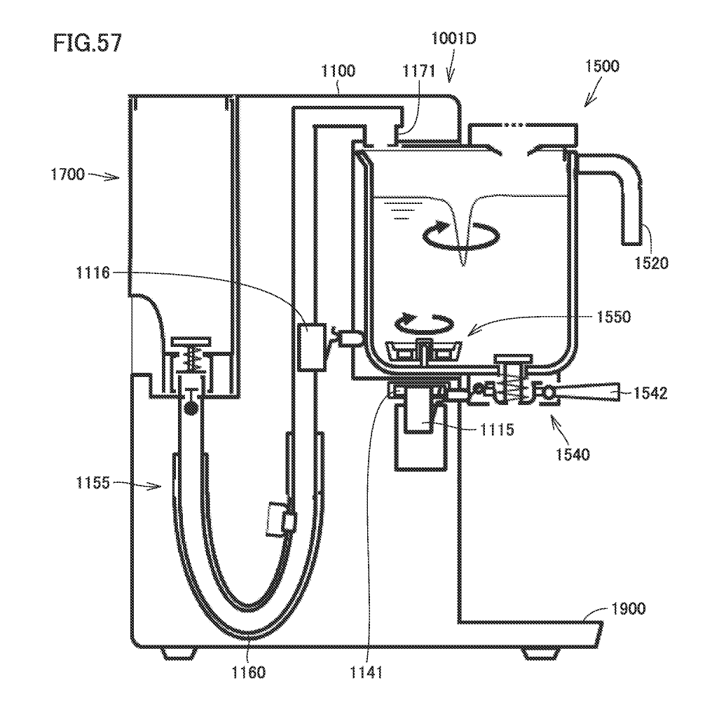

FIG. 57 is a cross-sectional view of a beverage preparation apparatus according to the present embodiment. A beverage preparation apparatus 1001D according to the present embodiment will be described with reference to FIG. 57.

Beverage preparation apparatus 1001D according to the present embodiment is different from beverage preparation apparatus 1001 according to Embodiment 10 in that an agitation tank sensing device 1116 for sensing whether or not agitation unit 1500 has been attached to agitation tank attachment portion 1190 is provided. The construction is otherwise substantially the same.

The agitation tank sensing device 1116 is attached, for example, to liquid supply path 1155 and provided to pass through a part of apparatus main body 1100 defining agitation tank attachment portion 1190. The agitation tank sensing device 1116 is in contact with agitation unit 1500 while agitation unit 1500 is attached. Various sensors such as an optical sensor and a load sensor can be employed as the agitation tank sensing device 1116. When an optical sensor is employed, the agitation sensing device 1116 does not have to be in contact with the agitation unit. The agitation tank sensing device 1116 should only be provided in apparatus main body 1100 such that attachment of agitation unit 1500 can be sensed through a through hole provided in a part of apparatus main body 1100 defining agitation tank attachment portion 1190.

In the present embodiment, during a period in which the agitation tank sensing device 20 is sensing attachment of the agitation unit, agitation blade 1550 is set to be intermittently rotationally driven. Thus, even when a time period from end of agitation in step 117 in the first preparation flow until start of the discharging step in step 118, for example, as shown in FIG. 41 is long, settling of powders or break of foams can be prevented.

Thus, in the present embodiment, even when a time period from end of agitation in step 117 until start of the discharging step in step 118 is long, settling of powders or break of foams can be prevented in addition to achievement of an effect substantially the same as the effect of the beverage preparation apparatus according to Embodiment 10.

Though an example in which the discharging step in Embodiments 10 to 3 and Embodiment 14 described above is applied to the discharging step in the first preparation flow in the beverage preparation apparatus according to Embodiment 10 is illustrated and described above, limitation thereto is not intended and the discharging step may be applicable to the discharging step in the second preparation flow and the discharging step in the third preparation flow.

Though an example in which the beverage preparation apparatus includes the sensing device is illustrated and described in Embodiments 10 to 5 above, limitation thereto is not intended and the beverage preparation apparatus does not have to include the sensing device. In this case, agitation blade 1550 may continuously or intermittently rotate, for example, until power of the beverage preparation apparatus is turned off. In this case, operation lever 1542 or an operation panel is operated at the timing of rotation of agitation blade 1550. Thus, in discharging a liquid from discharge mechanism 1540 to the outside, a state that agitation blade 1550 is rotationally driven can be established.

### Embodiment 15

### Beverage Preparation Apparatus 2001

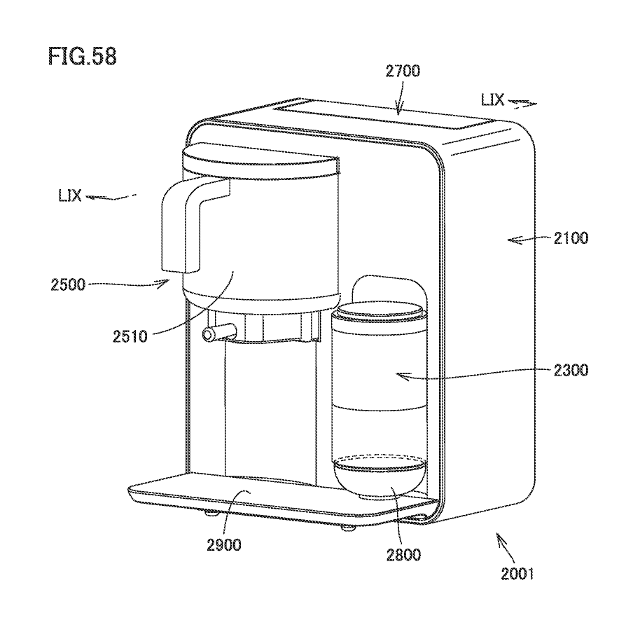

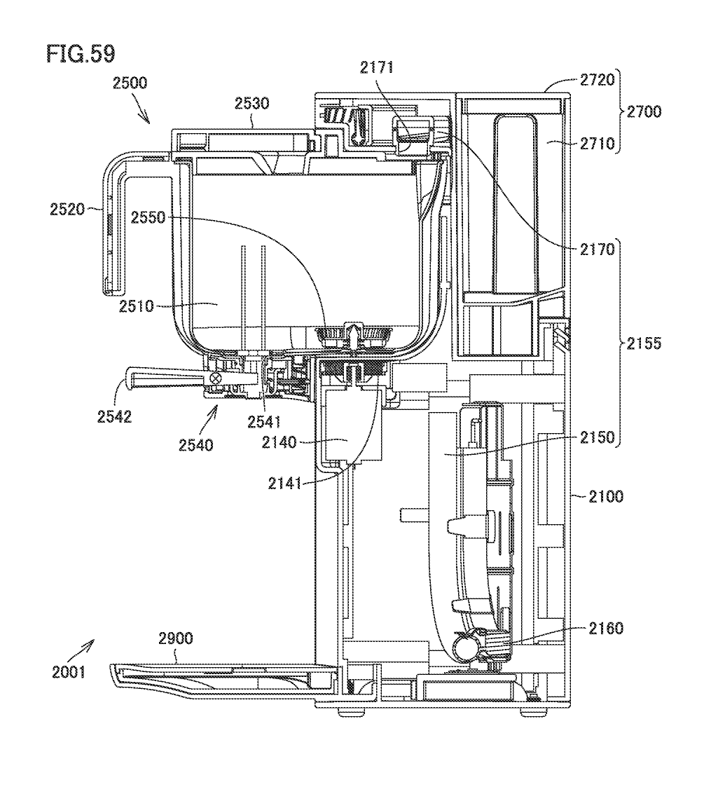

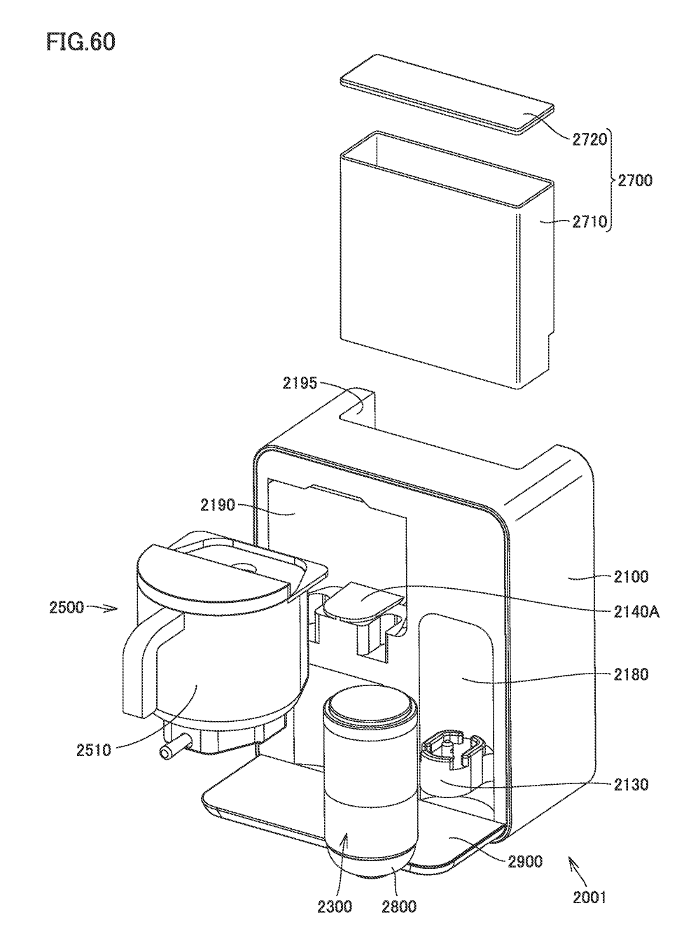

A beverage preparation apparatus 2001 in the present embodiment will be described with reference to FIGS. 58 to 60. FIG. 58 is an overall perspective view of beverage preparation apparatus 2001, FIG. 59 is a cross-sectional view along the line II-II in FIG. 58, and FIG. 60 is an overall perspective view of a schematic component of beverage preparation apparatus 2001.

As shown in FIGS. 58 to 60, beverage preparation apparatus 2001 uses tea leaves as an object to be grated and obtains tea leaf powders by grating the tea leaves. The beverage preparation apparatus uses the obtained tea leaf powders for preparing tea as a beverage. Beverage preparation apparatus 2001 includes an apparatus main body 2100 as a main body portion, a milling unit 2300, an agitation unit 2500, a liquid storage tank 2700, a liquid supply path 2155 as a liquid supply portion (see FIG. 59), a tea leaf powder tray 2800 as a powder reception portion, and a placement base 2900. Placement base 2900 is provided to protrude forward on a front side in a lower portion of apparatus main body 2100 and a cup (not shown) and tea leaf powder tray 2800 can be placed thereon. Tea leaf powder tray 2800 is provided such that a user can move the tray by holding the tray.

(Milling Unit 2300)

Milling unit 2300 is removably attached to a milling unit attachment portion 2180 provided on a front surface side of apparatus main body 2100. A milling driving force coupling mechanism 2130 is provided in milling unit attachment portion 2180 so as to protrude forward and milling unit 2300 is removably attached to milling driving force coupling mechanism 2130. Milling unit 2300 obtains driving force for milling tea leaves representing an object to be grated by being coupled to milling driving force coupling mechanism 2130.

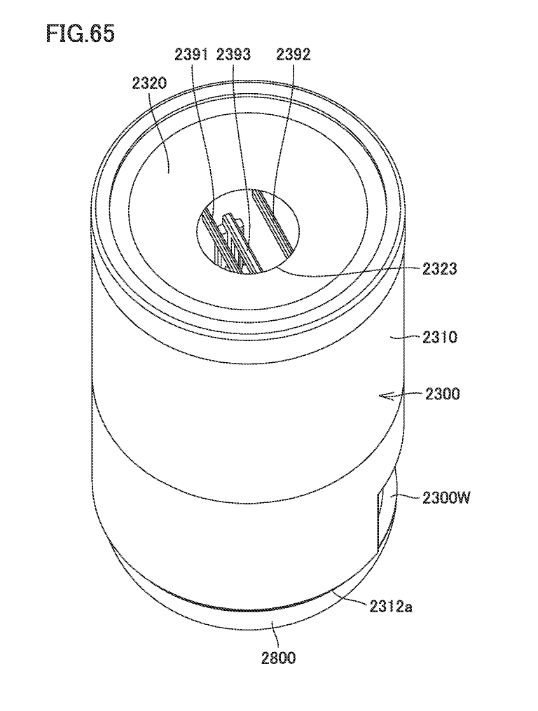

Tea leaves introduced from an upper portion of milling unit 2300 into milling unit 2300 are finely grated in milling unit 2300. The grated tea leaves are dropped and collected as tea leaf powders on tea leaf powder tray 2800 placed below milling unit 2300. A detailed structure of milling unit 2300 will be described later with reference to FIGS. 65 to 67.

(Liquid Storage Tank 2700)

Liquid storage tank 2700 is removably attached to a liquid storage tank attachment portion 2195 provided on an upper surface side of apparatus main body 2100. Liquid storage tank 2700 includes a tank main body 2710 having an opening in an upper surface and a lid portion 2720 closing the opening in the upper surface of tank main body 2710. Liquid storage tank 2700 stores such a liquid as water which is introduced from the outside by removing lid portion 2720.

(Liquid Supply Path 2155)

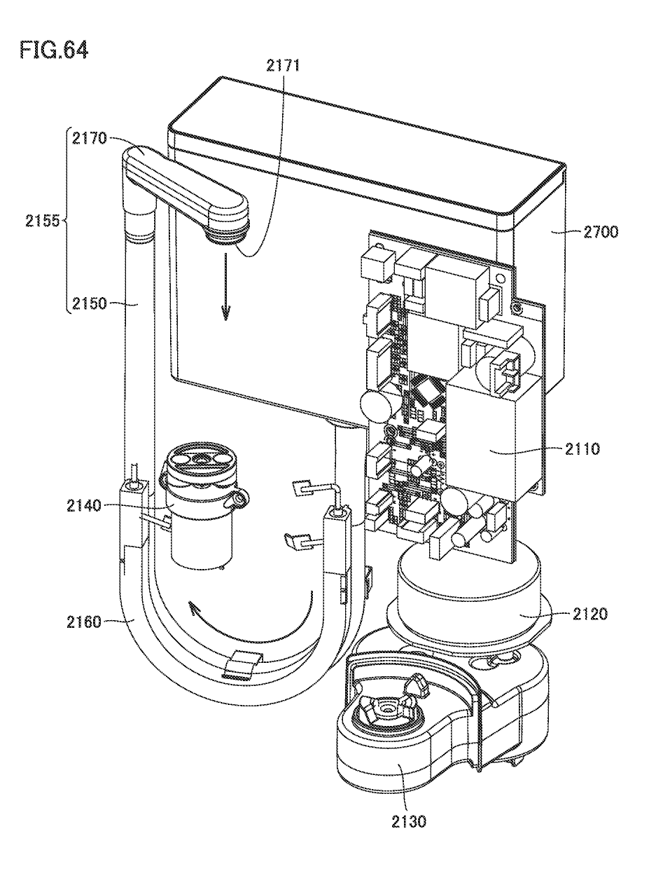

Liquid supply path 2155 is accommodated in apparatus main body 2100. Liquid supply path 2155 is connected to liquid storage tank 2700 (see FIG. 64). Liquid supply path 2155 is provided with a supply port 2171 on a side opposite to a side where liquid storage tank 2700 is connected. Liquid supply path 2155 includes a hot water supply pipe 2150 and a hot water supply nozzle 2170. Hot water supply pipe 2150 has one end side connected to liquid storage tank 2700 and the other end side connected to hot water supply nozzle 2170. A liquid introduced from liquid storage tank 2700 into liquid supply path 2155 is supplied to agitation unit 2500 through hot water supply pipe 2150 and hot water supply nozzle 2170.

(Agitation Unit 2500)

Agitation unit 2500 includes an agitation blade 2550 for agitating a liquid and powders and agitation tank 2510 accommodating agitation blade 2550. Agitation blade 2550 corresponds to an agitation member. Agitation tank 2510 is removably attached to an agitation tank attachment portion 2190 provided on the front surface side of apparatus main body 2100. Agitation tank 2510 is attached to agitation tank attachment portion 2190 such that a part of agitation tank 2510 protrudes from a front surface of apparatus main body 2100 in a direction of normal to the front surface.

An agitation motor contactless table 2140A is provided in agitation tank attachment portion 2190. Agitation unit 2500 is placed on agitation motor contactless table 2140A. Agitation blade 2550 provided in agitation unit 2500 is rotated by an agitation motor unit 2140 and a permanent magnet 2141 coupled thereto. Agitation motor unit 2140 and permanent magnet 2141 are accommodated in apparatus main body 2100 so as to be located below agitation motor contactless table 2140A. Agitation motor unit 2140 corresponds to an agitation blade drive portion which rotationally drives agitation blade 2550.

Hot water supply nozzle 2170 is provided above agitation tank attachment portion 2190 of apparatus main body 2100. In apparatus main body 2100, a temperature of water in hot water supply pipe 2150 is raised to a prescribed temperature and hot water is supplied from hot water supply nozzle 2170 into agitation tank 2510. Hot water prepared in apparatus main body 2100 and tea leaf powders obtained by milling unit 2300 are introduced into agitation tank 2510, and hot water and tea leaf powders are agitated by agitation blade 2550 in agitation tank 2510. Tea is thus prepared in agitation tank 2510.

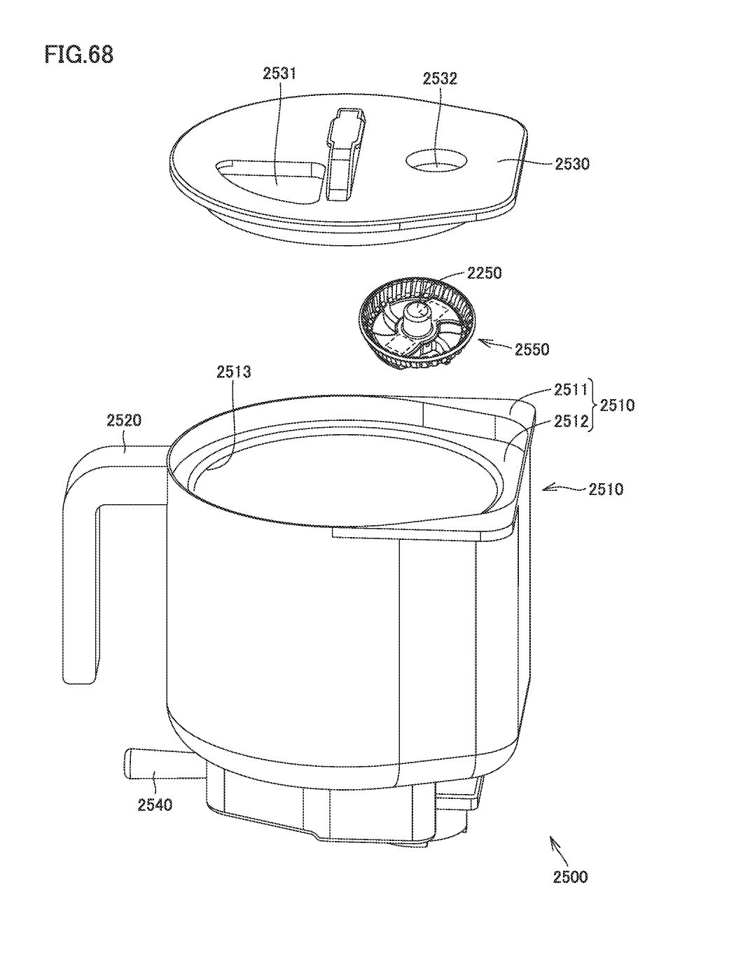

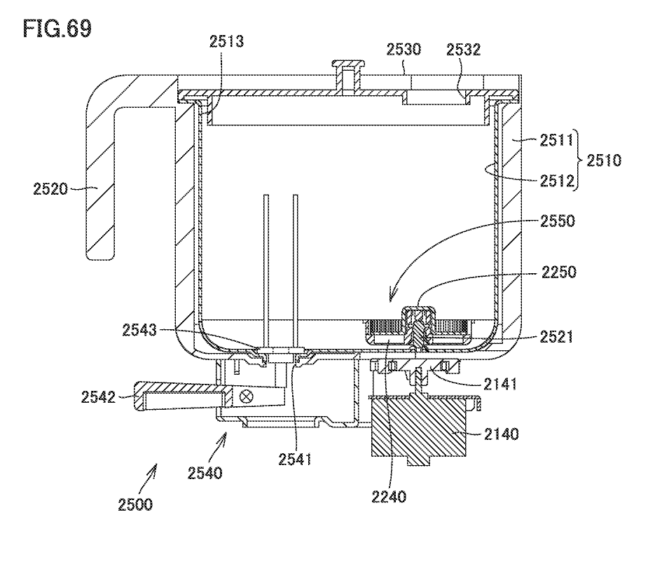

Tea prepared in agitation unit 2500 can be poured into a cup (not shown) placed on placement base 2900 by operating an operation lever 2542 of a discharge mechanism 2540 provided below agitation unit 2500. A detailed structure of agitation unit 2500 will be described later with reference to FIGS. 68 and 69.

(Flow of Preparation of Tea (Beverage))

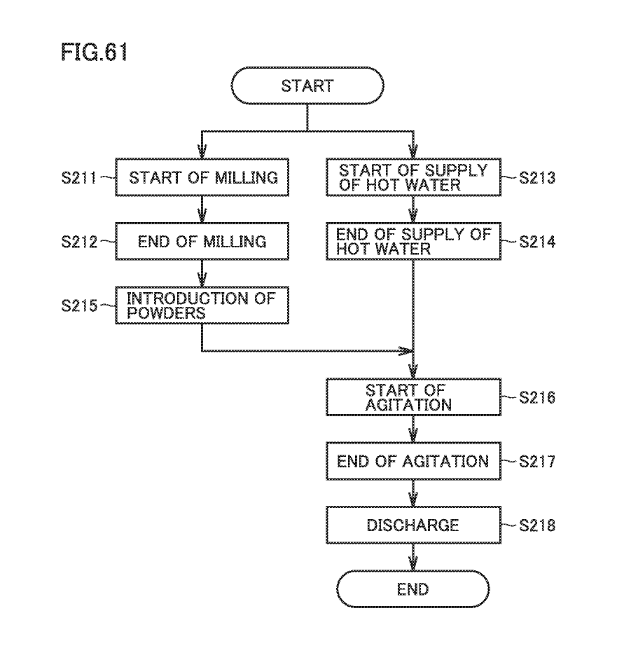

A flow of preparation of tea (beverage) with the use of beverage preparation apparatus 2001 will now be described with reference to FIGS. 61 to 63. FIGS. 61 to 63 show first to third preparation flows showing discharge of tea using beverage preparation apparatus 2001, respectively. A prescribed amount of tea leaves is introduced into milling unit 2300 and a prescribed amount of water is stored in liquid storage tank 2700.

(First Preparation Flow)

A first preparation flow will be described with reference to FIG. 61. This first preparation flow is a flow in which grating of tea leaves in milling unit 2300 and supply of hot water from apparatus main body 2100 to agitation unit 2500 are simultaneously carried out.

In beverage preparation apparatus 2001, milling of tea leaves by milling unit 2300 in a step 2211 and supply of hot water from apparatus main body 2100 to agitation unit 2500 in a step 2213 are simultaneously started. Then, milling of tea leaves by milling unit 2300 ends in a step 2212, and supply of hot water from apparatus main body 2100 to agitation unit 2500 ends in a step 2214.

In a step 2215, tea leaf powders obtained in step 2212 are introduced into agitation unit 2500 by a user.

Then, in a step 2216, agitation of the tea leaf powders and hot water in agitation unit 2500 is started. In a step 2217, agitation of the tea leaf powders and hot water in agitation unit 2500 ends. In a step 2218, tea is discharged into the cup placed on placement base 2900 as the user operates operation lever 2542 of discharge mechanism 2540 provided below agitation unit 2500. According to the present flow, since milling of tea leaves and supply of hot water are simultaneously performed, a tea beverage can efficiently be prepared in a short period of time.

(Second Preparation Flow)

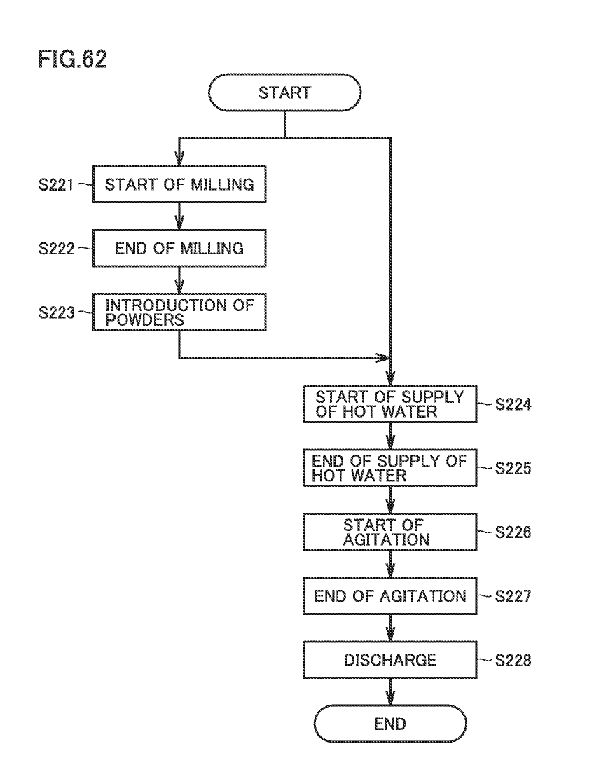

A second preparation flow will be described with reference to FIG. 62. This second preparation flow is a flow in which hot water is supplied from apparatus main body 2100 to agitation unit 2500 after tea leaves are grated in milling unit 2300.

In beverage preparation apparatus 2001, in a step 221, milling of tea leaves by milling unit 2300 is started. In a step 222, milling of tea leaves by milling unit 2300 ends. In a step 223, tea leaf powders obtained in step 222 are introduced into agitation unit 2500 by a user.

In a step 224, supply of hot water from apparatus main body 2100 to agitation unit 2500 is started. In a step 225, supply of hot water from apparatus main body 2100 to agitation unit 2500 ends.

Then, in a step 226, agitation of the tea leaf powders and hot water in agitation unit 2500 is started. In a step 227, agitation of the tea leaf powders and hot water in agitation unit 2500 ends. In a step 228, tea is discharged into the cup placed on placement base 2900 as the user operates operation lever 2542 of discharge mechanism 2540 provided below agitation unit 2500. According to the present flow, since hot water is supplied after tea leaves are milled, lowering in temperature of hot water can be suppressed.

(Third Preparation Flow)

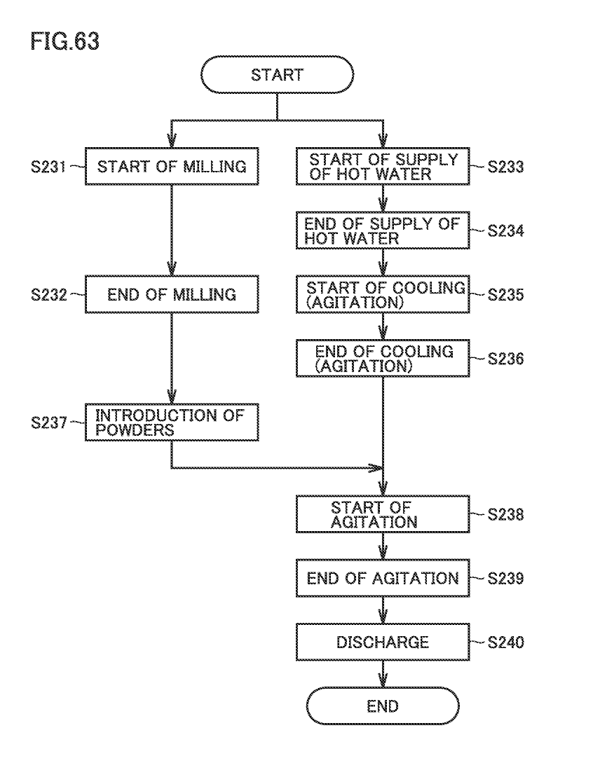

A third preparation flow will be described with reference to FIG. 63. This third preparation flow includes a step of cooling hot water by agitation in agitation unit 2500.

In beverage preparation apparatus 2001, milling of tea leaves by milling unit 2300 in a step 231 and supply of hot water from apparatus main body 2100 to agitation unit 2500 in a step 233 are simultaneously started. In a step 234, supply of hot water from apparatus main body 2100 to agitation unit 2500 ends.

Then, in a step 232, milling of tea leaves by milling unit 2300 ends, and in a step 235, cooling by agitation of hot water supply is started in agitation unit 2500. In a step 236, cooling by agitation of hot water supply in agitation unit 2500 ends.

In a step 237, the tea leaf powders obtained in step 232 are introduced into agitation unit 2500 by a user.

Then, in a step 238, agitation of the tea leaf powders and hot water in agitation unit 2500 is started. In a step 239, agitation of the tea leaf powders and hot water in agitation unit 2500 ends. In a step 240, tea is discharged into the cup placed on placement base 2900 as the user operates operation lever 2542 of discharge mechanism 2540 provided below agitation unit 2500. According to the present flow, a tea beverage can be prepared at an appropriate temperature from tea leaves suitable for hot water at a relatively low temperature, such as gyokuro.

(Internal Structure of Apparatus Main Body 2100)

An internal structure of apparatus main body 2100 will now be described with reference to FIG. 64. FIG. 64 is a perspective view showing the internal structure of beverage preparation apparatus 2001. In apparatus main body 2100 of beverage preparation apparatus 2001, a control unit 2110 including a printed circuit board on which electronic components are mounted is arranged on a front surface side of liquid storage tank 2700. Based on input of a start signal by a user, the flow for preparation of tea is executed by control unit 2110.

A milling motor unit 2120 for providing driving force to milling unit 2300 is arranged at a position below control unit 2110. Milling driving force coupling mechanism 2130 provided to protrude forward for transmitting driving force of milling motor unit 2120 to milling unit 2300 is provided at a position below milling motor unit 2120.

To a bottom surface of liquid storage tank 2700, one end of hot water supply pipe 2150 extending once downward from the bottom surface and then extending upward in a U shape is coupled. Hot water supply nozzle 2170 for pouring hot water into agitation tank 2510 of agitation unit 2500 is coupled to an upper end portion of hot water supply pipe 2150. A U-shaped heater 2160 for heating water which passes through hot water supply pipe 2150 is attached to an intermediate region of hot water supply pipe 2150.

(Structure of Milling Unit 2300)

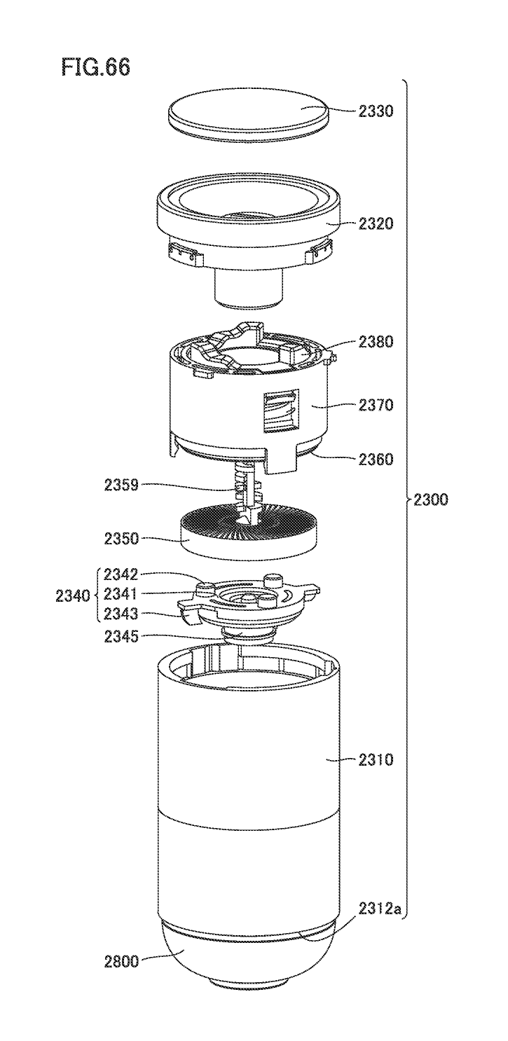

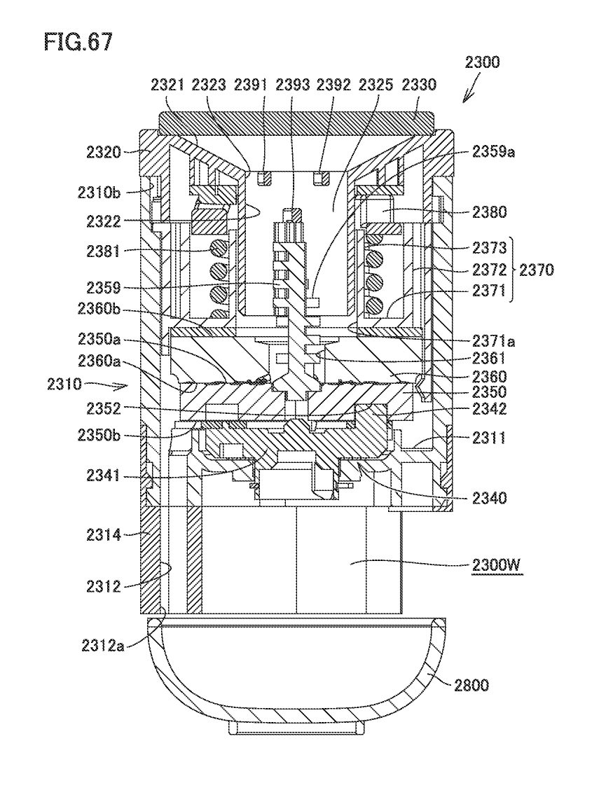

A structure of milling unit 2300 will now be described with reference to FIGS. 65 to 67. FIG. 65 is a perspective view of milling unit 2300, FIG. 66 is an exploded perspective view of milling unit 2300, and FIG. 67 is a vertical cross-sectional view of milling unit 2300.

Milling unit 2300 has a milling case 2310 having a cylindrical shape as a whole, and a window for coupling 2300W in which milling driving force coupling mechanism 2130 is inserted is provided in a side surface below. A storage portion 2311 (see FIG. 67) for storing tea leaf powders produced by an upper mill 2360 and a lower mill 2350 and a discharge path 2312 communicating with storage portion 2311 are provided. An outlet port 2312a for discharging tea leaf powders into tea leaf powder tray 2800 is provided at a lower end portion of discharge path 2312 which is a lowermost end portion of milling case 2310. Outlet port 2312a is provided below an opening portion 2513 of a thermally insulated tank 2512 (see FIG. 69) which will be described later. Entry through outlet port 2312a, of steam resulting from hot water supplied into thermally insulated tank 2512 can thus be prevented.

Milling unit 2300 includes upper mill 2360 and lower mill 2350 which grate an object to be grated and a lower mill support portion 2340 to which lower mill 2350 is attached. In milling case 2310, lower mill support portion 2340, lower mill 2350, and upper mill 2360 are successively provided from below.

Lower mill support portion 2340 supports lower mill 2350 from a side opposite to a side where upper mill 2360 is located (a side below lower mill 2350). Lower mill support portion 2340 has a substantially columnar main body portion 2341, an engagement protrusion portion 2342, and a powder scraping portion 2343. A milling shaft 2345 is provided on a lower surface of main body portion 2341 and extends downward. Milling shaft 2345 is coupled to milling driving force coupling mechanism 2130. Lower mill support portion 2340 is thus rotatable while it supports lower mill 2350.

Engagement protrusion portion 2342 is provided on an upper surface of main body portion 2341 and protrudes upward. Engagement protrusion portion 2342 is a site for locking lower mill 2350. Powder scraping portion 2343 is provided around a circumferential portion of main body portion 2341. Powder scraping portion 2343 scrapes off tea leaf powders stored in storage portion 2311 and transports the tea leaf powders to discharge path 2312 as lower mill support portion 2340 rotates.

Lower mill 2350 includes a main surface 2350a arranged to be opposed to a main surface 2360a of upper mill 2360, a main surface 2350b located opposite to main surface 2350a, and a circumferential surface connecting main surface 2350a and main surface 2350b to each other. A plurality of shear grooves are formed in main surface 2350a of lower mill 2350. The plurality of shear grooves are provided, for example, to extend along an equiangular spiral. The plurality of shear grooves may be such that linear grooves extending from an inner circumferential side toward an outer circumference are radially provided.

An engagement recess portion 2352 is provided in main surface 2350b of lower mill 2350. Engagement recess portion 2352 is provided at a position corresponding to engagement protrusion portion 2342 of lower mill support portion 2340 and locked by engagement protrusion portion 2342. Lower mill 2350 rotates in coordination with lower mill support portion 2340. A core 2359 extending upward along a core of a rotation shaft is provided in a central portion of lower mill 2350.

Core 2359 is provided to pass through a through hole 2361 provided in a central portion of upper mill 2360. Core 2359 has a helically provided helical blade 2359a.

Upper mill 2360 includes a main surface 2360a arranged to be opposed to main surface 2350a of lower mill 2350, a main surface 2360b located opposite to main surface 2360a, and a circumferential surface connecting main surface 2360a and main surface 2360b to each other. A shear groove is formed in main surface 2360a of upper mill 2360 as in main surface 2350a of the lower mill.

Upper mill 2360 is held by an upper mill holding member 2370 arranged above the upper mill. A not-shown hole portion is provided in an upper surface of upper mill 2360. As a not-shown pin portion provided in upper mill holding member 2370 enters the hole portion, rotation of upper mill 2360 is prevented.

Upper mill holding member 2370 includes a bottom surface portion 2371 provided with a hole portion 2371a, an outer cylindrical portion 2372 erected upward from a circumference of bottom surface portion 2371, and an inner cylindrical portion 2373 erected upward from a circumference of hole portion 2371a. Hole portion 2371a is provided to communicate with through hole 2361 in upper mill 2360. A spring 2381 pressing upper mill 2360 downward and a spring holding member 2380 are accommodated in between outer cylindrical portion 2372 and inner cylindrical portion 2373. Spring 2381 adjusts a grating pressure applied between upper mill 2360 and lower mill 2350.

A hopper portion 2320 for supplying an object to be grated in between upper mill 2360 and lower mill 2350 is attached to a side of an upper end opening portion 2310b of milling case 2310. Hopper portion 2320 has a top plate portion 2321, a cylindrical portion 2322, and an object-to-be-grated inlet 2325. Top plate portion 2321 has such a bowl shape that an opening portion 2323 is provided substantially in a central portion. Cylindrical portion 2322 is provided to extend downward from a circumference of opening portion 2323. Cylindrical portion 2322 is inserted in inner cylindrical portion 2373.

Object-to-be-grated inlet 2325 is defined by opening portion 2323 and cylindrical portion 2322. A tip end side of core 2359 is accommodated in object-to-be-grated inlet 2325. In cylindrical portion 2322, a plurality of linear ribs 2391, 2392, and 2393 are provided across object-to-be-grated inlet 2325.

In grating tea leaves, hopper portion 2320 is preferably covered with a cover portion 2330. Thus, after tea leaves are introduced into object-to-be-grated inlet 2325, entry of a foreign matter into milling unit 2300 and scattering of grated tea leaves can be prevented. When tea leaves are to be introduced, cover portion 2330 is removed from hopper portion 2320.

Tea leaves introduced into object-to-be-grated inlet 2325 are accommodated in a space defined by the upper surface of upper mill 2360 exposed through upper mill holding member 2370 and an inner circumferential surface of cylindrical portion 2322. Tea leaves accommodated in the space are guided in between upper mill 2360 and lower mill 2350 as helical blade 2359a rotates with rotation of lower mill 2350.

Tea leaves guided in between upper mill 2360 and lower mill 2350 are grated and fall downward in a form of tea leaf powders from a circumference of upper mill 2360 and lower mill 2350. Some of fallen tea leaf powders is discharged through discharge path 2312 into tea leaf powder tray 2800 from outlet port 2312a. Other fallen tea leaf powders are stored in storage portion 2311. Tea leaf powders in storage portion 2311 are transported to discharge path 2312 and discharged from outlet port 2312a into tea leaf powder tray 2800 as powder scraping portion 2343 rotates with rotation of lower mill support portion 2340.

(Structure of Agitation Unit 2500)

A structure of agitation unit 2500 will now be described with reference to FIGS. 68 and 69. FIG. 68 is a perspective view of agitation unit 2500 and FIG. 69 is a vertical cross-sectional view of agitation unit 2500.

Agitation unit 2500 is in a shape of a container having an opening upper surface and includes agitation tank 2510, agitation blade 2550, an agitation cover 2530, and discharge mechanism 2540. Agitation tank 2510 includes an exterior holder 2511 made of a resin and a thermally insulated tank 2512 held by exterior holder 2511. An integrally resin molded grip 2520 is provided in exterior holder 2511. Thermally insulated tank 2512 has opening portion 2513 which has a cylindrical shape with bottom and opens upward.

Agitation cover 2530 is attached to opening portion 2513 so as to be able to open and close opening portion 2513. Agitation cover 2530 is provided with a powder inlet 2531 for introducing tea leaf powders grated by milling unit 2300 and a hot water supply inlet 2532 through which hot water formed in apparatus main body 2100 is poured from hot water supply nozzle 2170. Hot water supply inlet 2532 is provided at a position corresponding to supply port 2171 of hot water supply nozzle 2170.

Powder inlet 2531 and hot water supply inlet 2532 communicate with opening portion 2513. Tea leaf powders introduced from moved tea leaf powder tray 2800 to powder inlet 2531 are introduced into thermally insulated tank 512 through opening portion 2513. Hot water poured through hot water supply inlet 2532 from hot water supply nozzle 2170 is supplied into thermally insulated tank 2512 through opening portion 2513.

Agitation blade 2550 is placed on a bottom portion of agitation tank 2510. A rotation shaft 2521 extending upward is provided on the bottom portion of agitation tank 2510, and a cylindrical core 2250 of agitation blade 2550 is inserted in this rotation shaft 2521.

A permanent magnet 2240 is embedded in agitation blade 2550. In agitation motor contactless table 2140A, permanent magnet 2240 embedded in agitation blade 2550 and permanent magnet 2141 provided on a side of agitation motor unit 2140 are magnetically coupled in a contactless state, so that rotational driving force of agitation motor unit 2140 is transmitted to agitation blade 2550.

Agitation blade 2550 can be modified as appropriate so long as the agitation blade is implemented as an agitation member having an agitation element in an outer circumferential portion. A wound portion formed from a wire in a toroidal shape or an impeller can be adopted as the agitation element.

Discharge mechanism 2540 discharges tea prepared as a result of agitation by agitation blade 2550. Discharge mechanism 2540 is provided to be able to open and close discharge port 2541 provided at the bottom portion of agitation tank 2510. As a user moves operation lever 2542, opening and closing of discharge port 2541 and a discharge path for an agitated liquid which will be described later can be switched (selected). As discharge port 2541 is opened, tea in agitation tank 2510 is poured into a cup (not shown) placed on placement base 2900.

(Details of Discharge Mechanism 2540)

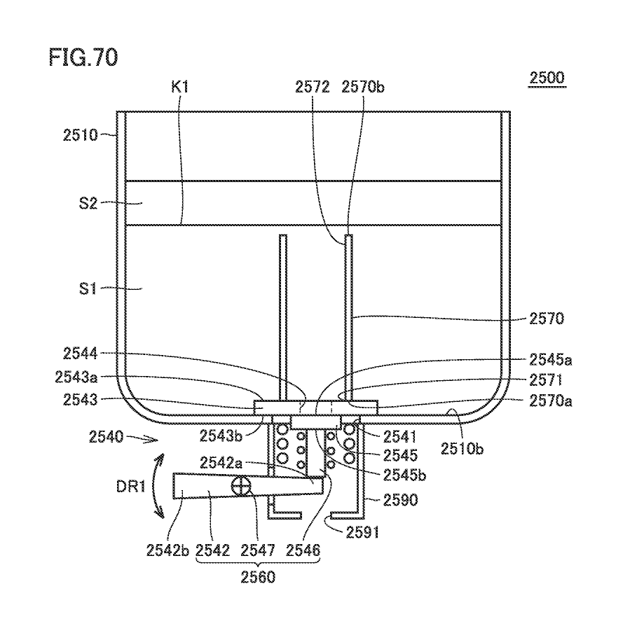

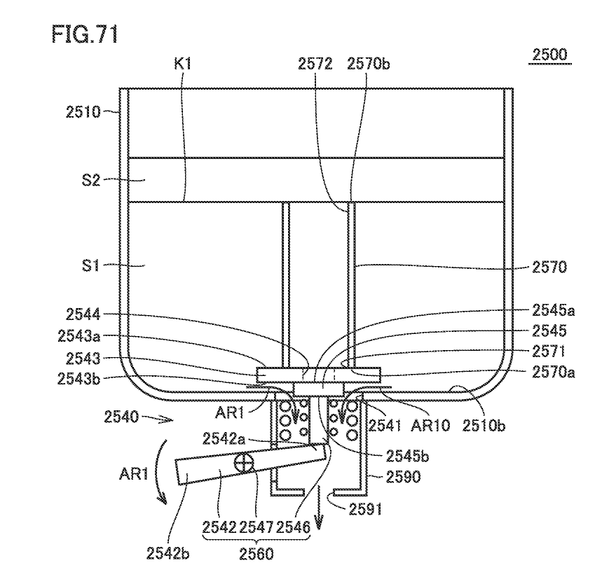

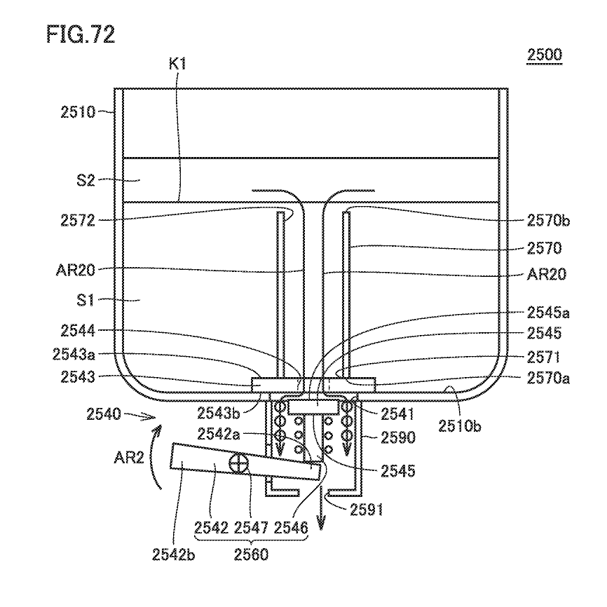

FIG. 70 is a schematic cross-sectional view showing an agitated liquid produced in the agitation unit according to the present embodiment and a discharge mechanism. FIGS. 71 and 72 are schematic cross-sectional views showing states that the discharge mechanism shown in FIG. 70 is opened and a first discharge path and a second discharge path are defined, respectively. A state of agitated tea and details of discharge mechanism 2540 will be described with reference to FIGS. 70 to 72.

As shown in FIG. 70, tea prepared as a result of agitation by agitation blade 2550 is separated into second layer S2 small in specific gravity and first layer S1 great in specific gravity due to a difference in specific gravity. Second layer S2 small in specific gravity is mainly composed of foams and first layer S1 great in specific gravity is composed of tea in which tea leaf powders and hot water have substantially uniformly been agitated. Foams are produced as a result of agitation of tea leaf powders and hot water while air is taken into a liquid.

Discharge mechanism 2540 includes a lid member 2543, a closing member 2545, a lift mechanism 2560, a cylindrical member 2570, and a discharge pipe 2590. Lid member 2543 is a site which can open and close discharge port 2541 provided in a bottom portion 2510b of agitation tank 2510. Lid member 2543 is formed, for example, from a gasket. Lid member 2543 is biased toward bottom portion 2510b by such a biasing member as a spring. A lower surface 2543b of lid member 2543 is thus liquid tightly in contact with bottom portion 2510b.

Lid member 2543 is provided to be movable in a direction away from bottom portion 2510b against biasing force. Lid member 2543 is provided with a through hole 2544 in the center and is in an annular shape. Through hole 2544 is provided to communicate with discharge port 2541.

Closing member 2545 opens and closes through hole 2544 provided in lid member 2543 from a side of discharge port 2541. Closing member 2545 is formed, for example, from a gasket. Closing member 2545 is biased toward lid member 2543 by such a biasing member as a spring. Thus, an upper surface 2545a of closing member 2545 is liquid tightly in contact with a lower surface 2543b of lid member 2543. Closing member 2545 is in a disc shape having an outer diameter larger than an inner diameter of through hole 2544.

Lift mechanism 2560 has operation lever 2542, a support shaft 2547, and a push-up member 2546. Operation lever 2542 is pivotally supported by support shaft 2547 around the shaft (in a direction shown with DR1 in the figure). Push-up member 2546 is in a shape, for example, of a column or a prism. Push-up member 2546 has an upper end fixed to a lower surface 2545b of closing member 2545 and has a lower end fixed to a tip end 2542a of operation lever 2542. Push-up member 2546 moves in a vertical direction in coordination with pivot of operation lever 2542.

Cylindrical member 2570 is arranged on an upper surface 2543a of lid member 2543 such that one end 2570a side surrounds through hole 2544. An opening portion 2571 is provided on one end 2570a side of cylindrical member 2570. A suction port 2572 is provided at the other end 2570b of cylindrical member 2570. Suction port 2572 is located in the vicinity of a boundary portion K1 between first layer S1 and second layer S2. Specifically, suction port 2572 is located slightly below boundary portion K1 between first layer S1 and second layer S2.

Discharge pipe 2590 is provided to communicate with discharge port 2541 provided in the bottom portion of agitation tank 2510. Discharge pipe 2590 extends downward from a circumference of discharge port 2541. Discharge pipe 2590 accommodates a part of lift mechanism 2560. Discharge pipe 2590 includes an exit portion 2591.

As shown in FIG. 71, when a user pivots downward (in a direction shown with AR1 in the figure) a side of a base end portion 2542b of operation lever 2542, push-up member 2546 moves upward to thereby push up closing member 2545, lid member 2543, and cylindrical member 2570. Here, a state that upper surface 2545a of closing member 2545 is liquid tightly in contact with lower surface 2543b of lid member 2543 is maintained and a state that closing member 2545 closes through hole 2544 is maintained.

As lid member 2543 is pushed upward and distant from discharge port 2541, a gap is provided between lower surface 2543b of lid member 2543 and bottom portion 2510b. Thus, agitation tank 2510 and discharge port 2541 communicate with each other, so that a first discharge path through which tea containing first layer S1 is discharged is defined. The first discharge path is defined by lower surface 2543b of lid member 2543, bottom portion 2510b of agitation tank 2510 in a portion opposed to the lower surface, and discharge port 2541. In this case, tea containing first layer S1 flows through the first discharge path as shown with an arrow AR10 in the figure, is guided from discharge port 2541 to discharge pipe 2590, and is discharged through exit portion 2591 of discharge pipe 2590 to the outside.

As shown in FIG. 72, when a user pivots upward (in a direction shown with AR2 in the figure) a side of base end portion 2542b of operation lever 2542, push-up member 2546 moves downward. With this movement, closing member 2545 fixed to push-up member 2546 also moves downward against biasing force which biases closing member 2545 toward lid member 2543. Thus, closing member 2545 moves away from through hole 2544, and a state that upper surface 2545a of closing member 2545 is liquid tightly in contact with lower surface 2543b of lid member 2543 is canceled. Since lower surface 2543b of lid member 2543 is maintained in a state that it is liquid tightly in contact with the bottom portion by biasing force of biasing toward the bottom portion of agitation tank 2510, a state that lid member 2543 closes discharge port 2541 except for a portion communicating with through hole 2544 is maintained.

Consequently, opening portion 2571 of cylindrical member 2570, through hole 2544 in lid member 2543, and discharge port 2541 communicate with one another, so that the second discharge path is defined. The second discharge path is defined by an inner circumferential surface of cylindrical member 2570, upper surface 2543a of lid member 2543 in a portion located on an inner side of one end 2570a of cylindrical member 2570, through hole 2544, and discharge port 2541. In this case, tea containing second layer S2 and first layer S1 is suctioned from suction port 2572 of cylindrical member 2570, flows through the second discharge path as shown with an arrow AR20 in the figure, is guided from discharge port 2541 to discharge pipe 2590, and is discharged through exit portion 2591 of discharge pipe 2590 to the outside.

Thus, discharge mechanism 2540 can switch (select) between the first discharge path through which tea containing first layer S1 is discharged and the second discharge path through which tea containing at least second layer S2 is discharged, by switching between directions of movement of base end portion 2542b of operation lever 2542. Thus, a desired amount of tea containing the second layer can be discharged in accordance with preference of a user.

When first layer S1 is first discharged to the outside, a liquid level of boundary portion K1 lowers with discharging. When boundary portion K1 is lower than suction port 2572 of cylindrical member 2570, second layer S2 cannot be discharged. Therefore, for example, when three servings of tea are prepared as shown in FIG. 72, preferably, tea containing the second layer is first discharged into three cups and then tea containing the first layer is discharged into the three cups.

Discharge mechanism 2540 is constituted of pivotably supported operation lever 2542 and push-up member 2546 which moves in coordination with operation lever 2542. Therefore, it is not necessary to electrically drive the discharge mechanism in discharging, and a construction of discharge mechanism 2540 can relatively be simplified.

As set forth above, agitation unit 2500 and beverage preparation apparatus 2001 including the same according to the present embodiment have a simplified construction, can agitate a desired amount of a supplied liquid, and can reliably discharge a liquid containing a layer small in specific gravity from an agitated liquid prepared by agitation and separated into different layers due to a difference in specific gravity.

### Embodiment 16

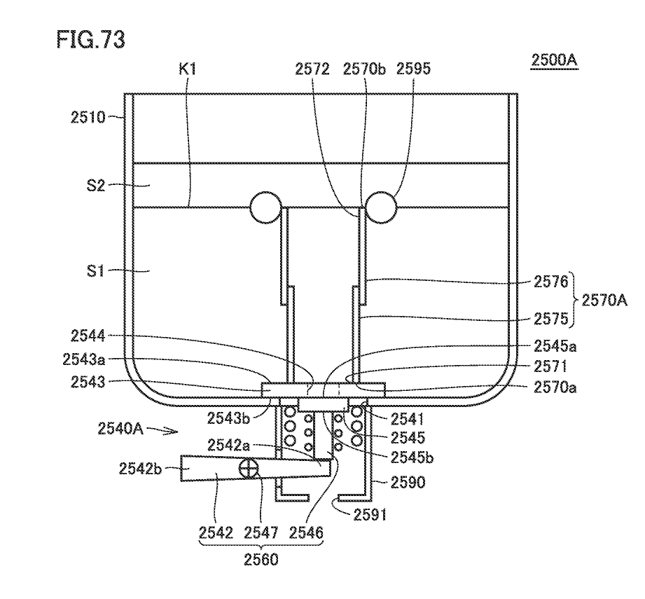

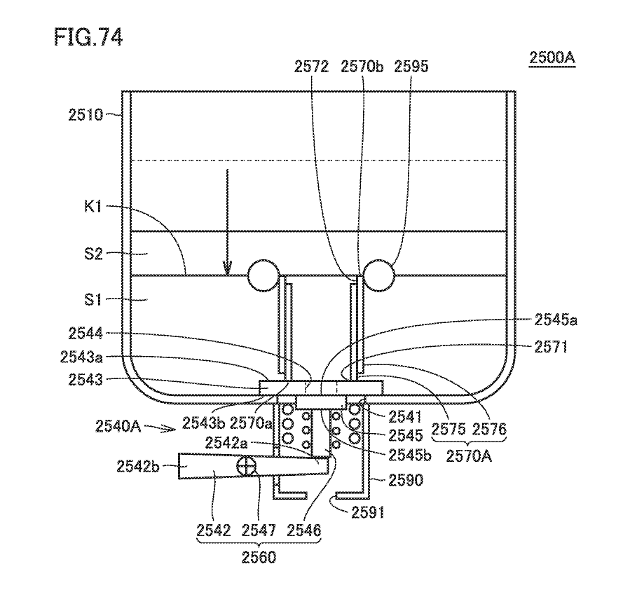

FIG. 73 is a schematic cross-sectional view showing an agitated liquid produced in an agitation unit according to the present embodiment and a discharge mechanism. FIG. 74 is a schematic cross-sectional view showing a state after some of the agitated liquid has been discharged from the state shown in FIG. 73. An agitation unit 2500A according to the present embodiment will be described with reference to FIGS. 73 and 74.

As shown in FIG. 73, agitation unit 2500A according to the present embodiment is different from agitation unit 2500 according to Embodiment 15 in including a float member 2595 and a structure of a discharge mechanism 2540A, and substantially the same as that in construction otherwise. Discharge mechanism 2540A is different from discharge mechanism 2540 according to Embodiment 15 in construction of a cylindrical member 2570A and substantially the same as that in construction otherwise.

Cylindrical member 2570A has a first cylindrical portion 2575 and a second cylindrical portion 2576. First cylindrical portion 2575 is located on one end 2570a side of cylindrical member 2570A. First cylindrical portion 2575 is fixed to upper surface 2543a of lid member 2543. A slide groove extending in the vertical direction is provided in an outer circumferential surface of first cylindrical portion 2575.

Second cylindrical portion 2576 is located on the other end 2570b side of cylindrical member 2570A. Second cylindrical portion 2576 is connected to first cylindrical portion 2575 and provided to be slidable in the vertical direction over first cylindrical portion 2575. Specifically, second cylindrical portion 2576 moves in the vertical direction owing to buoyancy received from first layer S1 by float member 2595 which will be described later.

A protrusion portion slidably fitted into the slide groove in first cylindrical portion 2575 described above is provided on an inner circumferential surface of second cylindrical portion 2576. As the protrusion portion slides within the slide groove, the inner circumferential surface of second cylindrical portion 2576 slides over the outer circumferential surface of first cylindrical portion 2575. Suction port 2572 is provided on the upper end side of second cylindrical portion 2576.

Float member 2595 is provided to sink in a liquid contained in second layer S2 and to float on a liquid contained in first layer S1 layer. Namely, specific gravity of the float member is set to be greater than specific gravity of second layer S2 and smaller than specific gravity of first layer S1. Thus, float member 2595 can follow displacement of boundary portion K1 between first layer S1 and second layer S2.

Float member 2595 is disposed around suction port 2572. Therefore, as float member 2595 follows displacement of boundary portion K1 between first layer S1 and second layer S2, second cylindrical portion 2576 moves with respect to first cylindrical portion 2575 and a position of suction port 2572 varies as following displacement of boundary portion K1.

As shown in FIG. 74, when tea containing first layer S1 is discharged, a position of boundary portion K1 between first layer S1 and second layer S2 moves downward as shown with an arrow in the figure, from a position shown with a dashed line in the figure. A position of float member 2595 moves downward as following variation in position of boundary portion K1.

In second cylindrical portion 2576, float member 2595 floats on first layer S1 owing to buoyancy received from first layer S1. Therefore, with movement of float member 2595 downward, the protrusion portion of second cylindrical portion 2576 moves downward along the slide groove of first cylindrical portion 2575 so that second cylindrical portion 2576 moves downward. Thus, a state that the position of suction port 2572 is located in the vicinity of boundary portion K1 can be maintained.

The position of suction port 2572 is preferably located slightly below boundary portion K1. Thus, tea containing second layer S2 can be suctioned while tea containing first layer S1 is suctioned. Therefore, tea containing second layer S2 can be discharged more efficiently than in an example in which suction port 2572 is located in second layer S2.

In agitation unit 2500A according to the present embodiment as well, discharge mechanism 2540A has a simplified construction, and switching between the first discharge path through which tea containing first layer S1 is discharged and the second discharge path through which tea containing second layer S2 is discharged can be made by an operation of operation lever 2542 by a user.

Therefore, agitation unit 2500A according to the present embodiment also obtains an effect substantially the same as the effect of agitation unit 2500 according to Embodiment 15. In agitation unit 2500A according to the present embodiment, even when a position of boundary portion K1 between first layer S1 and second layer S2 is displaced, a position of suction port 2572 through which tea containing second layer S2 is suctioned varies as following the position of boundary portion K1. Therefore, a user can have tea containing second layer S2 discharged into a cup as appropriate. Convenience is thus improved.

### Embodiment 17

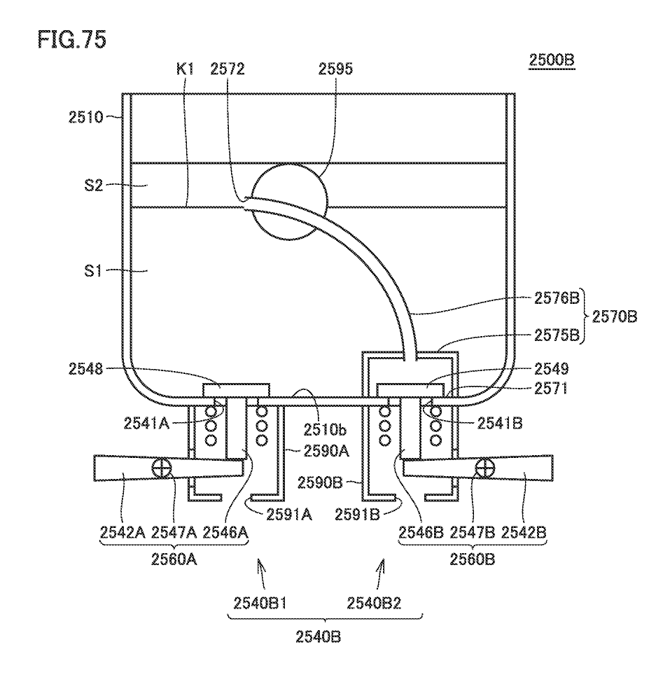

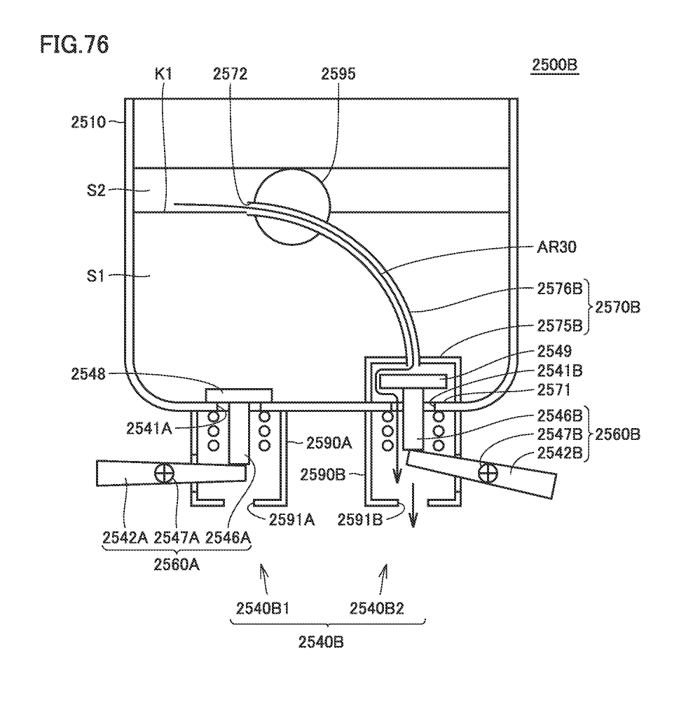

FIG. 75 is a schematic cross-sectional view showing an agitated liquid produced in an agitation unit according to the present embodiment and a discharge mechanism. FIG. 76 is a schematic cross-sectional view showing a state that the discharge mechanism of the agitation unit shown in FIG. 75 is opened to define the second discharge path. An agitation unit 2500B according to the present embodiment will be described with reference to FIGS. 75 and 76.

As shown in FIG. 75, agitation unit 2500B according to the present embodiment is different from agitation unit 2500 according to Embodiment 15 in a structure of a discharge mechanism 2540B. The construction is otherwise substantially the same.

Discharge mechanism 2540B includes a first opening and closing mechanism 2540B1 and a second opening and closing mechanism 2540B2. First opening and closing mechanism 2540B1 has a first lid member 2548, a first lift mechanism 2560A, and a first discharge pipe 2590A.

First lid member 2548 opens and closes a first discharge port 2541A provided in bottom portion 2510b of agitation tank 2510. First lid member 2548 is formed, for example, from a gasket. First lid member 2548 is biased toward bottom portion 2510b by such a biasing member as a spring. First lid member 2548 is thus liquid tightly in contact with bottom portion 2510b.

First lift mechanism 2560A is substantially the same in construction as lift mechanism 2560 according to Embodiment 15, and has an operation lever 2542A, a support shaft 2547A, and a push-up member 2546A. By pivoting operation lever 2542A downward around support shaft 2547A, push-up member 2546A moves upward. Thus, first lid member 2548 is pushed upward and a gap is provided between first lid member 2548 and bottom portion 2510b.

Consequently, first discharge port 2541A is opened by first opening and closing mechanism 2540B1 so that the first discharge path through which tea containing first layer S1 is discharged is defined. Tea containing first layer S1 flows through the first discharge path, is guided from first discharge port 2541A to first discharge pipe 2590A, and is discharged through an exit portion 2591A of first discharge pipe 2590A to the outside.

Second opening and closing mechanism 2540B2 has a second lid member 2549, a second lift mechanism 2560B, a second discharge pipe 2590B, and a cylindrical member 2570B.

Second lid member 2549 opens and closes a second discharge port 2541B provided in bottom portion 2510b of agitation tank 2510. Second lid member 2549 is formed, for example, from a gasket. Second lid member 2549 is biased toward bottom portion 2510b by such a biasing member as a spring. Thus, second lid member 2549 is liquid tightly in contact with bottom portion 2510b.

Second lift mechanism 2560B is substantially the same in construction as lift mechanism 2560 according to Embodiment 15, and has an operation lever 2542B, a support shaft 2547B, and a push-up member 2546B. Operation lever 2542B is provided to be pivotable around support shaft 2547B. Push-up member 2546B moves in the vertical direction in coordination with pivot of operation lever 2542B.

Cylindrical member 2570B has a first cylindrical portion 2575B and a second cylindrical portion 2576B. First cylindrical portion 2575B is located on one end side of cylindrical member 2570B. First cylindrical portion 2575B is in a shape of a cap having a top plate portion. A lower end (an opening end) of first cylindrical portion 2575B is provided to surround second discharge port 2541B. Second lid member 2549 is accommodated in first cylindrical portion 2575B. A connection portion for connecting second cylindrical portion 2576 is provided in a ceiling portion of first cylindrical portion 2575B.

Second cylindrical portion 2576B is located on the other end side of cylindrical member 2570B. Second cylindrical portion 2576B is connected to a top plate portion of first cylindrical portion 2575B. Second cylindrical portion 2576B has flexibility and is provided to be movable with respect to first cylindrical portion 2575B. Specifically, second cylindrical portion 2576B deforms in such a manner as being bent by buoyancy received from first layer S1 by float member 2595. Second cylindrical portion 2576B is smaller in inner diameter than first cylindrical portion 2575B.

Suction port 2572 is provided at an end portion of second cylindrical portion 2576B located opposite to first cylindrical portion 2575B. Float member 2595 similar to the float member according to Embodiment 16 is disposed around suction port 2572. As float member 2595 follows displacement of boundary portion K1, second cylindrical portion 2576B moves with respect to first cylindrical portion 2575B while second cylindrical portion 2576B deforms as being bent. Thus, a position of the suction port varies as following displacement of boundary portion K1.

As shown in FIG. 76, by pivoting operation lever 2542B downward around support shaft 2547B, push-up member 2546B moves upward. Thus, second lid member 2549 is pushed upward and a gap is provided between bottom portion 2510b and second lid member 2549.

Consequently, opening portion 2571 of cylindrical member 2570B and second discharge port 2541B communicate with each other so that the second discharge path is defined. The second discharge path is defined by an inner circumferential surface of second cylindrical portion 2576B, an inner surface of first cylindrical portion 2575B, bottom portion 2510b in a portion located on an inner side of an opening end of first cylindrical portion 2575B, and second discharge port 2541B.

In this case, tea containing second layer S2 is suctioned through suction port 2572, flows through the second discharge path as shown with an arrow AR30 in the figure, is guided from second discharge port 2541B to second discharge pipe 2590B, and is discharged through an exit portion 2591B of second discharge pipe 2590B to the outside.

In agitation unit 2500B according to the present embodiment as well, discharge mechanism 2540B has a simplified construction, and switching between the first discharge path through which tea containing first layer S1 is discharged and the second discharge path through which tea containing second layer S2 is discharged can be made by an operation of operation levers 2542A and 2542B by a user.

Therefore, agitation unit 2500B according to the present embodiment also obtains an effect substantially the same as the effect of agitation unit 2500 according to Embodiment 15. In agitation unit 2500B according to the present embodiment, even when a position of boundary portion K1 between first layer S1 and second layer S2 is displaced, a position of suction port 2572 through which tea containing second layer S2 is suctioned varies as following the position of boundary portion K1. Therefore, a user can have tea containing second layer S2 discharged into a cup as appropriate. Convenience is thus improved.

### Embodiment 18

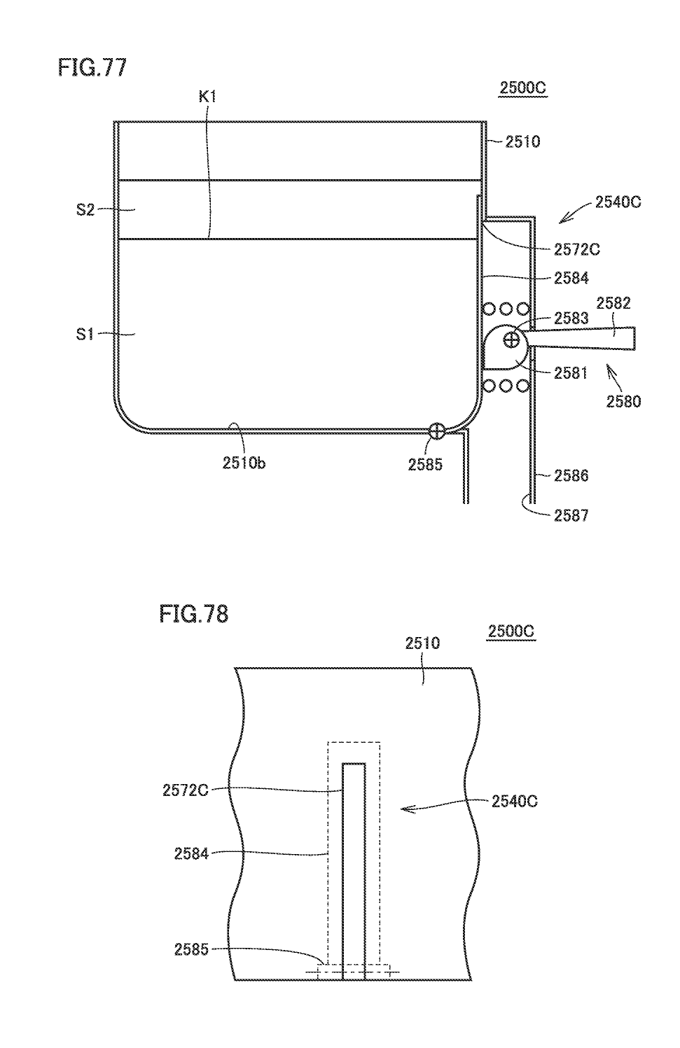

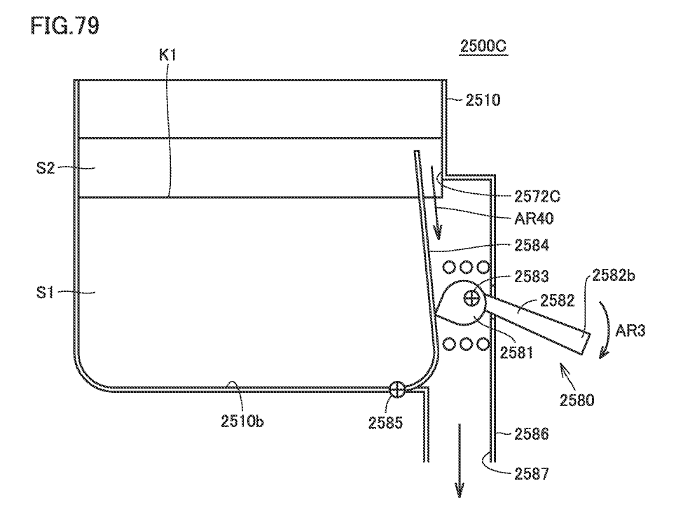

FIG. 77 is a schematic cross-sectional view showing an agitated liquid produced in an agitation unit according to the present embodiment and a discharge mechanism. FIG. 78 is a front view of the discharge mechanism shown in FIG. 77. FIG. 79 is a schematic cross-sectional view showing a state that the discharge mechanism shown in FIG. 77 is opened to discharge an agitated liquid. An agitation unit 2500C according to the present embodiment will be described with reference to FIGS. 77 to 79.

As shown in FIGS. 77 and 78, agitation unit 2500C according to the present embodiment is different from agitation unit 2500 according to Embodiment 15 in a construction of a discharge mechanism 2540C.

Discharge mechanism 2540C includes an opening and closing mechanism 2580 switching between an open state and a closed state of an opening portion 2572C provided on a side surface side of agitation tank 2510 and a discharge pipe 2586. As will be described later, opening portion 2572C functions as a suction port through which tea containing first layer S1 and second layer S2 is suctioned. Opening portion 2572C is provided from an upper side to a bottom portion of the side surface with a prescribed width (a length in the lateral direction in FIG. 78). An upper end of opening portion 2572C is located above boundary portion K1 between first layer S1 and second layer S2.

Opening and closing mechanism 2580 includes a lid member 2584, a support shaft 2585, a cam 2581, an operation lever 2582, and an operation shaft 2583. Lid member 2584 opens and closes opening portion 2572C provided in the side surface of agitation tank 2510 from an inner side of agitation tank 2510. Lid member 2584 is provided to be pivotable around support shaft 2585. Lid member 2584 is formed, for example, from a gasket. Lid member 2584 is biased toward the side surface of agitation tank 2510 by such a biasing member as a spring. Thus, lid member 2584 is liquid tightly in contact with bottom portion 2510b of agitation tank 2510 and the side surface around opening portion 2572C.

Operation lever 2582 is provided to be pivotable around operation shaft 2583. Cam 2581 is pivotally provided in coordination with pivot of operation lever 2582. Cam 2581 pivots around operation shaft 2583.

Discharge pipe 2586 is provided to surround opening portion 2572C from an outer side of the side surface of agitation tank 2510. Discharge pipe 2586 extends downward. Discharge pipe 2586 has an exit portion 2587. Exit portion 2587 is located at a position lower than bottom portion 2510b of agitation tank 2510. Cam 2581, operation shaft 2583, and a part of operation lever 2582 described above are accommodated in discharge pipe 2586.

As shown in FIG. 79, when a user pivots a base end portion 2582b of operation lever 2582 downward (in a direction shown with AR3 in the figure), cam 2581 pushes lid member 2584 into agitation tank 2510 against biasing force applied to lid member 2584. Thus, a gap is provided between the side surface of agitation tank 2510 and lid member 2584. Thus, as shown with an arrow AR40 in the figure, tea containing second layer S2 and first layer S1 is guided from opening portion 2572C to discharge pipe 2586 and discharged through exit portion 2587 of discharge pipe 2586 to the outside. Tea containing first layer S1 and second layer S2 can thus be poured into a cup.

Thus, in the present embodiment, tea containing first layer S1 and second layer S2 can be discharged and tea containing second layer S2 which makes a taste milder can reliably be discharged.

In agitation unit 2500C according to the present embodiment as well, discharge mechanism 2540C is constituted of pivotably supported operation lever 2582 and cam 2581 which moves in coordination with operation lever 2582. Therefore, it is not necessary to electrically drive the discharge mechanism in discharging, and a construction of discharge mechanism 2540C can be simplified.

Thus, agitation unit 2500C according to the present embodiment can obtain an effect substantially the same as the effect of agitation unit 2500 according to Embodiment 15.

### Embodiment 19

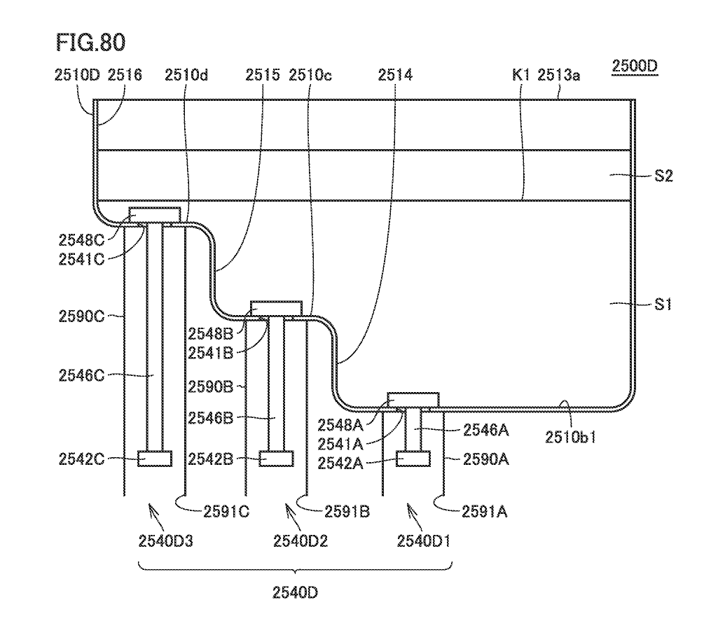

FIG. 80 is a schematic cross-sectional view showing an agitated liquid produced in an agitation unit according to the present embodiment and a discharge mechanism. An agitation unit 2500D according to the present embodiment will be described with reference to FIG. 80.

As shown in FIG. 80, agitation unit 2500D according to the present embodiment is different from any of the embodiments in a shape of an agitation tank 2510D and a construction of a discharge mechanism 2540D. The construction is otherwise substantially the same.

Agitation tank 2510D is in a shape like a staircase. Specifically, agitation tank 2510D includes a first bottom portion 2510b1, a second bottom portion 2510c, a third bottom portion 2510d, a first side wall portion 2514, a second side wall portion 2515, and a third side wall portion 2516. First bottom portion 2510b1 among first bottom portion 2510b1, second bottom portion 2510c, and third bottom portion 2510d is located at a position most distant from an opening surface 2513a of agitation tank 2510D in a direction of depth. Second bottom portion 2510c is located above first bottom portion 2510b1. Third bottom portion 2510d is located above second bottom portion 2510c.

First side wall portion 2514 is provided to connect first bottom portion 2510b1 and second bottom portion 2510c to each other. Second side wall portion 2515 is provided to connect second bottom portion 2510c and third bottom portion 2510d to each other. Third side wall portion 2516 is provided to be erected upward from a periphery of third bottom portion 2510d.

Discharge mechanism 2540D includes a first opening and closing mechanism 2540D1, a second opening and closing mechanism 2540D2, and a third opening and closing mechanism 2540D3. First opening and closing mechanism 2540D1 is provided to be able to switch between an open state and a closed state of first discharge port 2541A provided in first bottom portion 2510b1. First opening and closing mechanism 2540D1 is substantially the same in construction as first opening and closing mechanism 2540B1 according to Embodiment 17. In this case, operation levers 2542A to 2542C are provided to extend in a direction perpendicular to the drawing.

In first opening and closing mechanism 2540D1, push-up member 2546A is moved upward by pivoting a base end portion of operation lever 2542A downward. Thus, a lid member 2548A is pushed upward and a gap is provided between lid member 2548A and first bottom portion 2510b1.

Consequently, first discharge port 2541A is opened by first opening and closing mechanism 2540D1, so that the first discharge path through which tea containing first layer S1 is discharged is defined. Tea containing first layer S1 flows through the first discharge path, is guided from first discharge port 2541A to first discharge pipe 2590A, and is discharged through exit portion 2591A of first discharge pipe 2590A to the outside.

Second opening and closing mechanism 2540D2 is provided to be able to switch between an open state and a closed state of second discharge port 2541B provided in second bottom portion 2510c. Third opening and closing mechanism 2540D3 is provided to be able to switch between an open state and a closed state of third discharge port 2541C provided in third bottom portion 2510d. Second opening and closing mechanism 2540D2 and third opening and closing mechanism 2540D3 are substantially the same in construction as first opening and closing mechanism 2540D1. Thus, by performing an operation the same as the operation of first opening and closing mechanism 2540D1, tea is discharged through exit portion 2591B of second discharge pipe 2590B of second opening and closing mechanism 2540D2 and an exit portion 2591C of a third discharge pipe 2590C of third opening and closing mechanism 2540D3 to the outside.

Operation lever 2542B of second opening and closing mechanism 2540D2 and operation lever 2542C of third opening and closing mechanism 2540D3 are located at positions as high as the position of operation lever 2542A of first opening and closing mechanism 2540D1, and exit portion 2591B of second discharge pipe 2590B of second opening and closing mechanism 2540D2 and exit portion 2591C of third discharge pipe 2590C of third opening and closing mechanism 2540D3 are located at positions as high as the position of exit portion 2591A of first discharge pipe 2590A of first opening and closing mechanism 2540D1.

Thus, second discharge pipe 2590B and push-up member 2546B of second opening and closing mechanism 2540D2 are longer in length than first discharge pipe 2590A and push-up member 2546A of first opening and closing mechanism 2540D1, respectively.

Third discharge pipe 2590C and push-up member 2546C of third opening and closing mechanism 2540D3 are longer in length than second discharge pipe 2590B and push-up member 2546B of second opening and closing mechanism 2540D2, respectively.

In agitation unit 2500D, when boundary portion K1 between first layer S1 and second layer S2 is located above third bottom portion 2510d, initially, third discharge port 2541C is opened with the use of third opening and closing mechanism 2540D3, so that tea containing first layer S1 and second layer S2 can be discharged through third discharge port 2541C to the outside.

Specifically, by pushing up lid member 2548C by operating operation lever 2542C, a gap is provided between lid member 2548C and third bottom portion 2510d. Thus, a discharge path through which tea is discharged is defined. In this case, the discharge path functions as the second discharge path. Tea containing first layer S1 and second layer S2 flows through the discharge path, is guided from third discharge port 2541C to third discharge pipe 2590C, and is discharged through exit portion 2591C of third discharge pipe 2590C into a cup.

In succession, as described above, by opening first discharge port 2541A by using first opening and closing mechanism 2540D1, tea containing first layer S1 is discharged through first discharge port 2541A into a cup. Thus, tea in which second layer S2 and first layer S1 are mixed can be prepared in a cup.

When boundary portion K1 between first layer S1 and second layer S2 is located between second bottom portion 2510c and third bottom portion 2510d, tea can be discharged through second discharge port 2541B to the outside by opening second discharge port 2541B by using second opening and closing mechanism 2540D2.

Specifically, by pushing up lid member 2548B by operating operation lever 2542B, a gap is provided between lid member 2548B and second bottom portion 2510c. A discharge path through which tea is discharged is thus defined. In this case, the discharge path functions as the second discharge path. Tea containing first layer S1 and second layer S2 flows through the discharge path, is guided from second discharge port 2541B to second discharge pipe 2590B, and is discharged through exit portion 2591B of second discharge pipe 2590B to the outside.

In succession, as described above, by opening first discharge port 2541A by using first opening and closing mechanism 2540D1, tea containing first layer S1 is discharged through first discharge port 2541A into a cup. Thus, tea in which second layer S2 and first layer S1 are mixed can be prepared in a cup.

Agitation unit 2500D according to the present embodiment can thus also discharge tea containing first layer S1 and second layer S2 by selecting as appropriate a discharge port to be opened by selecting an opening and closing mechanism in accordance with a position of boundary portion K1 between first layer S1 and second layer S2, and can reliably discharge tea containing second layer S2 which makes a taste milder.

In agitation unit 2500D according to the present embodiment as well, discharge mechanism 2540D is constituted of a pivotably supported operation lever and a push-up member which moves in coordination with the operation lever. Therefore, it is not necessary to electrically drive the discharge mechanism in discharging, and a construction of discharge mechanism 2540D can be simplified.

As set forth above, agitation unit 2500D according to the present embodiment can also obtain an effect substantially the same as the effect of agitation unit 2500 according to Embodiment 15.

Though an example in which operation levers 2542A, 2542B, and 2542C are at the same height in agitation unit 2500D according to the present embodiment is illustrated and described, limitation thereto is not intended and positions of these operation levers can be varied as appropriate.

Though an example in which agitation unit 2500D according to the present embodiment includes agitation tank 2510 provided in a form of a staircase including two steps is illustrated and described, limitation thereto is not intended. The agitation tank may be provided in a form of a staircase including one step or in a form of a staircase including three or more steps. In this case, an opening and closing mechanism is provided in accordance with the number of bottom portions which form the steps.

Though an example in which beverage preparation apparatus 2001 includes agitation unit 2500 according to Embodiment 15 is illustrated and described in Embodiment 15 above, limitation thereto is not intended and the beverage preparation apparatus may include agitation units 2500A to 2500D according to Embodiments 16 to 5.

Though an example in which the agitation tank is constituted of the exterior holder and the thermally insulated tank is illustrated and described in Embodiments 15 to 5 above, limitation thereto is not intended and the agitation tank may consist of the thermally insulated tank. A container not having thermal insulation but having heat resistance may be employed instead of the thermally insulated tank.

Though an example in which tea as a beverage is prepared by agitating hot water as a liquid and tea leaf powders as powders in the agitation unit according to Embodiments 15 to 5 above is illustrated and described, limitation thereto is not intended. A foamed beverage such as milk foam may be prepared by agitating a liquid for a beverage such as milk alone, or a mixed beverage obtained by agitating a plurality of liquids for a beverage different in specific gravity may be prepared.

Though the embodiments and the examples of the present invention have been described above, the embodiments and the examples disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

1 beverage preparation apparatus; 100 apparatus main body; 110 control unit; 120 milling motor unit; 130 milling driving force coupling mechanism; 140 agitation motor unit; 140A contactless table; 141 permanent magnet; 150 hot water supply pipe; 155 liquid supply path; 160 heater; 170 hot water supply nozzle; 171 supply port; 180 milling unit attachment portion; 190 agitation tank attachment portion; 195 liquid storage tank attachment portion; 210 first paddle; 210a accommodation portion; 210h space; 211 second paddle; 212 paddle surface; 220 blade portion; 220a upper surface; 221 blade piece; 222 lower auxiliary ring; 223 upper auxiliary ring; 240 permanent magnet; 250 cylindrical core; 251 conical cap; 252 ring seal; 253 through hole; 260a cover; 260b paddle main body; 300 milling unit; 300W window for coupling; 310 milling case; 310b upper end opening portion; 311 storage portion; 312 discharge path; 312a outlet port; 320 hopper portion; 321 top plate portion; 322 cylindrical portion; 323 opening portion; 325 object-to-be-grated inlet; 330 cover portion; 340 lower mill support portion; 341 main body portion; 342 engagement protrusion portion; 343 powder scraping portion; 345 milling shaft; 350 lower mill; 350a, 350b main surface; 352 engagement recess portion; 359 core; 359a helical blade; 360 upper mill; 360a, 360b main surface; 361 through hole; 370 upper mill holding member; 371 bottom surface portion; 371a hole portion; 372 outer cylindrical portion; 373 inner cylindrical portion; 380 spring holding member; 381 spring; 391, 392, 393 rib; 500 agitation unit; 510, 510A, 510B, 510C 510D, 510E, 510F, 510G, 510H, 510X agitation tank; 510a inner circumferential surface; 510c helically extending surface; 511 exterior holder; 512, 512A, 512B, 512C, 512D, 512E, 512F, 512G, 512H, 512X thermally insulated tank; 513 opening portion; 514 bottom portion; 515, 515B, 515C, 515D, 515E, 515F, 515G, 515H, 515X side wall portion; 516 first cylindrical portion; 517 second cylindrical portion; 518 third cylindrical portion; 520 grip; 530 agitation cover; 531 powder inlet; 532 hot water supply inlet; 540 discharge port opening and closing mechanism; 541 discharge port; 542 operation lever; 543 opening and closing nozzle; 545 discharge portion; 550 agitation blade; 560 rotation shaft; 571, 571C, 571F, 571G connection portion; 572 curved portion; 573 flat portion; 573C inclined portion; 574, 574C connection portion; 575 curved portion; 576 flat portion; 576C inclined portion; 700 liquid storage tank; 710 tank main body; 720 lid portion; 800 tea leaf powder tray; 900 placement base; 1001, 1001D beverage preparation apparatus; 1100 apparatus main body; 1110 control unit; 1112 input portion; 1115 sensing device; 1116 agitation tank sensing device; 1120 milling motor unit; 1130 milling driving force coupling mechanism; 1140 agitation motor unit; 1140A agitation motor contactless table; 1141 permanent magnet; 1150 hot water supply pipe; 1155 liquid supply path; 1160 heater; 1170 hot water supply nozzle; 1171 supply port; 1180 milling unit attachment portion; 1190 agitation tank attachment portion; 1195 liquid storage tank attachment portion; 1240 permanent magnet; 1250 cylindrical core; 1300 milling unit; 1300W window for coupling; 1310 milling case; 1310b upper end opening portion; 1311 storage portion; 1312 discharge path; 1312a outlet port; 1320 hopper portion; 1321 top plate portion; 1322 cylindrical portion; 1323 opening portion; 1325 object-to-be-grated inlet; 1330 cover portion; 1340 lower mill support portion; 1341 main body portion; 1342 engagement protrusion portion; 1343 powder scraping portion; 1345 milling shaft; 1350 lower mill; 1352 engagement recess portion; 1359 core; 1359a blade portion; 1360 upper mill; 1361 through hole; 1370 upper mill holding member; 1371 bottom surface portion; 1371a hole portion; 1372 outer cylindrical portion; 1373 inner cylindrical portion; 1380 spring holding member; 1381 spring; 1391, 1392, 1393 rib; 1500 agitation unit; 1510 agitation tank; 1511 exterior holder; 1512 thermally insulated tank; 1513 opening portion; 1520 grip; 1530 agitation cover; 1531 powder inlet; 1532 hot water supply inlet; 1540 discharge mechanism; 1541 discharge port; 1542 operation lever; 1543 opening and closing nozzle; 1550 agitation blade; 1560 rotation shaft; 1700 liquid storage tank; 1710 tank main body; 1720 lid portion; 1800 tea leaf powder tray; 1900 placement base; 2001 beverage preparation apparatus; 2100 apparatus main body; 2110 control unit; 2120 milling motor unit; 2130 milling driving force coupling mechanism; 2140 agitation motor unit; 2140A contactless table; 2141 permanent magnet; 2150 hot water supply pipe; 2155 liquid supply path; 2160 heater; 2170 hot water supply nozzle; 2171 supply port; 2180 milling unit attachment portion; 2190 agitation tank attachment portion; 2195 liquid storage tank attachment portion; 2240 permanent magnet; 2250 cylindrical core; 2300 milling unit; 2300W window for coupling; 2310 milling case; 2310b upper end opening portion; 2311 storage portion; 2312 discharge path; 2312a outlet port; 2320 hopper portion; 2321 top plate portion; 2322 cylindrical portion; 2323 opening portion; 2325 object-to-be-grated inlet; 2330 cover portion; 2340 lower mill support portion; 2341 main body portion; 2342 engagement protrusion portion; 2343 powder scraping portion; 2345 milling shaft; 2350 lower mill; 2352 engagement recess portion; 2359 core; 2359a helical blade; 2360 upper mill; 2361 through hole; 2370 upper mill holding member; 2371 bottom surface portion; 2371a hole portion; 2372 outer cylindrical portion; 2373 inner cylindrical portion; 2380 spring holding member; 2381 spring; 2391, 2392, 2393 rib; 2500, 2500A, 2500B, 2500C, 2500D agitation unit; 2510, 2510C, 2510D agitation tank; 2510b bottom portion; 2510b1 first bottom portion; 2510c second bottom portion; 2510d third bottom portion; 2511 exterior holder; 2512 thermally insulated tank; 2513 opening portion; 2514 first side wall portion; 2515 second side wall portion; 2516 third side wall portion; 2520 grip; 2521 rotation shaft; 2530 agitation cover; 2531 powder inlet; 2532 hot water supply inlet; 2540, 2540A, 2540B, 2540C, 2540D discharge mechanism; 2540B1, 2540D1 first opening and closing mechanism; 2540B2, 2540D2 second opening and closing mechanism; 2540D3 third opening and closing mechanism; 2541 discharge port; 2541A first discharge port; 2541B second discharge port; 2541C third discharge port; 2542, 2542A, 2542B, 2542C operation lever; 2543 lid member; 2544 through hole; 2545 closing member; 2546, 2546A, 2546B, 2546C push-up member; 2547, 2547A, 2547B support shaft; 2548 first lid member; 2548A, 2548B, 2548C lid member; 2549 second lid member; 2550 agitation blade; 2560 lift mechanism; 2560A first lift mechanism; 2560B second lift mechanism; 2570, 2570A, 2570B cylindrical member; 2571 opening portion; 2572 suction port; 2572C opening portion; 2575, 2575B first cylindrical portion; 2576, 2576B second cylindrical portion; 2580 opening and closing mechanism; 2581 cam; 2582 operation lever; 2583 operation shaft; 2584 lid member; 2585 support shaft; 2586 discharge pipe; 2587 exit portion; 2590 discharge pipe; 2590A first discharge pipe; 2590B second discharge pipe; 2590C third discharge pipe; 2591, 2591A, 2591B exit portion; 2595 float member; 2700 liquid storage tank; 2710 tank main body; 2720 lid portion; 2800 tea leaf powder tray; and 2900 placement base.

1. An agitation unit comprising:
an agitation tank to which a liquid is supplied; and
an agitation member which agitates the liquid supplied to the agitation tank,
the agitation tank having an area of opening in a horizontal direction decreasing in a downward direction.

2. The agitation unit according to claim 1, wherein
a guideline amount of supply of the liquid is predetermined, and a liquid level position when the guideline amount of supply is minimal is located above an upper surface of the agitation member.

3. The agitation unit according to claim 1, wherein
the agitation member is provided at a bottom portion of the agitation tank.

4. The agitation unit according to claim 1, wherein
the agitation tank has such a curved shape that the area of opening in the horizontal direction decreases in the downward direction.

5. A beverage preparation apparatus comprising:
a milling unit which obtains powders by grating an object to be grated; and
an agitation unit to which the powders and a liquid are supplied,
the agitation unit according to claim 1 being employed as the agitation unit.

6. A beverage preparation apparatus comprising:
an agitation tank;
an agitation member which agitates a liquid supplied to the agitation tank;
an agitation member drive portion which rotationally drives the agitation member;
a discharge mechanism which is provided in the agitation tank and discharges the liquid from the agitation tank to outside; and
a control unit which controls the agitation member drive portion,
the control unit controlling the agitation member drive portion such that the agitation member is rotationally driven when the discharge mechanism discharges the liquid to the outside.

7. The beverage preparation apparatus according to claim 6, wherein
the control unit controls the agitation member drive portion such that the agitation member is intermittently rotationally driven.

8. The beverage preparation apparatus according to claim 6, the beverage preparation apparatus further comprising:
an operation portion for operating the discharge mechanism; and
a sensing device which senses timing of an operation of the operation portion, wherein
the control unit receives input of a sensing signal indicative of sensing of the timing from the sensing device and controls the agitation member drive portion such that the agitation member is rotationally driven after a prescribed period of time has elapsed since discharging of the liquid from the discharge mechanism to the outside.

9. The beverage preparation apparatus according to claim 6, the beverage preparation apparatus further comprising:
an operation portion for operating the discharge mechanism; and
a sensing device which senses timing of an operation of the operation portion, wherein
the control unit receives input of a sensing signal indicative of sensing of the timing from the sensing device and controls the agitation member drive portion such that the agitation member is rotationally driven before the liquid is discharged from the discharge mechanism to the outside.

10. The beverage preparation apparatus according to claim 6, the beverage preparation apparatus further comprising an input portion for indicating a time period for the agitation member to be rotationally driven and/or the number of rotations.

11. An agitation unit comprising:
an agitation tank to which a liquid is supplied;
an agitation member which agitates the liquid supplied to the agitation tank; and
a discharge mechanism which discharges an agitated liquid produced as a result of agitation by the agitation member to outside,
the agitated liquid including a first layer and a second layer which is separated as an upper layer based on a difference in specific gravity from the first layer, and
the discharge mechanism having a suction port located near a boundary portion between the first layer and the second layer and discharging the agitated liquid suctioned through the suction port.

12. The agitation unit according to claim 11, wherein
the discharge mechanism is provided to be able to select between a first discharge path through which the agitated liquid including the first layer is discharged and a second discharge path through which the agitated liquid including the second layer is discharged.

13. The agitation unit according to claim 11, the agitation unit further comprising a float member which follows displacement of the boundary portion between the first layer and the second layer, wherein
the float member is disposed around the suction port, and
the suction port follows displacement of the boundary portion owing to the float member and suctions the agitated liquid containing the second layer.

14. The agitation unit according to claim 11, wherein
the suction port is provided in a side surface of the agitation tank so as to be opened and closed, and
the agitated liquid containing the first layer and the second layer is suctioned through the suction port while the suction port is open.

15. A beverage preparation apparatus comprising:
a milling unit which obtains powders by grating an object to be grated; and
an agitation unit to which the powders and a liquid are supplied,
the agitation unit according to claim 11 being employed as the agitation unit.
